(19) United States
(12) Patent Application Publication
(10) Pub. No.: US 2008/0249804 A1
(43) Pub. Date: Oct. 9, 2008

(54) Method for Managing Medical Information Online

(75) Inventor: Suhung-Gwon Kim, Seoul (KR)

Correspondence Address: STERNE, KESSLER, GOLDSTEIN & FOX P.L.L.C., 1100 NEW YORK AVENUE, N.W., WASHINGTON, DC, 20005, US

(73) Assignees: EZ-Caretech Co., Ltd., Jongno-gu, Seoul (KR); Seoul National University Hospital, Seoul (KR)

(21) Appl. No.: 10/560,409

(22) PCT Filed: Jun. 14, 2004
(86) PCT No.: PCT/KR04/01408

§ 371 Date: Apr. 28, 2008

(30) Foreign Application Priority Data
Jun. 14, 2003 (KR) 10-2003-0038558
Jun. 14, 2003 (KR) 10-2003-0038563
Jun. 14, 2003 (KR) 10-2003-0038564
Jul. 14, 2003 (KR) 10-2003-0047695

(51) Int. Cl. G06F 19/00

(52) U.S. Cl. 705/3

(57) ABSTRACT

Disclosed is a method for managing medical information online, in which documents of various formats created by physicians during or after treatment, nursing notes created by nurses during or after nursing service, and other various notes or reports created by clinical laboratory staff during or after physical examinations performed on the patients are presented through a network and a variety of information input through the network is comprehensively managed to be later given users having access rights to the information, thereby enabling the users to share the variety of information.

### TECHNICAL FIELD

The present invention relates to a method for managing medical information online, and more particularly, to a medical information management method which enables physicians, nurses and clinical laboratory staff to directly input or view patient information online.

### BACKGROUND ART

With the advances in the Internet, which is a global network, and other networks such as LANs and Intranets, development of technology and contents enabling a variety of information to be shared is under way.

Such technological progress has also been made in the medical industry, which has led to the development of techniques and methods for sharing a variety of medical information through the internal networks of hospitals.

However, the information that is currently shared in hospitals is limited to only basic information on user identification, or simple contents including medical care items, medical care reservation, treatment details, and admission information.

In addition, information on orders issued by physicians after they make a diagnosis and information on medical treatment of patients, for example, information on what kind of or how much medicine to prepare, what kind of an injection to give, and what kind of examination to perform, may be shared through a network.

However, what matters in proper treatment or medical care for patients is not the above-stated fundamental, obvious information but individual status information on the pathological symptoms of each patient, including nursing notes, physician's opinions and methods of treatment, various test results, outcomes of treatment and the like.

Meanwhile, such information may be provided the in forms of charts created by physicians in the course of performing a medical care action, nursing notes created by nurses in the course of nursing, and various other notes or reports created by clinical laboratory staff after performing physical examinations on the patients.

However, since the individual status information on the pathological symptoms of each patient is acquired from various sources and input items become ever more detailed and becoming complex by treatment blocks, it is quite difficult to universally computerize such information and input items in a comprehensive manner. Accordingly, methods for sharing various kinds of medical information through a network in hospitals are still open for improvement.

Despite the development of networks and computerized systems, individual status information depending on the pathological symptoms of each patient is still dependent on paper-based filing and management, and such paper-based records are computerized by separate staff. Also, systems are required that may limit the effective management of patient information.

In addition, since the patient information is not fully computerized, patients cannot be provided with quick and accurate medical services in medical care treatment stages.

Physicians, nurses or clinical laboratory staff members often need to issue various orders in the course of performing a medical care action, nursing or examinations on patients. In such cases, they may encounter some difficulties in issuing appropriate orders. In other words, physicians, nurses or clinical laboratory staff members may encounter difficulties in, for example, selecting diagnosis type, and selecting the medication or blood transfusion dosages.

In such a case, the physicians, nurses or clinical laboratory staff members may search for pertinent information through various medical publications and reference books, which is, however, a time-consuming task. In addition, the searched information itself is not readily available as meaningful data.

### DISCLOSURE OF THE INVENTION

To solve the above problems, the present invention provides a method for managing medical information online, in which documents of various formats created by physicians during or after treatment, nursing notes created by nurses during or after nursing service, and other various notes or reports created by clinical laboratory staff during or after physical examinations performed on the patients are presented through a network and a variety of information input through the network is comprehensively managed to be later given users having access rights to the information, thereby enabling the users to access the variety of information.

The present invention also provides a method for managing medical information online, by which a variety of information generated while medical care and treatment are performed by the physicians, nurses and clinical laboratory staff can be directly input and viewed on the spot, is provided on a web screen through a pertinent terminal, and a variety of decision support information necessary in making decisions regarding care and treatment for a patient can be managed and viewed through web screens.

### BRIEF DESCRIPTION OF THE DRAWINGS

FIG. 1A is a schematic diagram illustrating hospital operation categories incorporating an embodiment of the present invention;

FIG. 1B is a block diagram of a medical information providing system according to an embodiment of the present invention;

FIG. 2 is an exemplary web browser screen for a physician provided by a method for managing medical information online according to the present invention;

FIG. 3A is an exemplary ‘Patient Selection’ screen activated from the web browser screen provided by the online medical information management method according to the present invention;

FIG. 3B is an exemplary order input screen activated from the web browser screen provided by the online medical information management method according to the present invention;

FIG. 4 is an exemplary main menu block screen activated from the web browser screen provided by the online medical information management method according to the present invention;

FIG. 5 is an exemplary initial screen of a ‘Patient Information’ input block activated from the web browser screen provided by the online medical information management method according to the present invention;

FIGS. 6A through 6H illustrate various exemplary screens displayed when a ‘New Outpatient’ menu item is selected from the patient information input block activated from the web browser screen provided by the online medical information management method according to the present invention;

FIG. 7 illustrates an exemplary screen displayed when an ‘Outpatient Progress’ menu item is selected from the patient information input block activated from the web browser screen provided by the online medical information management method according to the present invention;

FIG. 8 illustrates an exemplary screen displayed when a ‘New Inpatient’ menu item is selected from the patient information input block activated from the web browser screen provided by the online medical information management method according to the present invention;

FIG. 9 illustrates an exemplary screen displayed when an ‘Admission Progress’ menu item is selected from the patient information input block activated from the web browser screen provided by the online medical information management method according to the present invention;

FIG. 10 illustrates an exemplary screen displayed when an ‘Ask for Referral’ menu item is selected from the patient information input block activated from the browsers screens provided by the online medical information management method according to the present invention;

FIG. 11 illustrates an exemplary screen displayed when an ‘Operation Record’ menu item is selected from the patient information input block activated from the web browser screen provided by the online medical information management method according to the present invention;

FIGS. 12A and 12B illustrate exemplary screens displayed when a ‘Discharge Record’ menu item is selected from the patient information input block activated from the web browser screen provided by the online medical information management method according to the present invention;

FIG. 13 illustrates an exemplary screen displayed when a ‘Medical Certificate/Request’ menu item is selected from the patient information input block activated from the web browser screen provided by the online medical information management method according to the present invention;

FIG. 14 illustrates an exemplary screen displayed when a ‘Form’ menu item is selected from the patient information input block activated from the web browser screen provided by the online medical information management method according to the present invention;

FIG. 15 illustrates an exemplary screen for explaining the patient information view block and user information display block activated from the web browser screen provided by the online medical information management method according to the present invention;

FIG. 16 illustrates an exemplary web browser screen for a nurse provided by the online medical information management method according to the present invention;

FIGS. 17A and 17B illustrate exemplary ‘Patient Selection’ block displayed on the web browser screen provided by the online medical information management method according to the present invention;

FIG. 18 illustrates an exemplary main menu block displayed on the web browser screen provided by the online medical information management method according to the present invention;

FIG. 19 illustrates an exemplary user information display block displayed when a patient is selected from the web browser screen provided by the online medical information management method according to the present invention;

FIG. 20 illustrates an exemplary screen displayed when a shortcut icon for activating order execution is selected from a ‘My menu’ block displayed on the web browser screen provided by the online medical information management method according to the present invention;

FIGS. 21A and 21B illustrate exemplary screens displayed when a shortcut icon for activating nursing notes is selected from the ‘My menu’ block displayed on the web browser screen provided by the online medical information management method according to the present invention;

FIG. 22 illustrates an exemplary screen displayed when a shortcut icon for activating clinical observation is selected from the ‘My menu’ block displayed on the web browser screen provided by the online medical information management method according to the present invention;

FIG. 23 illustrates an exemplary screen displayed when a shortcut icon for activating nursing activity execution is selected from the ‘My menu’ block displayed on the web browser screen provided by the online medical information management method according to the present invention;

FIG. 24 illustrates an exemplary screen displayed when a shortcut icon for activating diet issue and review is selected from the ‘My menu’ block displayed on the web browser screen provided by the online medical information management method according to the present invention;

FIGS. 25A through 25E illustrate various examples of web browser screens for function tests provided by the online medical information management method according to an embodiment of the present invention;

FIGS. 26A through 26D illustrate various examples of web browser screens for rehabilitation service provided by the online medical information management method according to an embodiment of the present invention;

FIGS. 27A through 27D illustrate various examples of web browser screens for health examinations provided by the online medical information management method according to an embodiment of the present invention;

FIGS. 28A and 28B illustrate examples of web browser screens for radiotherapy provided by the online medical information management method according to the present invention.

FIGS. 29A through 29C illustrate various examples of web screens to which the online medical information management method according to the present invention is applied;

FIGS. 30A through 30E illustrate various examples of decision support web screens on which an anticancer agent information providing method is implemented in the online medical information management method according to the present invention;

FIG. 31 shows an exemplary decision support web screen on which an antibiotic information providing method is implemented in the online medical information management method according to the present invention;

FIGS. 32A through 32E illustrate various examples of decision support web screens on which a blood transfusion prescription information providing method is implemented in the online medical information method management according to the present invention; and

FIGS. 33A and 33B illustrate examples of decision support web screens on which a medication information providing method is implemented in the online medical information management method according to the present invention.

### BEST MODE FOR CARRYING OUT THE INVENTION

In an aspect of the present invention, an online medical information management method applied to a medical information providing system is provided, the method comprising the acts of (1) when a physician terminal connected to the medical information providing system requests a medical information management service for a physician from through an Internet or an Intranet, a controller performing an authentication procedure for the request, (2) when it is determined by the authentication procedure that the request has been made by an authenticated user, the controller transmitting a physician's web screen to the physician terminal, the physician's web screen comprising at least one block selected from the group consisting of a user information display block, a My menu block, a main menu block, a patient information view block, and a patient information input block, (3) when a patient to be cared for is selected, the controller displaying information in the user information display block, the information including at least one information item selected from the group consisting of patient identification, department concerned, primary care physician, diagnosis, and operation, (4) when at least one information item selected from the group consisting of new outpatient, outpatient progress, new inpatient, admission progress, ask for referral, operation record, discharge record, medical certificate/request, form, and psychiatric findings is input through the patient information input block, the controller storing the input information together with the patient information displayed in the user information display block, and (5) when a request to view at least one information item selected from the group consisting of new outpatient, outpatient progress, examination query, ask for referral, form, new inpatient, admission progress, operation record, and discharge record is input through the patient information view block, the controller retrieving pertinent information among the information items stored in act (4) and outputting the retrieved information through the patient information view block.

In another aspect of the present invention, there is provided an online medical information management method applied to a medical information providing system, comprising the acts of (1) when a nurse terminal connected to the medical information providing system requests a medical information management service for a nurse through the Internet or Intranet, a controller performing an authentication procedure for the request, (2) when it is determined by the authentication procedure that the request has been made by an authenticated user, the controller transmitting a nurse's web screen to the nurse terminal, the nurse's web screen comprising at least one block selected from the group consisting of a user information display block, a My menu block, a main menu block, a patient selection block, and a patient information input/output block, (3) when a patient to be cared for is selected, the controller displaying information in the user information display block, the information including at least one information item selected from the group consisting of patient identification, department concerned, primary care physician, diagnosis, and operation, and (4) when there is a request for activating at least one menu item of the ‘My menu’ block selected from the consisting of order execution, nursing notes, clinical observation, serious case nursing note, nursing activity execution, initial nursing information, post discharge nursing plan, pre-operation nursing status checklist, nursing note and nursing activity query, patient position check, medication issuance, diet issue and review, examination result review, and discharge process, the controller outputting the pertinent content to the patient information input/output block, storing the information input through the patient information input/output block therein, and outputting the requested information through the patient information input/output block when there is a request for outputting the menu items, the patient selection block displaying a first patient selection button for activating patient selection, a second patient selection button displayed in different types according to the menu item selected by the first patient selection button, and a patient list for displaying a list of patients according to the menu item selected by the second patient selection button.

In still another aspect of the present invention, an online medical information management method applied to a medical information providing system is provided, the method comprising the acts of (1) when there is a request for a medical information management service for clinical laboratory staff from at least one selected from the physician terminal, the nurse terminal, and the clinical laboratory staff terminal connected to the medical information providing system through an Internet or an Intranet, a controller performing an authentication procedure for the request, (2) when it is determined by the authentication procedure that the request has been made by an authenticated user, the controller transmitting a clinical laboratory staff's web screen to the requesting terminal, the clinical laboratory staff's screen including at least one block selected from the group consisting of a user information display block, a main menu block, and a patient information input/output block, (3) when a patient to be reviewed is selected, the controller displaying information on the user information display block, the information including at least one information item selected from the group consisting of patient identification, department concerned, primary care physician, diagnosis, operation, examination history, consultation history, treatment history, treatment room and examining room, and (4) the controller outputting pertinent information according to the content of the menu item selected from the main menu block to the patient information input/output block and storing the examination or treatment related information input through the patient information input/output block, and outputting the examination or treatment related information when there is a request for reviewing the information, wherein the clinical laboratory staff's web screen in act (2) is at least one selected from a web screen for information on function tests assigned to the respective departments concerned, a web screen for a rehabilitation service for physical therapy and occupational therapy, and a web screen for radiotherapy.

In a further aspect of the present invention, there is provided a (1) managing medical information necessary for patient care by a controller transmitting a physician's web screen, a nurse's web screen, and a clinical laboratory staff's web screen for medical information management to each of a physician terminal, a nurse terminal, and a clinical laboratory staff terminal connected to the service providing system through the Internet or Intranet and storing the same to allow the user to share the information input through the respective terminals through the web screens, (2) when there is a request for viewing decision support information through a menu item supplied from the at least one the physician's web screen, the nurse's web screen, and the clinical laboratory staffs web screen, the controller supplying pertinent decision support information retrieved from the decision support information stored in a decision support management unit to the requesting user through the corresponding decision support web screen, (3) the controller storing the information input by least one user selected from a physician, a nurse or a clinical laboratory staff member through the physician's decision support web screen and, when it is necessary to convert the input information based on prestored patient information, performing a pertinent calculation and supplying the calculation result through the decision support web screen, and (4) the controller allowing the information input through the decision support web screen to be viewed through the user's web screen and issuing an alert message to the user's web screen when the information input through the user's web screen is inappropriate information with respect to the decision support information stored in the decision support management unit, the decision support information including at least one information item selected from the group consisting of anticancer agent information, antibiotics information, blood transfusion prescription information, and medicine information.

Hereinafter, embodiments of the present invention will be described in detail with reference to the attached drawings.

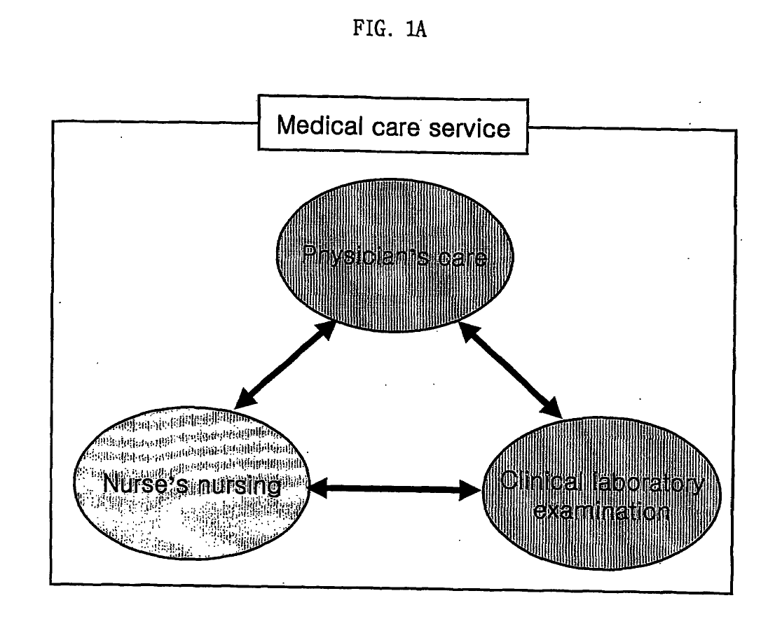

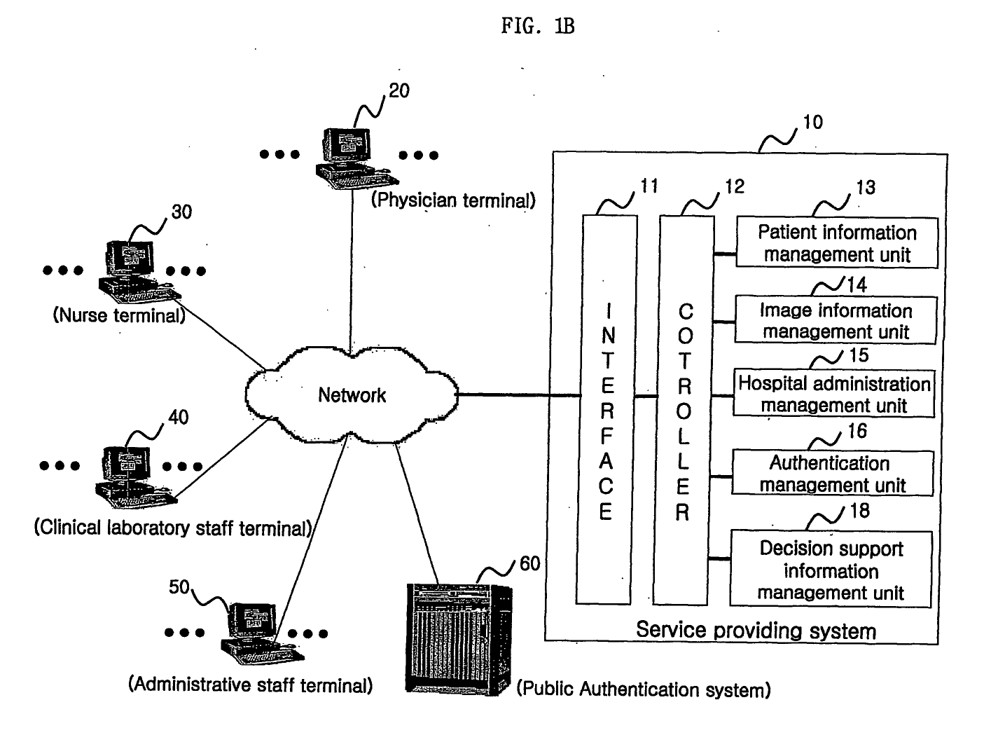

FIG. 1A is a schematic diagram illustrating hospital operation categories incorporating an embodiment of the present invention. As shown in FIG. 1A, hospital services, particularly, medical services for treatment of patients, can be largely categorized into physician's care service performed by a physician, nursing service performed by a nurse, and examination or treatment service performed by clinical laboratory staff.

Conventionally, as stated above in describing the background art, a variety of patient information produced at the respective stages, that is, the physician's care, nursing service and clinical laboratory examination stages, have not been shared. In the present invention, unlike in the prior art, the patient information can be shared by physicians, nurses and clinical laboratory staff through a hospital network.

FIG. 1B is a block diagram of a medical information providing system according to an embodiment of the present invention.

As shown in FIG. 1B, the medical information providing system according to the present invention includes a physician terminal 20, a nurse terminal 30, a clinical laboratory staff terminal 40, an administrative staff terminal 50 and an external public authentication system 60. The physician terminal 20 allows physicians to access a service providing system 10 that manages and provides them with patient information and general information on hospital services through a network for viewing patient information and entering results produced after performing medical care on patients. The nurse terminal 30 allows nurses to access the service providing system 10 for viewing patient information and entering nursing service results. The clinical laboratory staff terminal 40 allows clinical laboratory staff to access the service providing system 10 for viewing information on patients' test requests and entering the test results. The administrative staff terminal 50 allows administrative staff to access the service providing system 10 for viewing various kinds of information related to general matters and services. The external public authentication system 60 performs authentication when a user desires to access the service providing system 10 through one of the terminals.

The physician's care, nurse's nursing service and clinical laboratory staff's examination service depicted in FIG. 1A are performed on web screens of the physician terminal 20, the nurse terminal 30 and the clinical laboratory staff terminal 40, respectively. For convenience of explanation, web screens run on the respective terminals will be briefly referred to as a physician's web screen, a nurse's web screen and a clinical laboratory staffs web screen, respectively.

Now, a medical information providing system in which the service providing system 10, the physician terminal 20, the nurse terminal 30 and the clinical laboratory staff terminal 40 are connected to one another over a hospital's internal network (hereinafter referred to as an “Intranet”) will be described by way of example, but the invention is not limited thereto. The components may be interconnected with one another through a network such as the Internet and operated.

The Intranet will now be described briefly. That is, in a computerized environment, the term “Internet” refers to a group of networks permanently interconnected to thus construct an extended network or a single network. The Intranet is slightly different from a local area network (LAN) or a wide area network (WAN) owned by a group, or the Internet, which is a public network. In other words, the Intranet is different from the LAN in that it employs Internet technology and TCP/IP for communications. Unlike the Internet, though, which is a public network, the Intranet is a private network which is physically isolated from attackers using firewalls.

Also, in order to interconnect without discontinuity networks of several areas where different protocols are used and intelligent service applications are implemented, the Intranet may involve a much higher level of complexity than the Internet. Further, a user of the Intranet is allowed to access the Internet, whereas a user of the Internet is only allowed to access the intranet in a restricted sense.

As described above, the Intranet is different from the typical LAN in that it employs the Internet standards. Thus, when physicians, nurses or clinical laboratory staff members desire to access the service providing system 10 using their respective terminals, they have only to access the same by executing a web browser in the same manner as they would when they access the Internet.

In addition, in the present invention, since a variety of data is available from the service providing system 10. using Internet-based web browsers, it is not necessary to provide storage media for the physician terminal 20, the nurse terminal 30 and the clinical laboratory staff terminal 40 with programs for executing applications and data according to the present invention.

While the administrative staff terminal 50 and the service providing system 10 are, of course, interconnected through the Internet or the Intranet, the present invention will be described based on the assumption that the administrative staff terminal 50 and the service providing system 10 are connected to each other by an ordinary internal network, such as LAN. Here, however, in order to access a variety of information, the administrative staff terminal 50 must have software carried thereon.

Meanwhile, the service providing system 10 according to the present invention includes an interface 11, a controller 12, a patient information management unit 13, an image information management unit 14, a hospital administration management unit 15, an authentication management unit 16 and a decision support information management unit 18.

First, the interface 11 performs connecting the respective terminals 20, 30, 40, and 50 and the public authentication system 60 to one another through the network. In other words, the interface 11 connects the physician terminal 20, the nurse terminal 30 and the clinical laboratory staff terminal 40 to one another through the Intranet. Also, when the respective terminals request for Internet connections, the interface 11 performs connecting them to the Internet in response to their requests. Connecting the administrative staff terminal 50 may be implemented through the internal network such as LAN. Also, the connecting the public authentication system 60 may be implemented through the Internet, which has been described above.

Next, the patient information management unit 13 manages patient information (medical information) input from at least one of the physician terminal 20, the nurse terminal 30, the clinical laboratory staff terminal 40, and administrative staff terminal 50. When there is a request for information on a given patient from the physician terminal 20, the patient information management unit 13 retrieves the medical information for the patient and transmits the same to the physician terminal 20.

The image information management unit 14 manages image information input from at least one of the respective terminals. When there is a request for information on the patient from the physician terminal 20, the image information management unit 14 retrieves the image information for the patient and transmits the same to the physician terminal 20. Here, the image information generally includes electronic images of various photos taken for the purpose of inspect the status of the patient, including X-ray films, endoscope films, computed tomograms (CTs), and the like. In addition, the electronic images may include scanned images of various documents or photos.

The hospital administration management unit 15 manages hospital administrative management related information which the administrative staff members have entered through the administrative staff terminal 50. Also, when there is a request for outputting information from the administrative staff terminal 50 and/or at least one of the other terminals 20, 30, and 40, the hospital administration management unit 15 transmits the information related to hospital administrative management to the corresponding terminal.

The public authentication management unit 16 performs authentication of various users seeking access to the service providing system 10 through the network, i.e., the Internet or Intranet. That is, when physicians, nurses, clinical laboratory staff members, and administrative staff members desire to access the service providing system 10 through their terminals, the authentication management unit 16 performs an authentication procedure to verify whether the user is authenticated and to allow only the authenticated user to access the system. Meanwhile, since a patient information management system in a hospital, like the service providing system, requires thorough security and confidentiality, in-house authentication may not be enough to ensure the security and confidentiality. Here, the public authentication system 60, rather than the internal authentication system connected to the Intranet, may perform an authentication procedure. That is to say, when there is a request for authentication from a user, the authentication management unit 16 transmits the user information to the public authentication system 60 over a network, such as the Internet, to allow the public authentication system 60 to perform an authentication procedure to decide to allow the user's access according to the authentication result.

The decision support information management unit 18 manages a variety of decision support information supplied from the physician's web screen, the nurse's web screen, and the clinical laboratory staff's web screen.

Here, the decision support information is information that is to be referred to or learned when a physician, a nurse or clinical laboratory staff performs care, nursing or examination on the patient, that is, information which has been verified clinically and empirically. Examples of the information include information on kinds and characteristics of an anticancer agent, information on kinds and characteristics of an antibiotic, information on suggestions or matters to be attended to in blood transfusion, information on medication and interactivity, and so on. The physician, the nurse or the clinical laboratory staff utilizes the decision support information as reference data in making decisions for selection of kinds and dosages of anticancer agents, selection of kinds and dosages of antibiotics, selection of kinds and dosages of blood transfusion agents, selection of types, possibility of concurrent administration and dosages of medications, and so on. According to the present invention, the decision support information is provided through the respective web screens to assist the physician, the nurse or the clinical laboratory staff in accurately determining and selecting optimal care, nursing or treatment for the patient.

Lastly, the controller 12 controls the interface 11 and the respective units 13 through 16 and 18. Meanwhile, the controller 12 transmits/receives a variety of information to/from the terminals via the network.

Here, the interface 11 and the respective units 12 through 16 and 18 may be implemented by a single computer or server. However, in order to avoid various possible impediments, auxiliary systems may also be provided.

Throughout the description that follows, initial registration of basic information on a patient, e.g., identification number, name, patient number, sex, etc., in the service providing system 10 may be performed, but not limited thereto, through the administrative staff terminal 50. The initial registration may also be performed through the physician terminal 20 or the clinical laboratory staff terminal 40. As described above, the administrative staff terminal 50 is connected to the service providing system 10 through the internal network such as LAN.

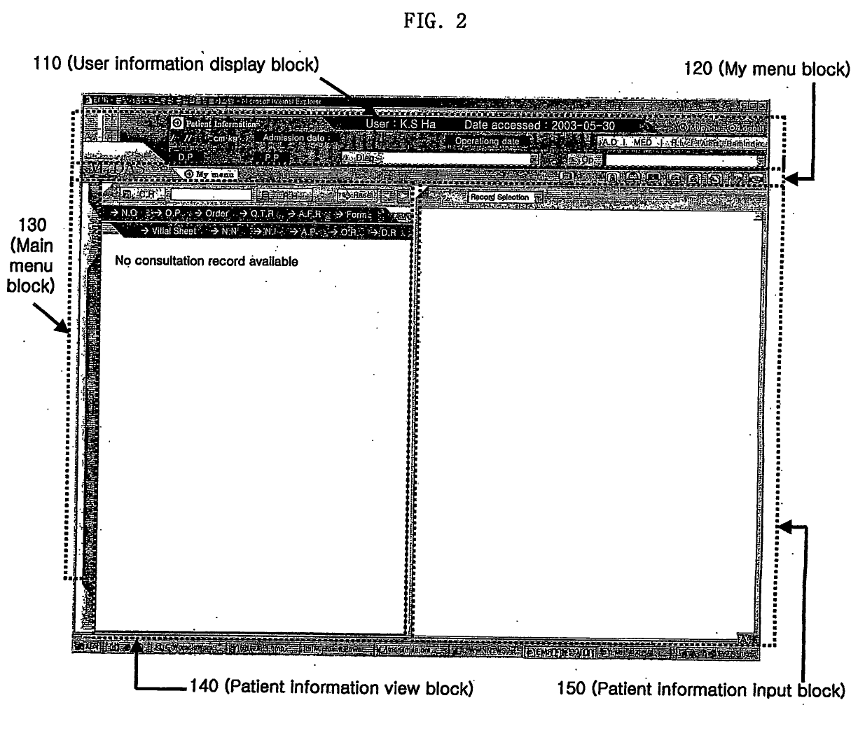

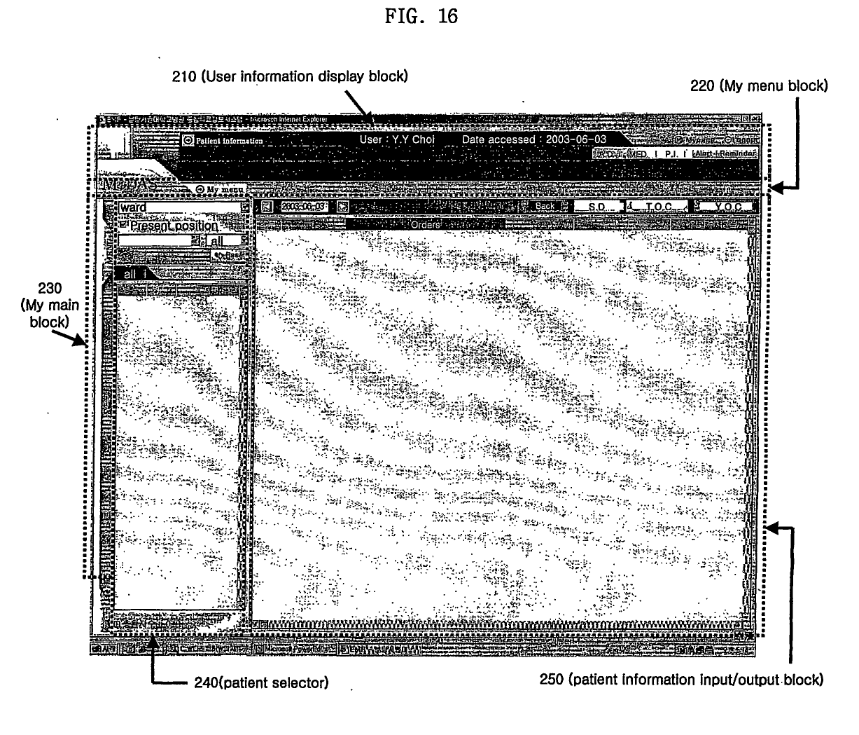

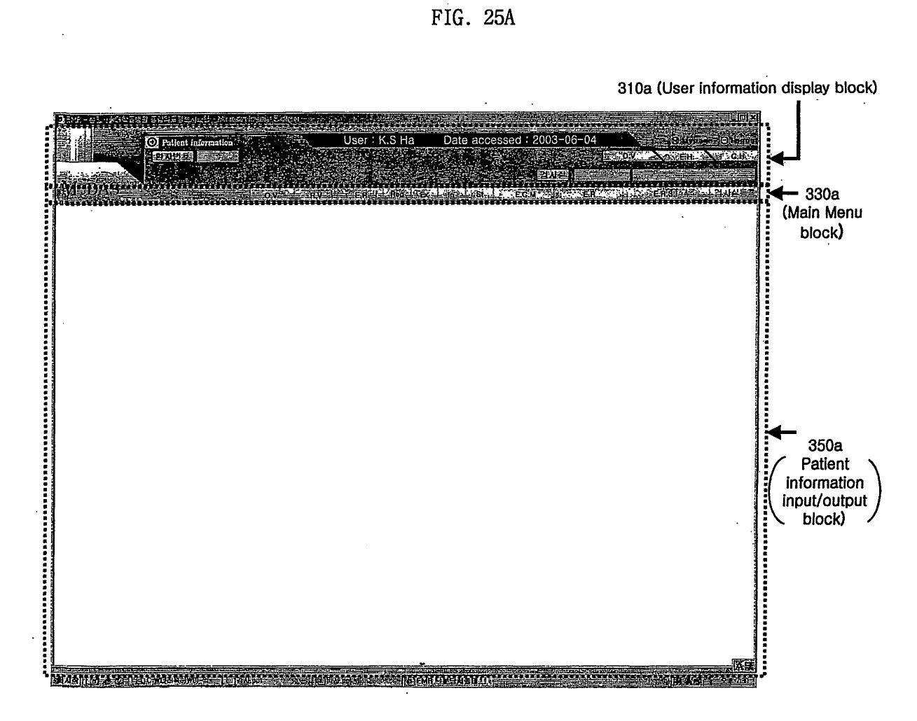

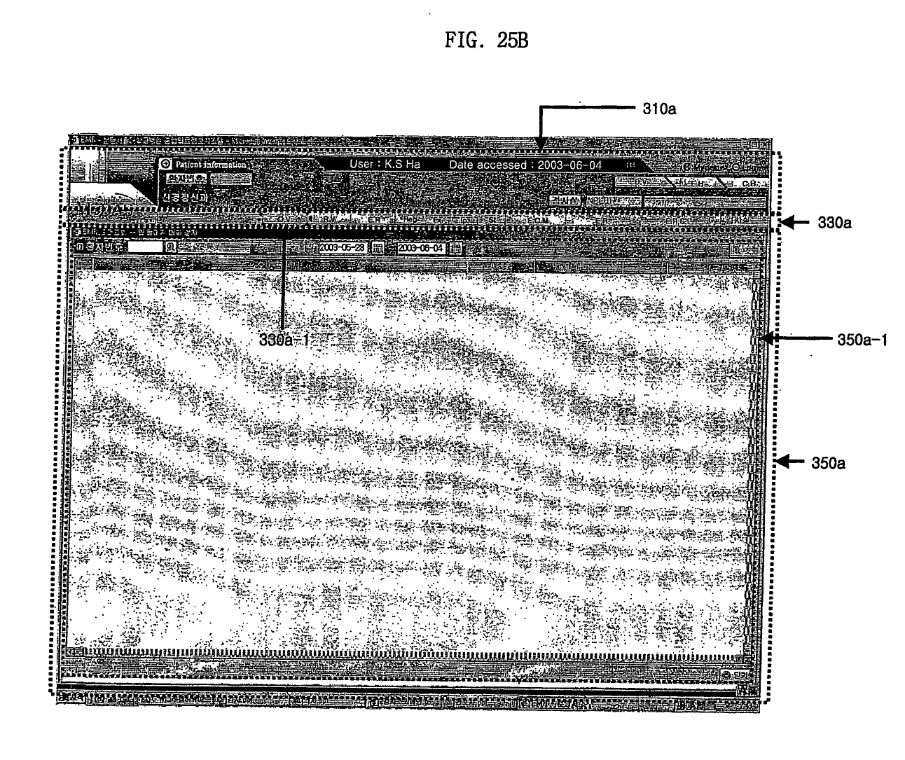

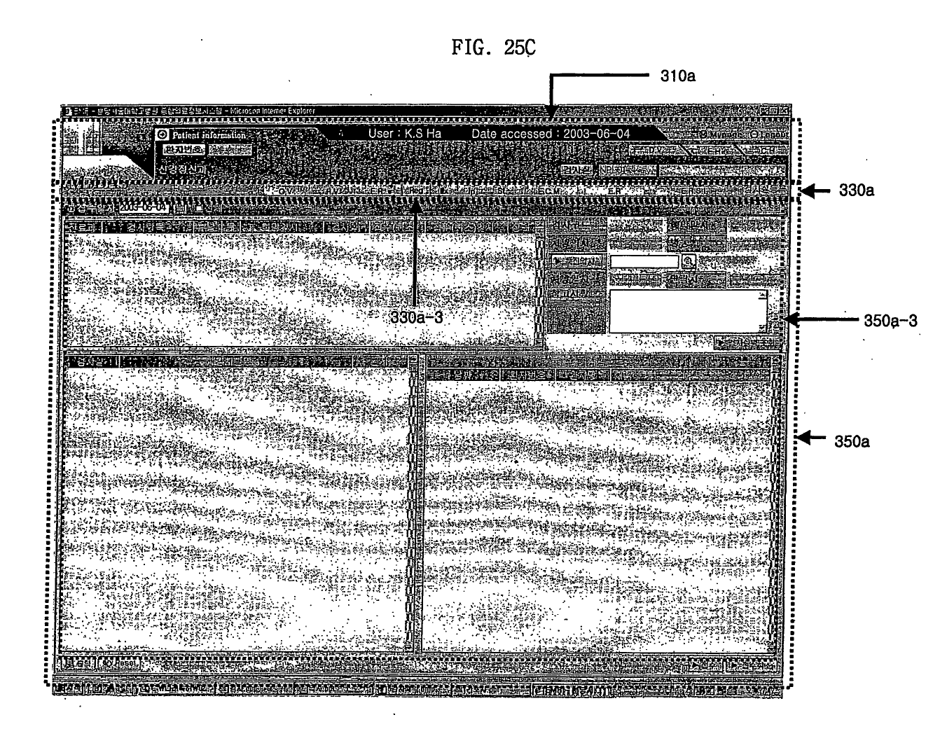

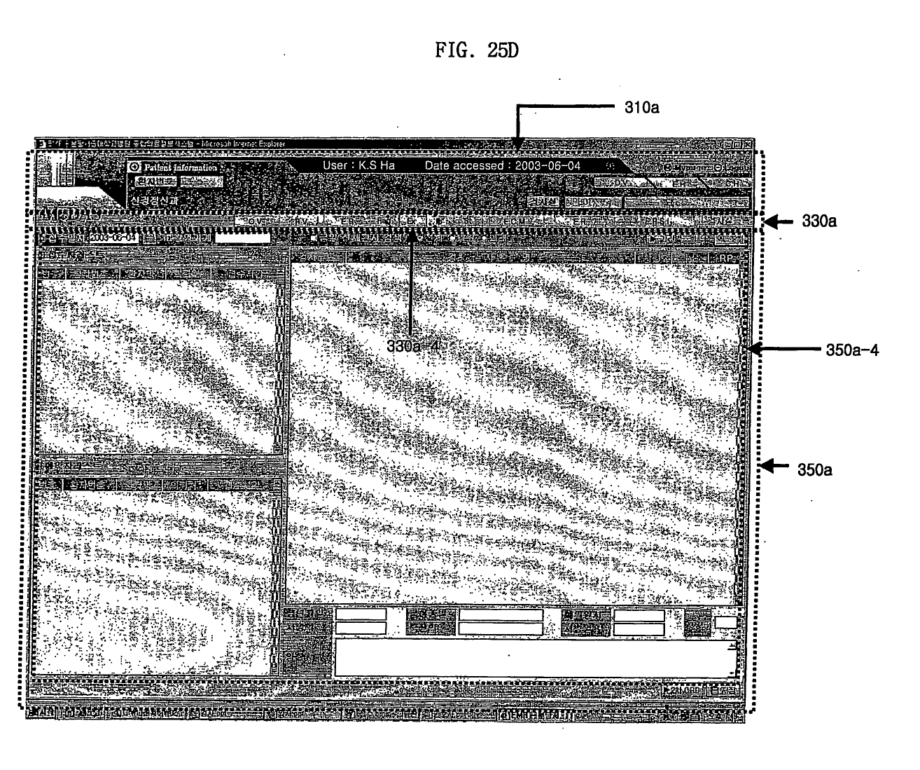

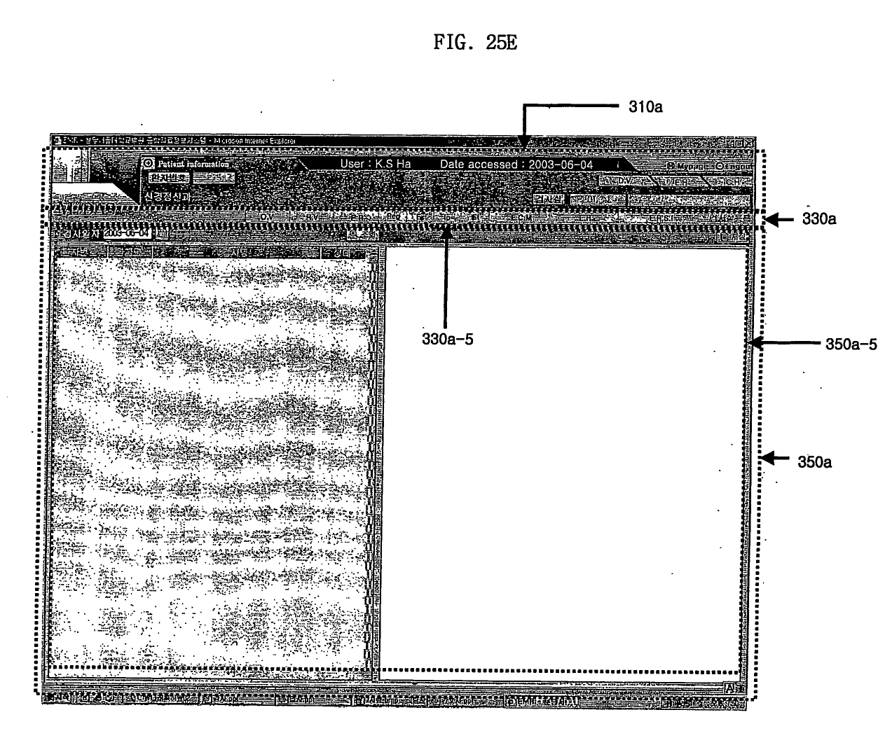

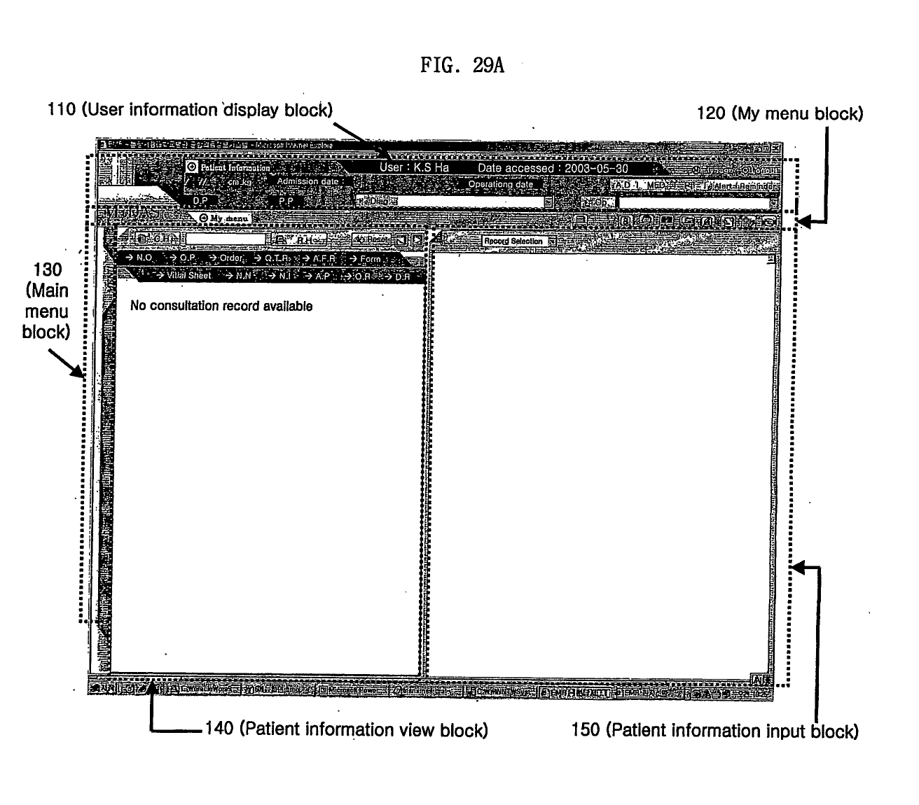

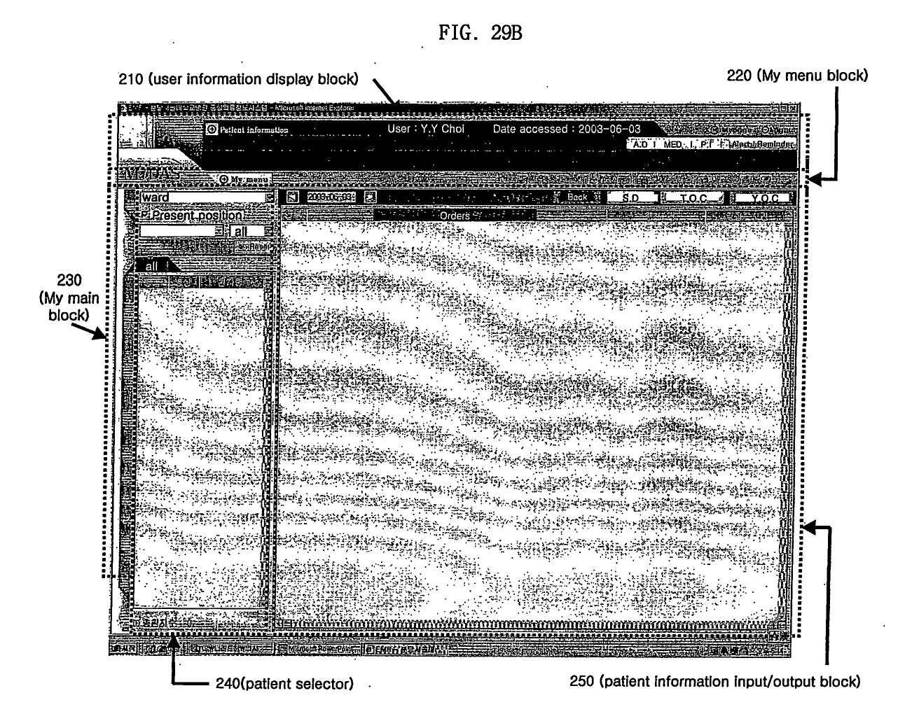

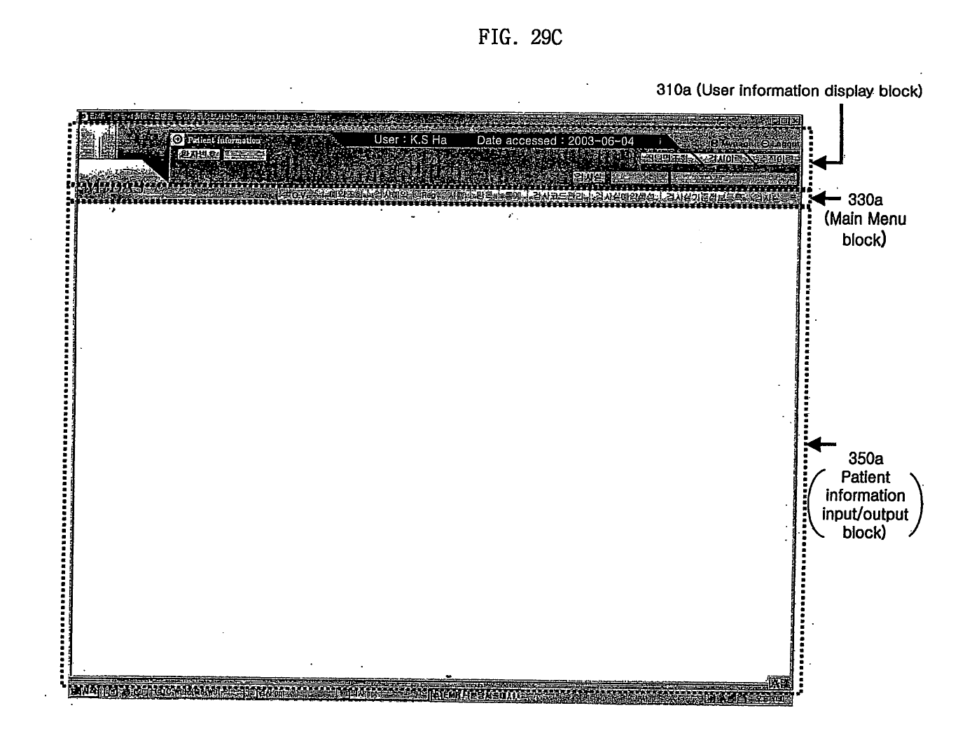

Now, a medical information providing method implemented by the physician terminal 20 will be described with reference to FIGS. 2 through 15. Then, a medical information providing method implemented by the nurse terminal 30 will be described with reference to FIGS. 16 through 24. A medical information providing method implemented by the clinical laboratory staff terminal 40 will be described with reference to FIGS. 25A through 28B. Finally, a medical information providing method which can assist the physician, the nurse and the clinical laboratory staff in making decisions will be described with reference to FIGS. 29A through 33B.

FIG. 2 is an exemplary web browser screen provided by a method for managing medical information online according to the present invention, particularly illustrating an initial screen of physician's web browser for providing the physician with a variety of medical information when the physician has connected to the service providing system 10 via the physician terminal 20 and normally logged in to the same system 10.

Although the physician can access the service providing system 10 via the web browser, he/she should be authenticated by the authentication management unit 16 or the external public authentication system 60 incorporated in the service providing system 10 to get a variety of information.

FIG. 2 illustrates an example of a web browser screen activated when a menu option “screen managed by physician” is selected after the physician has normally logged in and connected to the service providing system 10, which is simply referred to as a “physician's web screen”. That is, as shown in FIG. 2, the physician's web screen is largely divided into five blocks: a user information display block 10; a ‘My menu’ block 120; a main menu block 130; a patient information view block 140; and a patient information input block 150.

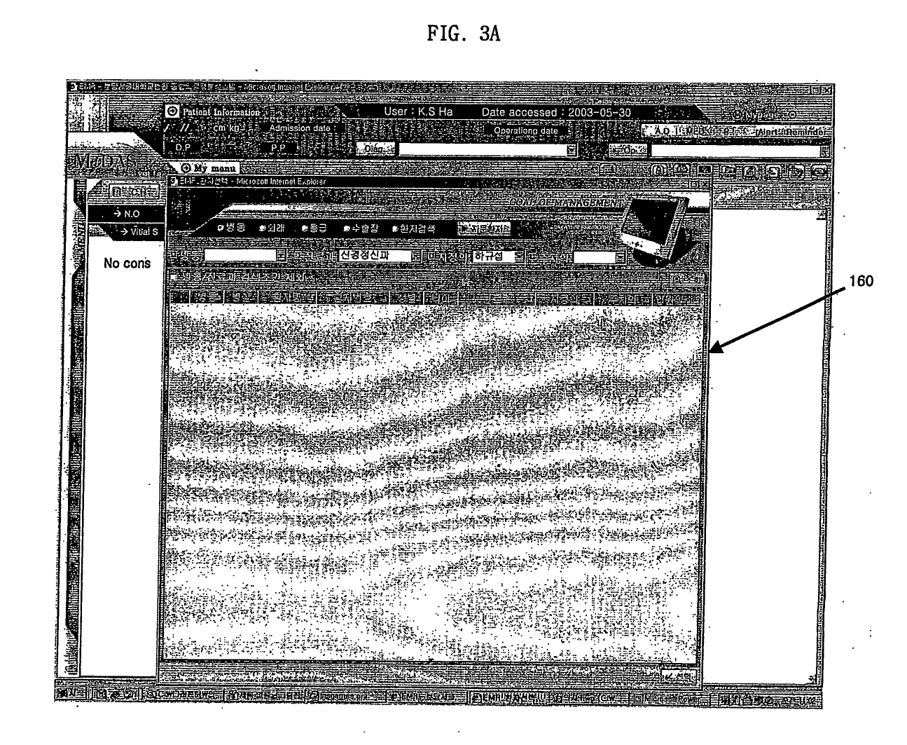

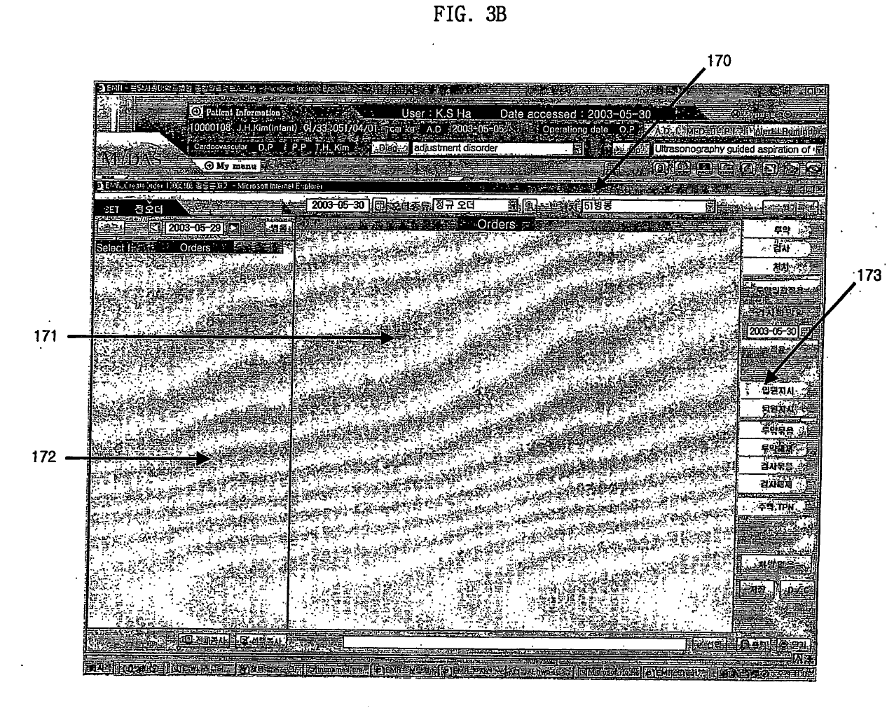

The user information display block 10 displays information on a physician (user) who has logged in. Also, when the physician selects a given patient, whose information the physician wants to view or update, the user information display block 10 displays the basic information on the patient, including name, patient number, department concerned, designated physician, primary care physician and so on. In addition, the user information display block 10 displays pertinent items contained in the information, including diagnosis, operation, operation date, attending doctor, prescription and so on. The displayed items are stored in the patient information management unit 13. Here, the basic patient information is input by the administrative staff, i.e., hospital personnel in the reception area, through the administrative staff terminal 50, but the invention is not limited thereto. It should be appreciated that other entry types and methods would not depart from the scope of the invention. A method of selecting a patient will be described below with reference to FIG. 3A.

The ‘My menu’ block 120 displays shortcut icons for activating user's preference menu items among a plurality of menu items in the main menu block 130. That is, the ‘My menu’ block 120 is devised such that each physician can select his/her desired menu items from the main menu block 130. A menu for setting the ‘My menu’ block 120 is provided in the main menu block 130. Alternatively, the ‘My menu’ block may be initiated by pressing a button “My menu” in the ‘My menu’ block 120.

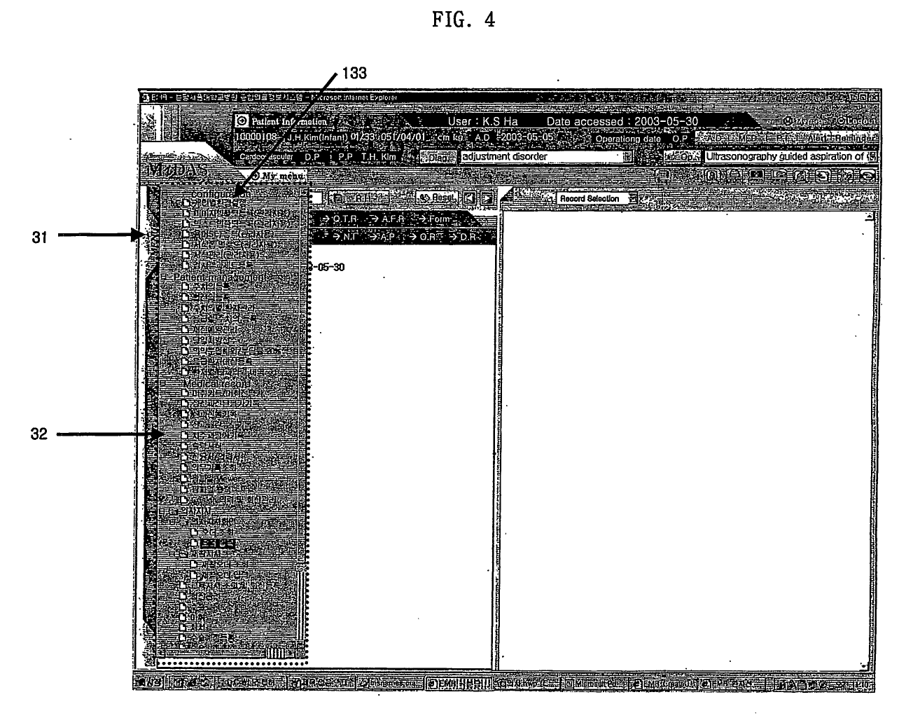

The main menu block 130 displays all menu items that can be used by the physician, which will be described below in detail with reference to FIG. 4.

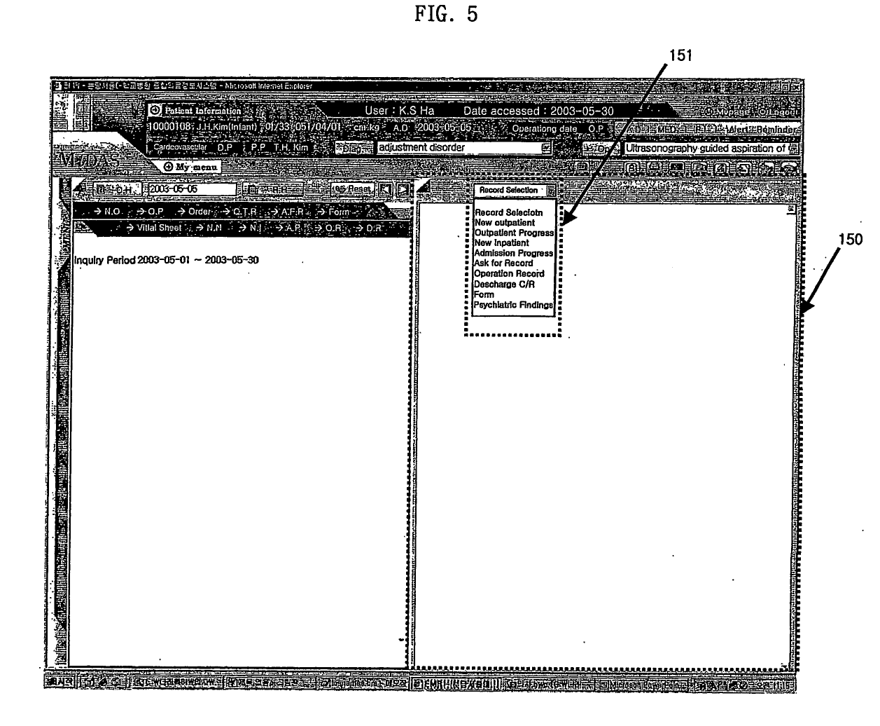

The patient information view block 140 allows a user to view detailed information on patients, which is stored in the patient information management unit 13. As shown, the physician can selectively view information on New outpatient, Outpatient Progress, Order, Check Test Result, Ask for Referral, Form, Vital sheet, Nursing notes, New inpatient, Admission Progress, Operation Record, Discharge Record, and so on. Referring to FIG. 2, the patient information view block 140 displays a substantially blank status, suggesting that information viewing has not yet been selected. Here, among information items displayed from the patient information view block 140, New outpatient, Outpatient Progress, New inpatient, Admission Progress, and so on, are retrieved from the patient information management unit 13 that has been input by the physician through the patient information input block 150. The patient information view block 140 will later be described in detail with reference to FIG. 5.

The patient information input block 150 allows the physician to enter a variety of information necessary in the course of performing medical care actions, including columns for entries of New outpatient, Outpatient Progress, New inpatient, Admission Progress, Ask for Referral, Operation Record, Discharge Record and other information, that can be shared by all physicians. Also, additional menu items, such as Medical Certificate/Request, Form, or Psychiatric Findings, may also be entered. As described above, the information that the physician has entered through the patient information input block 150 is stored in the patient information management unit 13 of the service providing system 10. If the physician clicks on a menu item from the patient information view block 140 on the physician's web screen to request for the corresponding information, the controller 12 retrieves the corresponding information and displays the same on the physician's web screen. The patient information input block 150 will later be described in detail with reference to FIG. 5.

FIG. 3A is an exemplary ‘Patient Selection’ screen activated from the web browser screen provided by the online medical information management method according to the present invention, and FIG. 3B is an exemplary order input screen activated from the web browser screen provided by the online medical information management method according to the present invention.

When the physician has logged in and the physician's web screen shown in FIG. 2 has been activated, a menu window 160 for activating the physician's web screen display and patient selection screen is activated, as shown in FIG. 3A.

However, the menu window 160, by which a patient is selected, which will be briefly referred to as a “patient selection window” hereinafter, can be simultaneously activated in the form of a pop-up window when the physician's web screen is activated, as described above. Alternatively, the menu window 160 can be activated by the user (physician) clicking on the shortcut icon for activating patient selection, which is provided in the ‘My menu’ block 120 shown in FIG. 2 or the patient selection menu item in the main menu block 130.

Meanwhile, the physician may review a patient through menu options displayed on the patient selection window 160 shown in FIG. 3A, including hospital ward, outpatient, emergency, operation place, consulted patient, department concerned, designated physician, primary care physician and so on. However, not all physicians are able to access to view the information on every patient. Also, not all physicians are able to correct or enter the information on every patient. That is, viewing of the information on a patient who needs to be specially managed may be limited to a designated physician, a primary care physician, and/or a few physicians. In most cases, all physicians are allowed to view the information on all the patients while only a limited number of physicians, e.g., a designated physician or a primary care physician, are allowed to correct and/or enter patient information.

When a patient visits the hospital that provides the service according to the present invention for the first time, basic information on the patient is input to the system through the administrative staff terminal 50 in the hospital reception areas and stored in the patient information management unit 13, thus allowing the physician to view the patient information. In other words, the initial information on the New Patient is stored in the patient information management unit 13 of the service providing system 10 through the administrative staff terminal 50. Later on, the stored patient information can be viewed or updated by other physicians or nurses.

Although not shown in the drawings, the physician can check a waiting list of patients waiting for medical care by clicking on a menu option for patients on a waiting list in the ‘My menu’ block 120 or the main menu block 130; or can retrieve patient information in the order of the waiting list. The waiting list is also stored in the patient information management unit 13 as entered by date through the administrative staff terminal 50 or the physician terminal 20.

As described above, the user, i.e., the physician, selects a patient to be serviced through the patient selection window 160 or the waiting list. Once the patient is selected, patient information of the selected patient, including name, sex, age, patient number, designated physician, primary care physician, and so on, is displayed on the user information display block 10 on the physician's web screen shown in FIG. 2.

If the physician selects the patient, the basic information on the selected patient is displayed on the user information display block 10 and such a screen for an order input window 170 as shown in FIG. 3B may also be displayed at the same time. The order input window 170 allows the physician to enter various orders regarding treatment method, examination request, prescription request, nursing method, injections and so on, as instructions to relevant departments according to the care results.

As shown in FIG. 3B, the order input window 170 includes an order input block 171, an order view block 172 and an order menu block 173 containing menu options associated with each order. That is to say, the order information selected by the order menu block 173 and input through the order input block 171 is stored in the patient information management unit 13 of the service providing system 10. If the physician request the stored information, the information is displayed through the order view block 172. Also, the order information input through the order input window 170 can be viewed by nurses, clinical laboratory staff members or administrative staff members, so that they can take proper actions according to the order details.

As described above, the order input window 170 is activated simultaneously with the patient information. In addition, like the patient selection window 160, the order input window 170 may be activated by clicking on the shortcut icon for activating patient selection, which is provided in the ‘My menu’ block 120 shown in FIG. 2 or on the patient selection menu item in the main menu block 130.

FIG. 4 is an exemplary main menu block screen activated from the web browser screen provided by the online medical information management method according to the present invention, illustrating the main menu block 130 of the physician's web screen shown in FIG. 2.

In other words, if a menu button 131 of the main menu block 130 is clicked, the menu selection window 132 being in a tree form is activated. Here, the menu selection window 132 has all possible menu items that can be used on the physician's web screen in a tree form.

For example, a shortcut icon of the ‘My menu’ block 120 can be set by user through an individual configuration menu 133 included in the menu selection window 132. The menu selection window 132 includes not only the configuration menu 133 but also a variety of menu options including a menu option of the order input window 170, and a menu option of the patient selection window 160. Here, a menu option of a variety of recording sheets used in the patient information input block 150, a menu option of a variety of recording sheets used in the patient information view block 140, and a menu option of request for viewing of a variety of record information usually take predetermined formats. Thus, these menu options may not be given on the menu selection window 132. The patient information input block 150 and the patient information view block 140 will now be described in detail.

FIG. 5 is an exemplary initial screen of a ‘Patient Information’ input block activated from the web browser screen provided by the online medical information management method according to the present invention, illustrating the patient information input block 150 of the physician's web screen shown in FIG. 2.

The patient information input block 150 shown in FIG. 5 allows a physician to enter patient care related care information to be written down in the course of performing care on the patient in a computerized, systematic manner, which has conventionally been in the form of paper-based charts. To this end, the patient information input block 150 may include various menu options including new outpatient, Outpatient Progress, New inpatient, Admission Progress, Ask for Referral, Operation Record, and Discharge Record and so on, in a record selection column 151. These menu options are required for entry of results of medical care actions for New outpatient, entry of results of medical care actions for Outpatient Progress, entry of information necessary for New inpatient, entry of information on care actions created by Admission Progress, entry of information necessary for asking for a referral to other department(s), entry of patient information necessary for operation, entry of information necessary for discharge, and so on.

The above-listed menu items can all be shared by physicians. Some physicians may have to prepare a variety of Medical Certificate/Request. The Medical Certificate/Request menu item is included in the record selection column 151. In addition to the mentioned menu items, there may be so many different styles of forms for each department concerned. However, all forms used in different departments cannot be universally formatted. Thus, a ‘Form’ menu item is included in the record selection column 151, thereby allowing forms to be created by department concerned as needed. In other words, when the user (physician) selects the form menu item, a specific formulated form is not output. Rather, a variable form is output, which allows the user to create a characteristic form customized for each department concerned. In particular, the psychiatric department may require a variety of different styles of forms. In order to meet such a requirement, a menu item for psychiatric findings is separately provided in the record selection column 151.

Meanwhile, the patient information entered through the respective menu items of the record selection column 151 can be viewed through various menu items of the patient information view block 140.

Next, the patient information input block 150 When the user, i.e., the physician, selects the respective menu item of the record selection column 151, and the patient information view block 140 associated therewith will be described.

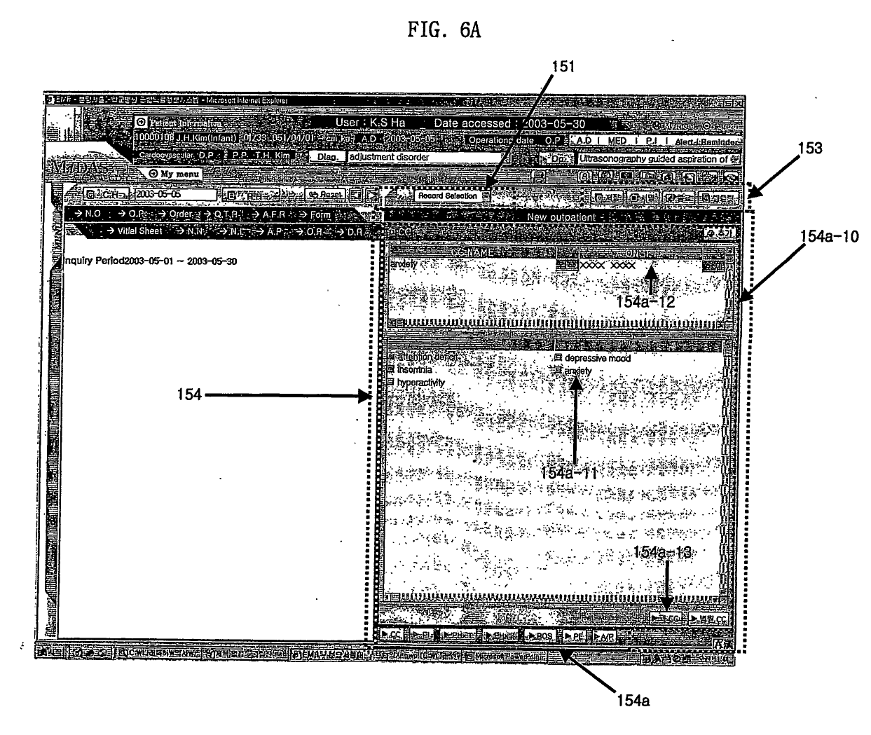

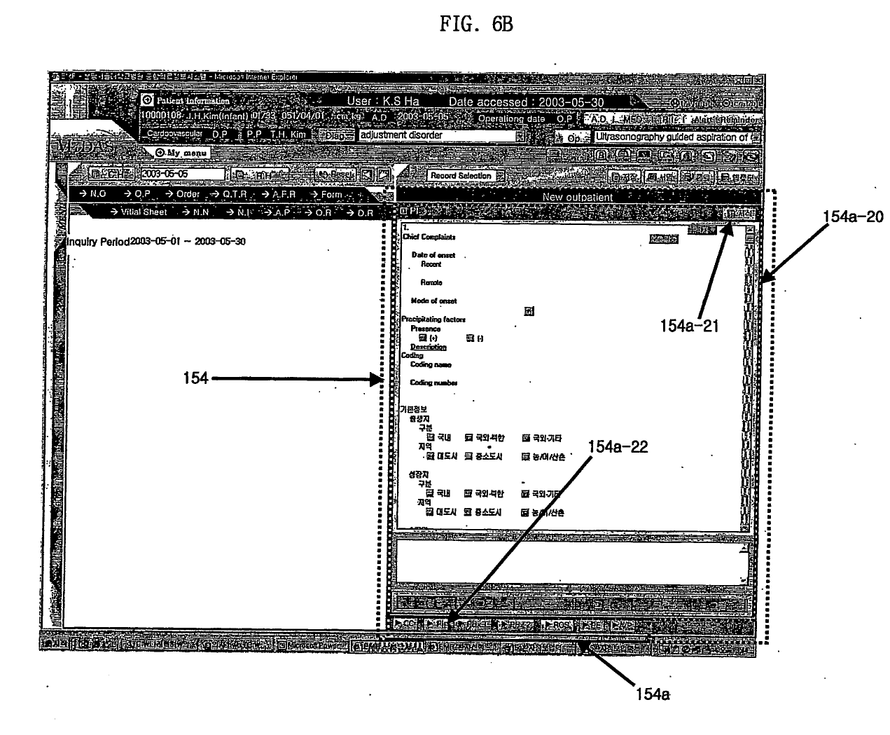

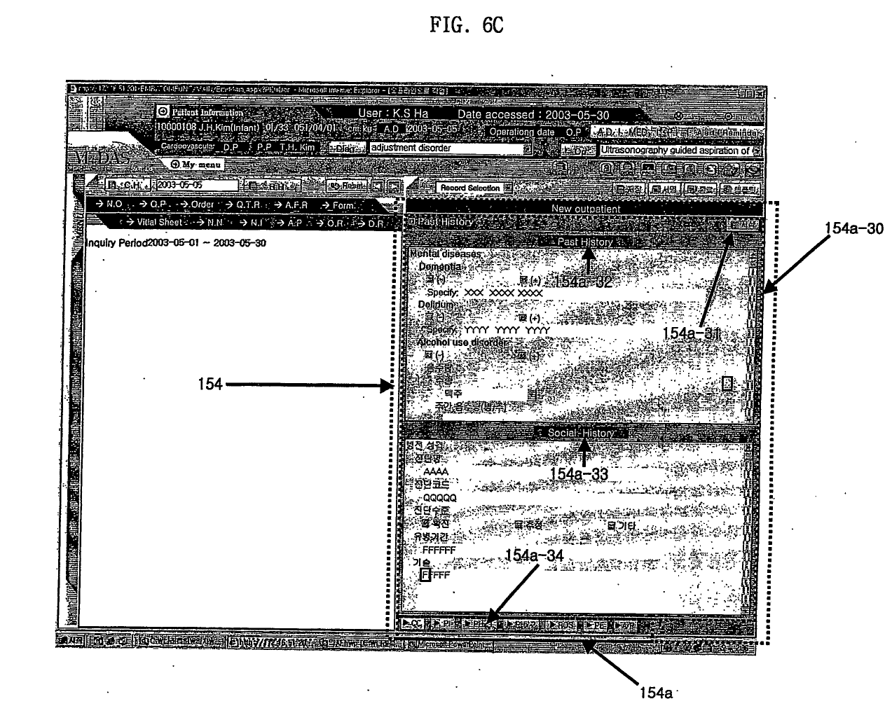

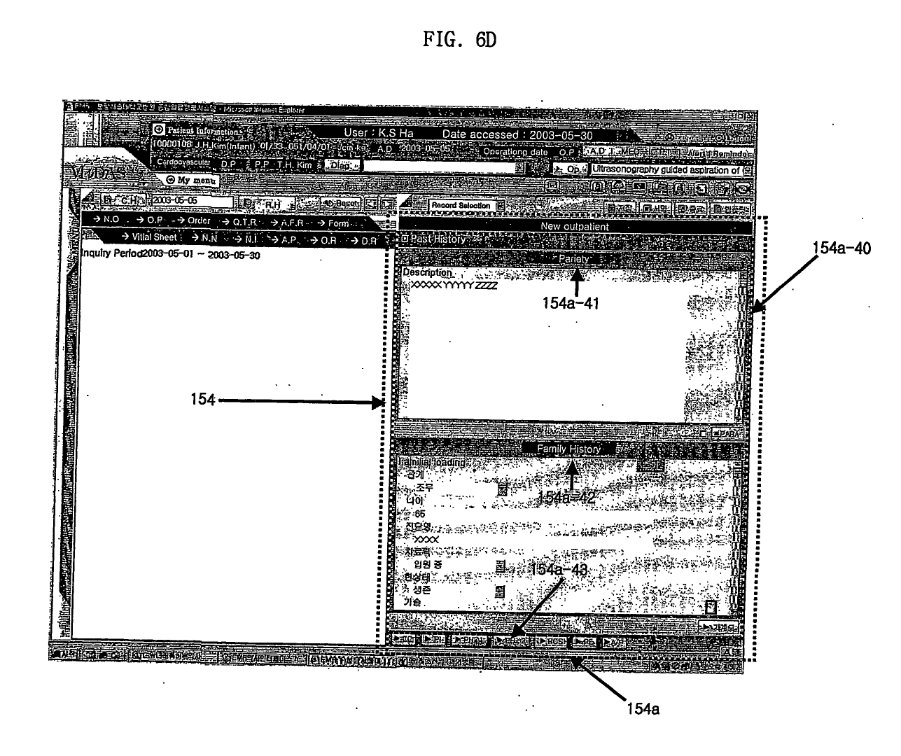

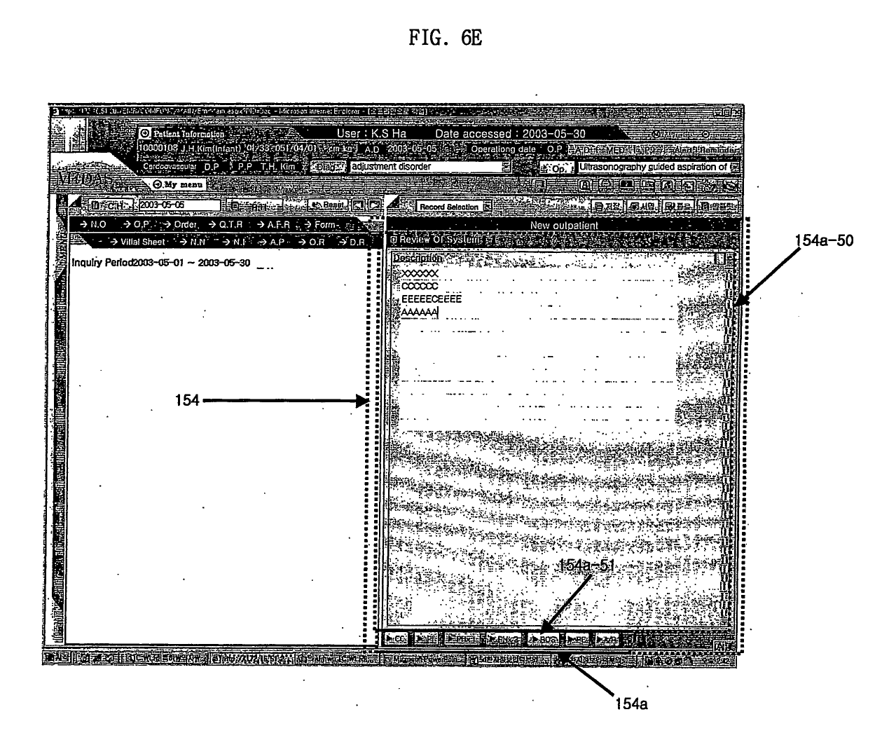

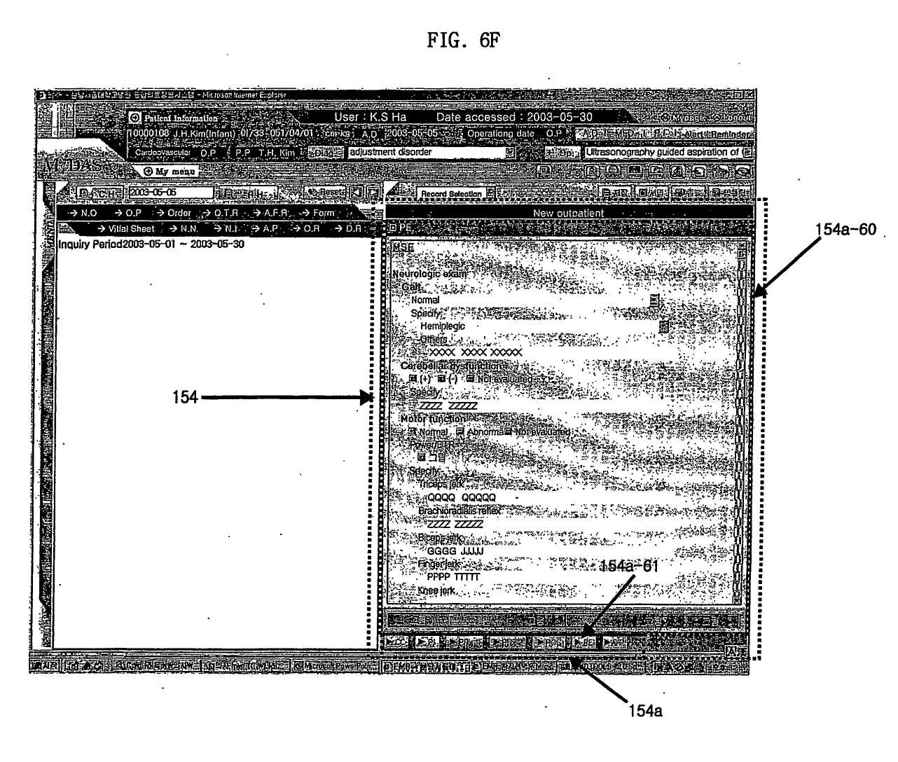

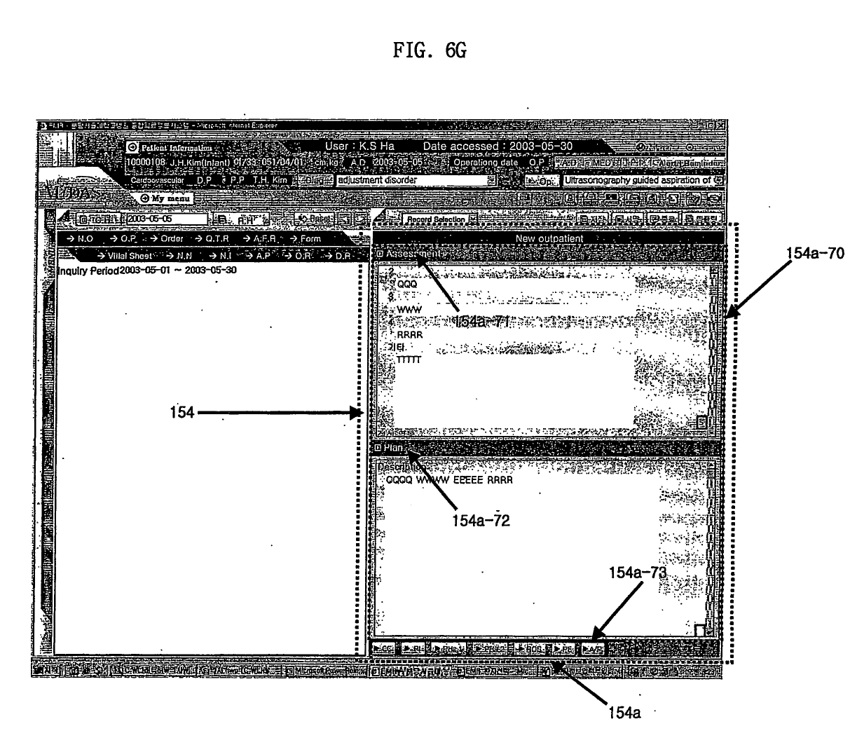

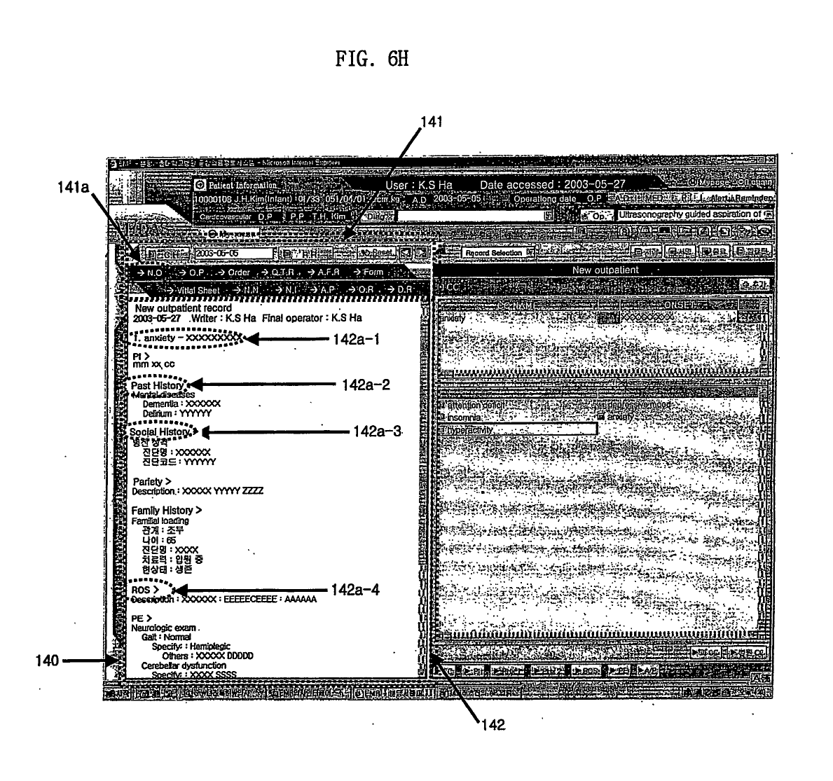

FIGS. 6A through 6H illustrate various exemplary screens displayed when a ‘New Outpatient’ menu item is selected from the patient information input block activated from the web browser screen provided by the online medical information management method according to the present invention.

As shown in FIG. 6A, the patient information input block 150 shown in FIG. 5 is largely divided into three blocks: record selection column 151; status storage block 153; and status input block 154. That is to say, only the record selection column 151 is displayed on an initial screen of the patient information input block 150, as shown in FIG. 5. Once any one menu item is selected from the record selection column 151, as shown in FIG. 6A, the status storage block 153 and the status input block 154 are activated. Here, the status storage block 153 causes the patient information input through the status input block 154 to be stored in the patient information management unit 13 of the service providing system 10 or the input information to be signed for confirmation.

The record selection column 151 and the status storage block 153 of the patient information input block 150 shown in FIG. 6A are represented in the same format irrespective of the kind of the menu item selected from the record selection column 151, while the status input block 154 may be represented in different formats depending on the kind of the menu item selected from the record selection column 151 or another submenu item included in the selected menu item.

Referring to FIG. 6A illustrating exemplary screens displayed when a ‘New Outpatient’ menu item is selected from the record selection column 151, when the New outpatient menu item is selected, the status input block 154 includes a ‘New Outpatient’ menu block 154a consisting of 7 submenu items and a status information input window 154a-10 selected by the New outpatient menu block 154a. Here, the New outpatient menu block 154a is not changed in format in a state in which the New outpatient menu item is selected. However, the format of the status, information input window 154a-10 may vary according to the menu item selected by the New outpatient menu block 154a.

The New outpatient menu block 154a includes 7 submenu items, including chief complaint (CC), present illness (PI), past history1 (PHx1), past history2 (PHx2), review of systems (ROS), physical examination (PE) and treatment plan (ANP). In particular, the status input block 154 shown in FIG. 6A displays a chief complaint status input block 154a-10 When the CC menu item is selected.

The chief complaint status input block 154a-10 further includes a CC selection section 154a-11 and a CC details input section 154a-12. Since a wide variety of CC items are used in the respective departments throughout the whole hospital, the physician can search for CC items that are not displayed on the CC selection section 154a-11 by clicking on a CC search button 154a-13. Here, the information supplied when the user, i.e., the physician, clicks on the button 154a-13, is stored in the service providing system 10.

After the physician enters information necessary for understanding of the patient's chief complaint, the physician selects a shortcut icon on the status storage block 153 to activate storage of the information. Here, the information is stored in the patient information management unit 13 of the service providing system 10.

FIG. 6B illustrates the status input block 154 When the user (physician) selects a present illness (PI) menu item 154a-22 from the submenu item 154a of the New outpatient menu item, illustrating a PI information input window 154a-20.

Here, items necessary for patient's present illness may differ depending on the department concerned. Thus, after the user (physician) clicks on the form menu item 154a-21 to initiate a form selection window, the user selects a desired form and then fills in the form with necessary items.

The variety of information displayed on the PI information input window 154a-20 can be entered by the user ticking or typing. That is to say, as shown, the PI information input window 154a-20 is formatted such that the user (physician) can tick a menu item corresponding to a patient's place of birth, or can directly type the pertinent content on an input window displayed when the user selects a Description menu item.

After the user (physician) enters necessary information, the user clicks on a shortcut icon on the status storage block 153 for storage of the information, as described in FIG. 6A.

FIG. 6C illustrates the status input block 154 When the user (physician) selects a past history1 (PHx1) menu item 154a-34 from the submenu item 154a of the New outpatient menu item, illustrating a PHx1 information input window 154a-30.

Here, the input window 154a-30 is formatted such that various items can be selected by ticking or directly typing, as described in FIG. 6B, which is also applied to descriptions that follows.

As described in FIG. 6B, items necessary for patient's present illness may differ depending on the department concerned. Thus, after the user (physician) clicks on the form menu item 154a-31 to initiate a form selection window, the user selects a desired form and then fills in the form with necessary items.

Meanwhile, referring to FIG. 6C, the past history is classified into two subtitle items of past history 154a-32 and social history 154a-33, allowing the user (physician) to enter the corresponding information, thereby recording details of patient's past history.

After entry of the necessary information is completed, as described in FIG. 6A, the user (physician) clicks on a shortcut icon on the status storage block 153 for storage of the information.

FIG. 6D illustrates the status input block 154 When the user (physician) selects a past history2 (PHx2) menu item 154a-43 from the submenu item 154a of the New outpatient menu item, illustrating a PHx2 information input window 154a-40.

Here, the past history shown in FIG. 6D is different from the past history shown in FIG. 6C. That is, the past history shown in FIG. 6D includes family members' past history information 154a-42 as well as patient's important records 154a-41, such as pregnancy, while the past history shown in FIG. 6C includes patient's disease history.

After entry of the necessary information is completed, as described in FIG. 6A, the user (physician) clicks on a shortcut icon on the status storage block 153 for storage of the information.

FIG. 6E illustrates the status input block 154 When the user (physician) selects a review of systems (ROS) menu item 154a-51 from the submenu item 154a of the New outpatient menu item, illustrating an indefinable information input window 154a-50.

The ROS menu item is provided for entry of patient information that is unable to belong to any one of the categories described above.

After entry of the necessary information is completed, as described in FIG. 6A, the user (physician) clicks on a shortcut icon on the status storage block 153 for storage of the information.

FIG. 6F illustrates the status input block 154 When the user (physician) selects a physical examination (PE) menu item 154a-61 from the submenu item 154a of the New outpatient menu item, illustrating a visual health condition information input window 154a-60.

When a picture file illustrating the visual health condition of the patient is available, the picture file can be attached and stored. Here, the picture file can be stored in the patient information management unit 13 or the image information management unit 14.

After entry of the necessary information for the visual health condition information input window 154a-60 is completed, as described in FIG. 6A, the user (physician) clicks on a shortcut icon on the status storage block 153 for storage of the information.

FIG. 6G illustrates the status input block 154 When the user (physician) selects a treatment plan (A/P) menu item 154a-73 from the submenu item 154a of the New outpatient menu item, illustrating an ANP information input window 154a-70.

That is, the ANP information input window 154a-70 is provided for entry of information on the plan about the treatment to be applied to the establish patient based on the assessment obtained from the patient's first visit, by which the physician can utilize the ANP information entered through the input window 154a-70 in next care actions for the same patient.

Referring to FIG. 6G, the ANP menu item is categorized into two submenu items, that is, assessment 154a-71 and plan 154a-72.

After entry of the necessary information for the A/P information input window 154a-70 is completed, as described in FIG. 6A, the user (physician) clicks on a shortcut icon on the status storage block 153 for storage of the information.

FIG. 6H illustrates the status input block 154 When the user (physician) selects a treatment plan (A/P) menu item 154a-73 from the submenu item 154a of the new outpatient menu item, illustrating an A/P information input window 154a-70.

That is, the A/P information input window 154a-70 is provided for entry of information on the plan about the treatment to be applied to the patient based on the assessment obtained from the new patient. The physician can utilize the A/P information input through the input window 154a-70 in next care actions for the same patient.

FIG. 6H illustrates a screen displayed when viewing New outpatient information input through the process shown in FIG. 6A through FIG. 6G.

The patient information view block 140 shown in FIG. 2 includes a view menu box 141 and a view display box 142, as shown in FIG. 6H. In particular, in order for the user (physician) to check new outpatient information input through the process shown in FIG. 6A through FIG. 6G, the physician selects a ‘New Outpatient’ menu item 141a of the view menu box 141. In other words, when the physician selects the new outpatient menu item 141a of the view menu box 141, the controller of the service providing system 10 retrieves the New outpatient information of a pertinent patient from the patient information management unit 13 and transmits the same to the physician terminal 20 to be displayed on the view display box 142.

The information displayed on the view display box 142, which is input through the patient information input block 150, is selectively input through the new outpatient menu item among menu items of the record selection section 151 for 7 submenu items, including chief complaint (CC), present illness (PI), past history1 (PHx1), past history2 (PHx2), review of systems (ROS), physical examination (PE) and treatment plan (A/P).

Multiple kinds of information input for the respective 7 submenu items are displayed in the view display box 142, as shown in FIG. 6H.

In more detail, the view display box 142 shown in FIG. 6H includes a variety of information 142a-1 input through the CC menu item shown in FIG. 6A, information 142a-2, 142a-3 input through the PHx-1 menu item shown in FIG. 6C, information 142a-4 input through the ROS menu item shown in FIG. 6E, information input through the process shown in FIGS. 6B, 6D, 6D, 6F and 6G.

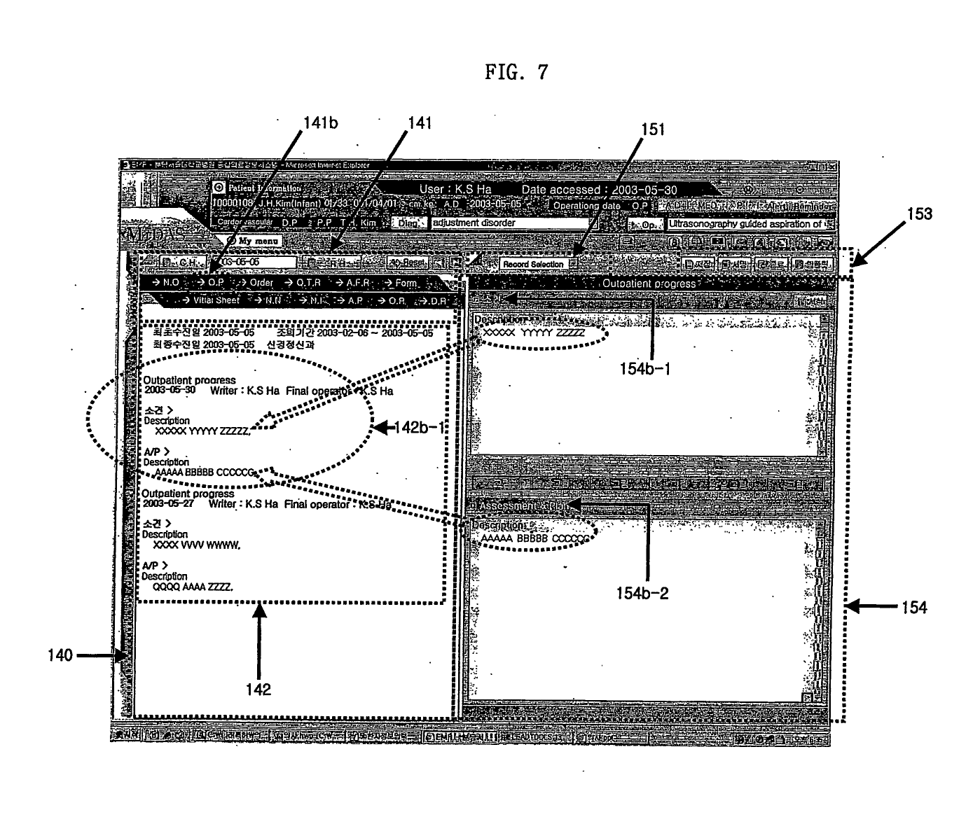

FIG. 7 illustrates an exemplary screen displayed when an ‘Outpatient Progress’ menu item is selected from the patient information input block activated from the web browser screen provided by the online medical information management method according to the present invention.

The outpatient progress menu item is provided for recording contents of a care action given When the patient has already undergone care services based on the process shown in FIGS. 6A through 6H. As shown, the outpatient progress status input block 154 is divided into an opinion column 154b-1 and an Assessment & Plan column 154b-2, so that the corresponding contents are separately recorded.

At this stage, the physician inputs necessary information to the respective columns of the status input block 154. After entry of the necessary information is completed, the physician clicks on a shortcut icon in the status storage block 153 for storage of the information, as described above in FIG. 6A.

The information input through the status storage block 153 can be viewed from the patient information view block 140.

In other words, if the physician selects the Outpatient progress menu item 141b of the view menu box 141, the controller of the service providing system 10 retrieves the outpatient progress information concerning the patient from the patient information management unit 13 and transmits the same to the physician terminal 20 to then be displayed on the view display box 142.

As described above, the information displayed on the view display box 142 is input through the opinion column 154b-1 and the A/P column 154b-2.

That is, the information displayed on the view display box 142 includes information (XXXXX YYYYY ZZZZZ) of the opinion column 154b-1 and the information (AAAAA BBBBB CCCCCC) of the ANP column 154b-2.

Here, the view display box 142 includes the last information input through the patient information input block 150 and information pieces previously recorded in an order of entry dates, so that the physician can quickly understand past and present medical information of his/her patient. That is, as shown, the Outpatient progress information input on May 27, 2003 and the Outpatient progress information 142b-1 input on May 30, 2003 are sequentially displayed.

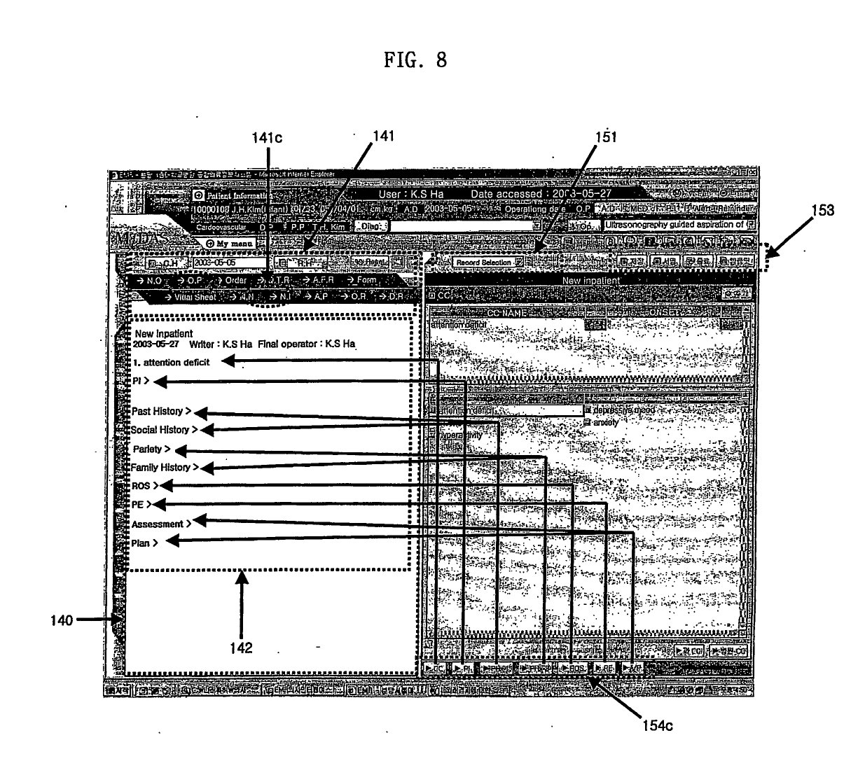

FIG. 8 illustrates an exemplary screen displayed when a ‘New Inpatient’ menu item is selected from the patient information input block activated from the web browser screen provided by the online medical information management method according to the present invention, illustrating menu items necessary for recording contents of care actions performed in the new inpatient.

Here, methods of inputting information when the new inpatient menu item shown in FIG. 8 is selected, and viewing the information are substantially the same as those in the case of the New outpatient menu item shown in FIGS. 6A through 6H.

If the New inpatient menu item is selected from the record selection column 151 of the patient information input block 150, a new inpatient menu block 154c for selecting 7 submenu items is displayed, the 7 submenu items including chief complaint (CC), present illness (PI), past history1 (PHx1), past history2 (PHx2), review of systems (ROS), physical examination (PE) and treatment plan (A/P).

After the physician selects a desired menu item among the 7 submenu items, he/she enters necessary information. In order to store the information, the physician clicks on a shortcut icon on the status storage block 153 for storage of the information. At this time, the physician clicks on a shortcut icon corresponding to each submenu item for activating storage of the information. Here, the entered information is stored in the patient information management unit 13 of the service providing system.

In order to view the entered New inpatient information, the physician selects the New inpatient menu item 141c of the view menu box 141. Here, the controller of the service providing system 10 retrieves the New inpatient information concerning the patient from the patient information management unit 13 and transmits the same to the physician terminal 20 to then be displayed on the view display box 142.

Here, the contents entered for the respective submenu items of the new inpatient menu item are sequentially displayed on the view display box 142. That is, the contents entered for chief complaint (CC), present illness (PI), past history1 (PHx1), past history2 (PHx2), review of systems (ROS), physical examination (PE) and treatment plan (A/P). For brevity and clarity, after entry of the content for the CC menu item is completed, the new inpatient menu item 141c is selected without further entry. Thus, only the content for the CC menu item, e.g., attention deficit disorder, is displayed in FIG. 8.

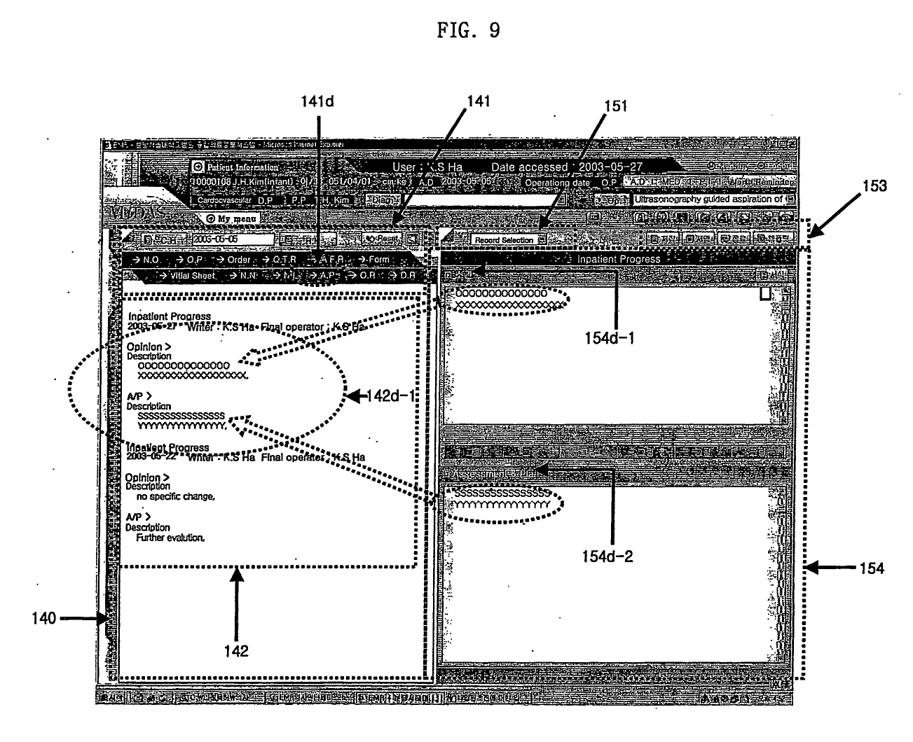

FIG. 9 illustrates an exemplary screen displayed when an ‘Admission Progress’ menu item is selected from the patient information input block activated from the web browser screen provided by the online medical information management method according to the present invention.

The Admission Progress menu is provided for recording contents of care actions given When the patient has already undergone care services based on the process shown in FIG. 8. Like in the outpatient progress menu item shown in FIG. 7, the admission progress status input block 154 is divided into two columns: an opinion column 154d-1 and an assessment & plan column 154d-2, thereby recording the corresponding contents separately.

A physician inputs necessary contents to the respective columns of the status input block 154, diagnosing and treating a patient who is in hospital. After recording the desired contents, the physician clicks on a shortcut icon on the status storage block 153 in the same manner as described in FIG. 6A.

The information input through the status storage block 153 by the same method as described above can be viewed from the patient information view block 140.

In other words, when a physician selects the admission progress menu item 141d from the view menu box 141, the controller of the service providing system 10 retrieves the Admission progress information on the patient from the patient information management unit 13, and transmits the same to the physician terminal 20 to then be displayed on the view display box 142.

The information 142d-1 displayed on the view display box 142, which has been input through the patient information input block 150, as described above, is the information input through the opinion column 154d-1 and the assessment & plan column 154d-2.

In other words, the information of the opinion column 154d-1 and the information of the assessment & plan column 154d-2, shown in the status input block 154 shown in FIG. 9, are displayed on the view display box 142.

The view display box 142 displays not only the last information input through the patient information input block 150 but also the information previously recorded in an order of entry dates. Therefore, the physician can quickly grasp the past and present medical information on the patient. As shown, the Admission progress information input on May 22, 2003 and the outpatient progress information 142d-1 input on May 27, 2003 are displayed sequentially.

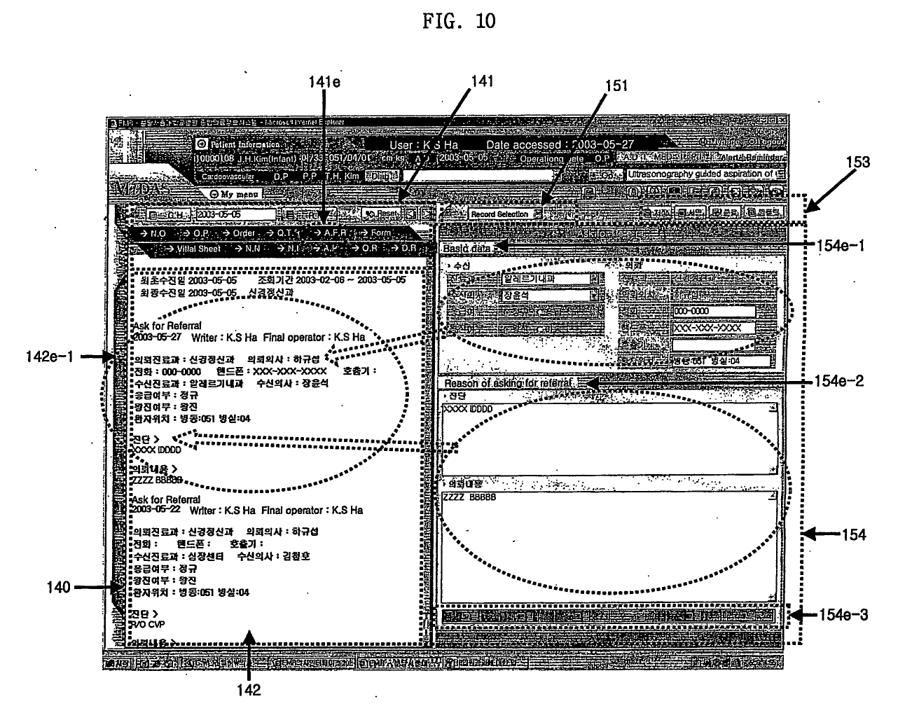

FIG. 10 illustrates an exemplary screen displayed when an ‘Ask for Referral’ menu item is selected from the patient information input block activated from the browsers screens provided by the online medical information management method according to the present invention.

The Ask for Referral menu item is provided for inputting information on another physician to whom the physician intends to ask for referral for the patient and contents related to the referral. As shown in FIG. 10, the ask for referral status input block 154 is divided into two columns: a basic data column 154e-1 and a referral asking reason column 154e-2. The basic data column 154e-1 is for recording the information on the both asking and asked physicians and the basic information on the patient referred, while the referral asking reason column 154e-2 is for recording referral asking reasons.

The referral asking reason column 154e-2 is subdivided into two parts: a diagnosis part for recording the primary care physician's diagnosis results, and a referral content part for recording contents related to asking for referral. When it is necessary to attach a picture files, such as X-ray films or CT films, the physician can attach the necessary picture to the contents using the picture menu item 154e-3.

If the primary care physician of the patient requests for another physician's opinion or asks for referral to another physician of other department with respect to the patient's abnormal signs or symptoms in the course of performing care actions on the patient, the physician may input the contents related to the referral to the status input block 154. After recording the related contents, the primary care physician stores the recorded contents by clicking on a shortcut icon on the status storage block 153, as described in FIG. 6A.

The information input through the status storage block 153 can be viewed from the patient information view block 140.

In other words, if the physician selects the ask for referral menu item 141e of the view menu box 141, the controller of the service providing system 10 retrieves the ask for referral information concerning the patient from the patient information management unit 13 and transmits the same to the physician terminal 20 to then be displayed on the view display box 142.

The information displayed on the view display box 142 is input through the patient information input block 150, as described above. Accordingly, the information has been input through both the basic data column 154e-1 and the referral asking reason column 154e-2.

In other words, the information on the basic data column 154e-1 and the information of the referral asking reason column 154e-2, included in the status input block 154 shown in FIG. 10, are displayed on the view display box 142. Therefore, the primary care physician can check the contents related with referral for the patient.

As described above, the view display box 142 displays not only the last information but also the information which has already been recorded in an order of entry dates through the status input block 150. Thus, the physician can quickly grasp the past and present contents related with referral for the patient.

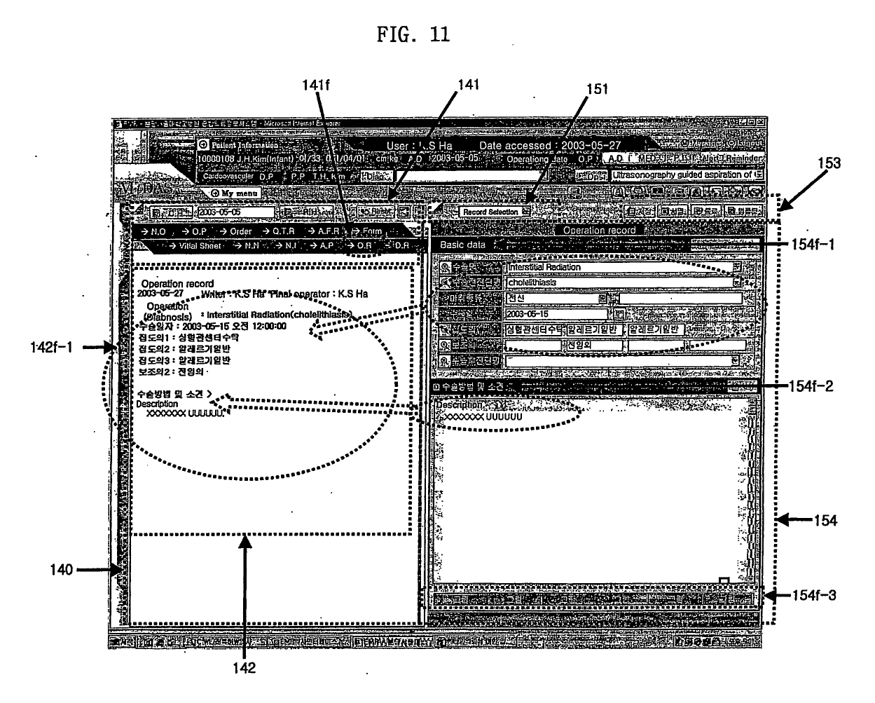

FIG. 11 illustrates an exemplary screen displayed when an ‘Operation Record’ menu item is selected from the patient information input block activated from the web browser screen provided by the online medical information management method according to the present invention.

The operation record is an item for recording the contents of operation results when an operation is performed on the patient in the course of care. The operation record menu item is divided into two columns: a basic data column 154f-1 and an operation method & opinion column 154f-2. The basic data column 154f-1 is for inputting Operation, nature of illness diagnosed before operation, anesthesia type, operation date, chief operating physician, assistant physician, and diagnose name after operation, and the operation method & opinion column 154f-2 is for recording operation method and findings after operation.

When it is necessary to add the pictures taken in operation or necessary pictures, the physician can add them through the picture menu item 154f-3.

When a patient has undergone an operation, a physician who takes charge of the patient can input and store all kinds of information related with the operation. Accordingly, after inputting the operation results, the physician clicks on the shortcut icon of the status storage block 153 as described in FIG. 6A. The operation record information input through the status storage block 153 can be viewed from the patient information view block 140 by the same method as described above.

Accordingly, when the physician selects the operation menu item 141f of the view menu box 141, the controller of the service providing system retrieves the operation record information on the patient from the patient information management unit 13, transmits the same to the physician terminal 20 to then be displayed on the view display box 142.

The information displayed on the view display box 142 is the same as the information input through the patient information input block 150 as described above. The information has been input through the basic, data column 154f-1 and the operation method & opinion column 154f-2.

In other words, the information on the basic data column 154f-1 and the information on the operation method & opinion column 154f-2 shown in the status input block in FIG. 11 are displayed on the view display box 142. Therefore, the primary care physician can check the patient's operation record.

The view display box 142 displays not only the last information input through the patient information input block 150 but also the information which has already been recorded in an order of entry dates as described above. Thus, the physician can quickly grasp the past and present operation record for the patient.

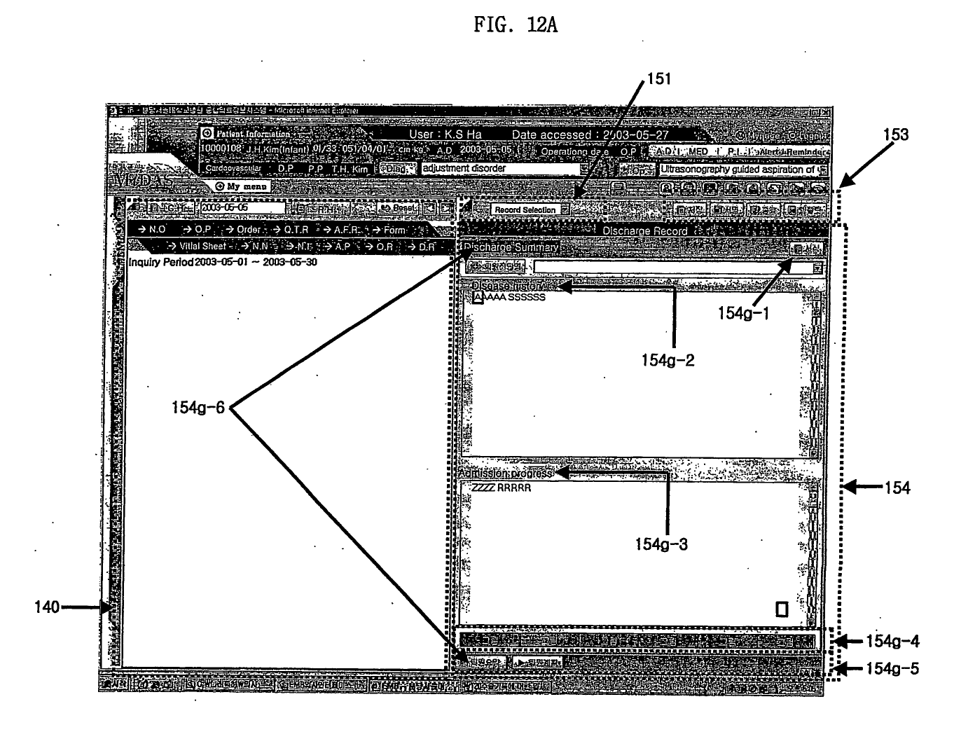

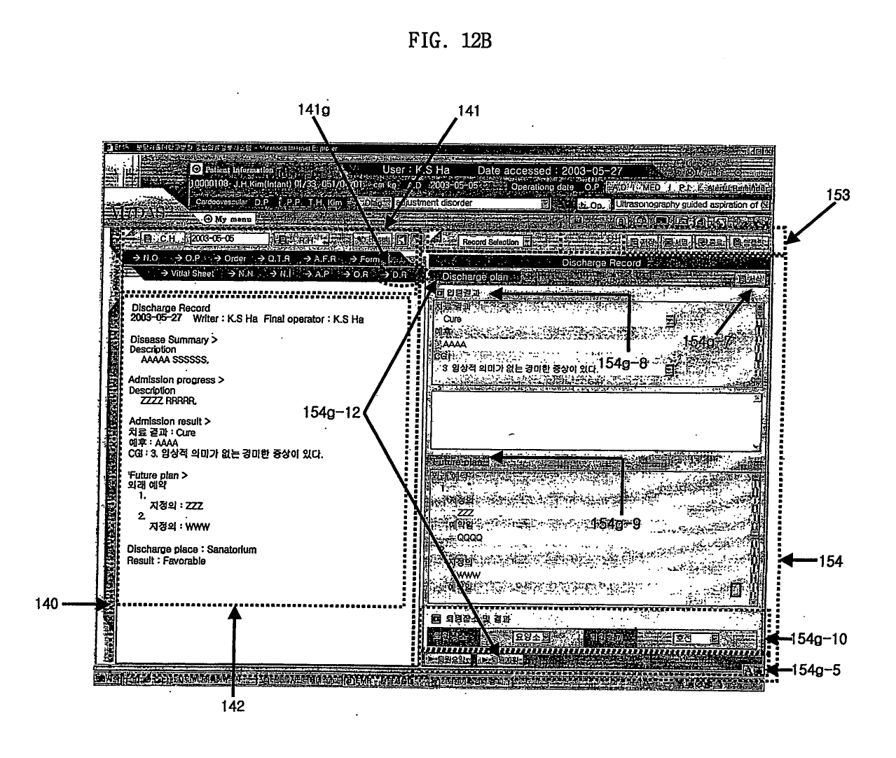

FIGS. 12A and 12B illustrate exemplary screens displayed when a ‘Discharge Record’ menu item is selected from the patient information input block 150 activated from the web browser screen provided by the online medical information management method according to the present invention.

The discharge record menu item is an item for recording contents on admission progress and treatment plan after discharge. The discharge record menu item is largely subdivided into two sections: discharge summary 154g-6; and discharge plan 154g-12. The discharge summary section 154g-6 is for inputting history summary 154g-2 and an admission progress 154g-3, as shown in FIG. 12A, while the discharge plan 154g-12 is for inputting an admission result 154g-8 and a future plan 154g-9, as shown in FIG. 12B.

When a user (physician) selects the discharge record menu item from the record selection block 151, the discharge record menu block 154g-5 is displayed in the status input block 154. FIG. 12A shows a screen displayed when the discharge summary menu item 154g-6 is selected from the discharge summary menu block 154g-5, and FIG. 12B shows a screen displayed when the discharge plan menu item 154g-2 is selected.

First, as shown in FIG. 12A, when the discharge summary menu item 154g-6 is selected, columns for inputting history summary 154g-2 and admission progress 154g-3 are displayed. The history summary column 154g-2 is for inputting a disease history, while the admission progress column 154g-3 is for inputting important events occurring during admission. Meanwhile, since contents to be recorded are different by department, a user (physician) can select a form through the form menu item 154g-1. If there is a characteristic form for discharge record used by department concerned, the user (physician) retrieves the form which he or she has stored in the service providing system from the form menu item, and enters necessary details. The details input by the physician are stored in the patient information management unit 13. In every case a characteristic form is selected as described above, the output forms may be stored in the service providing system after being made out by a special system, or after a physician himself or herself making out them.

The method for storing input details is the same as that described above; that is, just by the physician's clicking on the store menu item in the status storage block 153.

When the discharge summary menu item is selected, the status input block 154 has a picture menu item 154g-4, where all kinds of images created by the patient in hospital are added.

The information on the patient's discharge record stored by the input progress is stored in the patient information management unit 13 in the service providing system 10 as described above. If the physician selects the discharge record menu item 141g of the view menu box 141, he or she can view the above-described information. FIG. 12a shows a screen where the discharge record menu is item 141g is not selected, while FIG. 12B shows a screen where the discharge record menu item 141g is selected after the input progress has been performed. Accordingly, when the user selects the discharge record menu item 141g after inputting information provided by discharge summary, he or she can view only the information on discharge summary. Also, when the user selects the discharge record menu item 141g after inputting information on the discharge plan 154g-12, the user can view information on both discharge summary and discharge plan. On the contrary, when the user selects the discharge record menu item 141g after inputting information on discharge plan, the user can view only the information on discharge plan.

FIG. 12B, which illustrates an exemplary screen displayed when a discharge plan menu item 154g-12 is selected, includes an admission result 154g-8 and future plan 154g-9 are input. In the part for admission result 154g-8 where the progress according to admission is input, the information with regard to treatment result, prognosis, and CGI can be input, and in the section for future plan 154g-9, where examining plan after discharge is input, designated physician and examining date can be selected in case of outpatient. As shown in FIG. 12B, the status input block 154 of the discharge plan menu item has information section 154g-10 on discharge place and the discharge results. It shows the information on whether a patient goes to a sanitarium or home after discharge. And in this section the user (physician) can input the status of the patient, who goes to hospital to examine after discharge. In other words, he or she records whether the patient is good or not after discharge.

In FIG. 12B the status input block 154 in the discharge plan menu item also has a ‘Form’ menu item 154g-7 like the discharge summary menu item in FIG. 12A, so that the user (physician) can select a pertinent form for discharge plan.

After inputting all the necessary records, the user (physician) clicks the shortcut icon of the status storage block 153 as described above. The records are stored in the patient information management unit 13. After that, the physician can view the input information through the patient information view block 140.

When a physician selects the discharge record menu item 141g of the view menu box 141, the controller 12 of the service providing system retrieves the information on the discharge records of the patient from the patient information management unit 13, transmits the same to the physician terminal 20, and it is displayed on the view display box 142.

The information displayed on the view display box 142 is the same as the information input through the patient information input block 150 as described above. It shows not only the information on history summary 154g-2 and admission progress 154g-3 shown at the status input block in FIG. 12A, but also the information on admission result 154g-8 and future plan 154g-9 shown at the status input block in FIG. 12B.

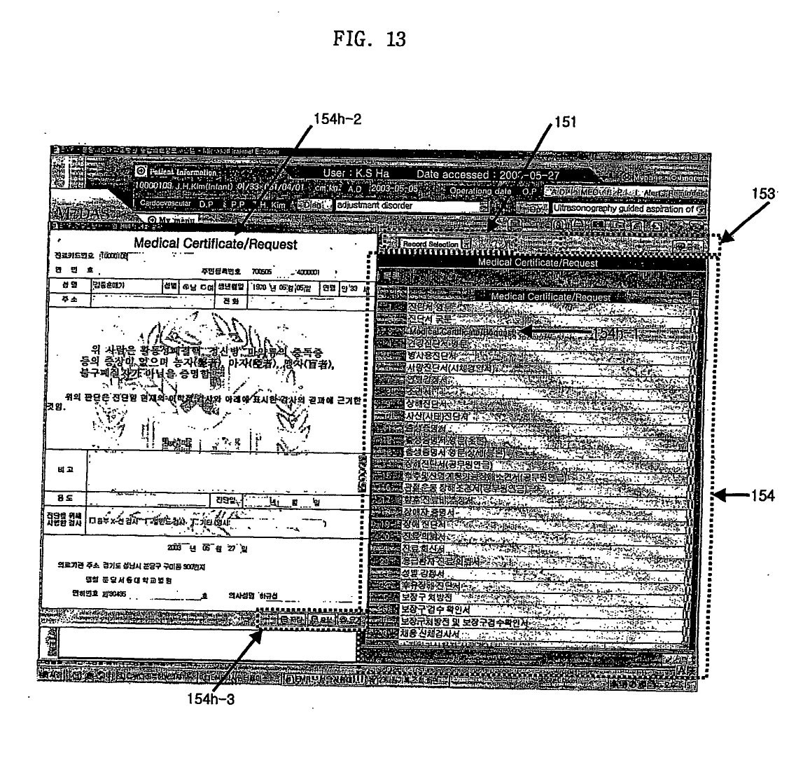

FIG. 13 illustrates an exemplary screen displayed when a ‘Medical Certificate/Request’ menu item is selected from the patient information input block activated from the web browser screen provided by the online medical information management method according to the present invention.

First, the Medical Certificate/Request menu item is used when it is necessary for a user (physician) to make out all kinds of medical certificate or Request for a patient who goes to be examined.

For example, when a physician should issue a health care medical certificate for a patient, the physician selects the Medical Certificate/Request menu item in the record selection block 151. Then, the Medical Certificate/Request menu item which is able to be issued is output in the status input block 154. Accordingly, in the status input block 154 various kinds of menu items such as medical certificate (in English), medical certificate (in Korean), health care medical certificate, health care medical certificate (in English), and opinion are output, and the physician selects health care medical certificate among the above menu items.

When the physician selects the health care medical certificate menu item, a pop-up window 154h-2 for inputting a health care medical certificate is output as shown in FIG. 13, and the physician enters the details.

The method of storing each menu item described above is that a physician clicks the shortcut icon on the status storage block 153, but in case of Medical Certificate/Request, the shortcut icon of the menu item 154h-3 in the pop-up window 154h-2 is supposed to be clicked. In addition, the status storage block 153 has an ending button to end a screen for inputting Medical Certificate/Request.

Furthermore, if the health care medical certificate is issued immediately after being output, it can be output through a printer, if the output menu item is selected in the above-described menu item 154h-3.

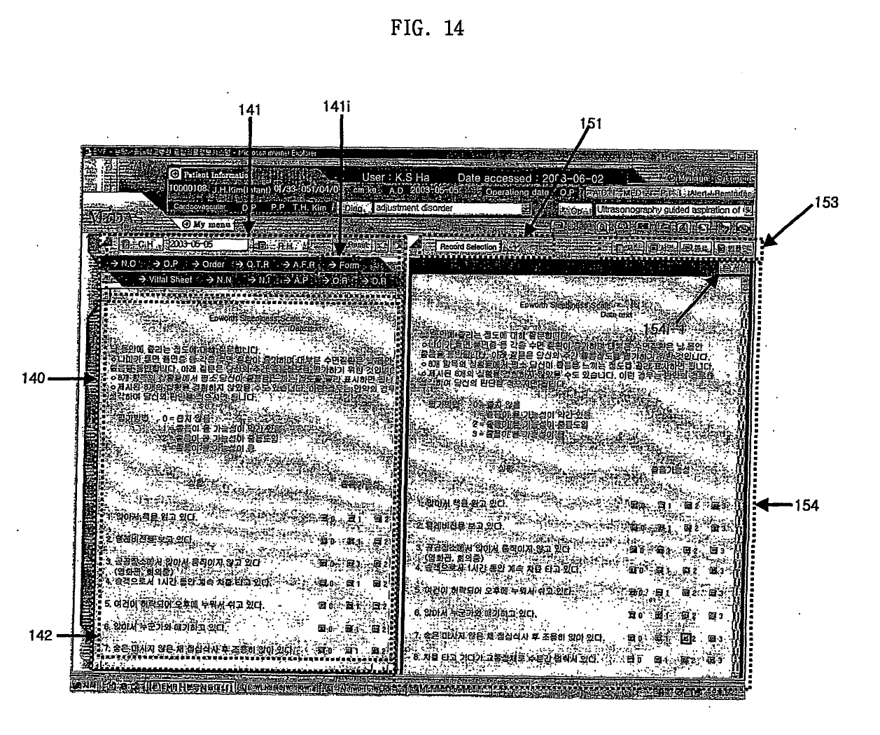

FIG. 14 illustrates an exemplary screen displayed when a ‘Form’ menu item is selected from the information input block activated from the web browser screen provided by the method of online medical management, which is provided by the present invention.

First, in the form menu item by department concerned it is possible to select form menu items which are not included in FIG. 6A to FIG. 13. That is, the menu items mentioned above can be commonly used regardless of department concerned, but the form menu item by department concerned is to collect forms which are omitted from the above-described menu items.

In addition, though not shown in any drawings, the diagnosing menu item for psychiatric findings of the recording selection block 151 shown in FIG. 5 is another necessary menu item for a special department concerned, and can be provided in a similar method to the form menu item by department concerned.

Here, a physician can select the form menu item by department concerned in the recording selection block 151, and then the menu item to select forms 154i-1 is displayed in the status input block 154. Accordingly, when a physician selects the above menu item 154i-1, all possible kinds of form menu item are displayed on a pop-up window, and then the physician selects a form he or she wants.

When the physician selects a desired form, the selected form is displayed in the status input block 154. In other words, FIG. 14 illustrates an exemplary screen displayed when a physician selects the menu item of Epworth Sleepiness Scale. As shown in FIG. 14, the pertinent form is displayed in the input block for patients' status 154.

Through consulting with a patient, the physician checks necessary items for the output form from the status input block 154. After checking them, the physician clicks on the shortcut icon on the status storage block 153. Here, the input contents are stored in the patient information management unit 13 of the service providing system. The information input in the above-described method can be viewed in the patient information view block 140.

In other words, when a physician selects the form menu item by department concerned 141i of the view menu box 141, the controller of the service providing system 10 retrieves the patient information on the form by department concerned from the patient information management unit 13, and transmits the same to the physician terminal 20 to then be displayed on the view display box 142.

So far, the respective menu items of the patient information input block 150 has been described in details with reference to FIGS. 5 through 14. In addition, the menu items of the patient information view block 140 with regard to the above menu items has also been described in details.

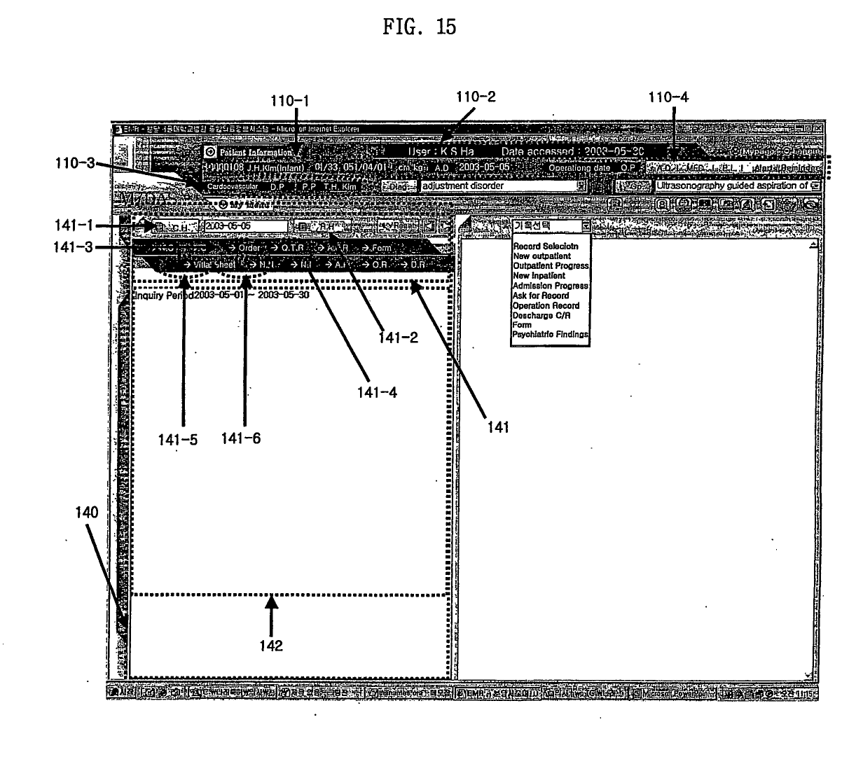

Hereinafter, the other menu items and functions of the patient information view block 140 and the user information display block 10, which have not been described above, will be described with reference to FIG. 15.

FIG. 15 illustrates an exemplary screen for explaining the patient information view block and the user information display block displayed on the web browser screen provided by the online medical information management method according to the present invention;

As described above, a physician's web screen according to the present invention is mainly divided: user information display block 10, My menu block 120, main menu block 130, patient information view block 140, and patient information input block 150. So far, among them the patient information input block 150 has been mainly described, and the patient information view block 140 has also been described together.

As shown in FIG. 15, the patient information view block 140 is divided into two categories: a view menu box 141 and a view display box 142. Among submenu items of the view menu box 141, there are shown some submenu items which have not been described.

In other words, except the menu items described above, the view menu box 141 includes submenu items for consultation record 141-1, record history 141-2, order 141-3, test request 141-4, vital sheet 141-5 and nursing note 141-6.

First, the consultation record menu 141-1 is for viewing the records about which a patient has received examining. When a physician selects the consultation record menu 141-1, a pop-up window appears. It shows all the records about which the patient has received examining.

Next, the record history menu 141-2 is for viewing the records where patient information has been input in the above-described method. When a physician selects the record history menu 141-2, a pop-up window appears. It shows all the histories which have been recorded about the patient according to each menu of the recording selection block 151.

Next, the order menu 141-3 is for viewing the orders input through the order input window 170 as shown in FIG. 3B. When a physician selects the order menu 141-3, the orders input to the view display box 142 are displayed.

Next, the test reference menu 1414 is for viewing the patients' information input by all kinds of tests. That is, the test reference menu 1414 enables a physician to view the test results, which have been input through a clinical laboratory staff terminal 40 and stored in the patient information management unit 13. Accordingly, when a physician selects the test reference menu 141-4, all kinds of test results stored in the patient information management unit 13 are displayed in the view display box 142.

Finally, the vital sheet menu 141-5 and the nursing note 141-6 are input by the nurse terminal 30. For example, when a physician wants to view the information measured by a nurse such as temperature, body weight, and blood pressure, the physician selects the vital sheet menu 141-5. In addition, when a physician wants to view nursing notes, which have been recorded while a nurse has generally been nursing a patient, he or she selects the nursing note menu 141-6. Accordingly, the above-described information input by a nurse is stored in the patient information management unit 13 and displayed on the view display box 142 or a pop-up window, when a physician selects the above menu.

The user information display block 10 will now be described. As shown in FIG. 2, the information 10-1 including the name of a physician has logged in, and the input date is displayed. When the logging-in physician selects a patient as shown in FIG. 3A, the information not only about the patient 10-2 but also about the department concerned to which the patient belongs, his or her designated physician and primary care physician 10-3.

As shown in FIG. 15, the user information display block 10 shows the menu item 104. The menu item is for viewing or inputting the detail information on a patient or an examining physician additionally.

FIG. 15 illustrates that the above-described menu 104 includes attending doctor, medication from order, patient information, alert and reminder as submenu items.

First, the attending doctor menu enables a user check the pertinent physician, if another physician except a primary care physician is designated for the patient.

Next, the medication from order menu enables a user to check the information on medication for the patient.

Then, the patient information menu enables a user (physician) to check more detail information for the patient than the patient information 10-2 displayed on the user information display block 10.

Finally, the alert menu and the reminder menu enable a physician to check important matters in examining the patient. If the patient has allergy, it is possible to check it in the alert menu, or if he or she has side effect in a certain medicine, a physician enters a message for it through the alert menu. In addition, if the patient is pregnant, it is possible to check the pregnancy from the alert menu. In other words, the alert menu enables to a physician to input characteristic information created while examining the patient.

Also, the reminder menu is for inputting the matters which are necessary for a physician to check in further examining progress. That is, in the alert menu and the reminder menu, a physician himself or herself can input necessary information while examining the patient. The input information is input in the patient information management block unit 13 and can be displayed in a pop-up window when the menu items are selected.

Meanwhile, when each menu for attending doctor, medication from order, and patient information is selected by a physician, a screen reference or an input screen can be shown through a pop-up window. Here, the physician himself or herself can input and register the information in the patient information management unit 13, or can check the information stored in the patient information management unit 13 by other terminals 30, 40 and 50.

By using the method of managing medical information online management according to the present invention, a physician can store the examining information for a patient in the patient information management unit 13 through network as soon as the physician has examined the patient. The physician can view the information on the patient whenever the physician wants to.

In addition, through network the physician not only can transmit all kinds of orders to nurses, laboratory staff or general staff but also can check all kinds of information input by nurses, laboratory staff or general staff whenever he or she wants to.

A method for providing medical information executed through a nurse terminal 30, that is, a method of managing medical information online implemented in the nurse terminal 30 according to the present invention When a nurse accesses the service providing system 10 through the nurse terminal 30 normally, will now be described with reference to FIGS. 16 through 24.

FIG. 16 illustrates an example from the web browser screen provided by the method of managing medical information online management, showing an initial screen for managing all kinds of medical information, when a nurse connects the service providing system through the nurse terminal 30 and logs in normally.

As described above, the nurse can access the service providing system 10 through the web browser of the nurse terminal 30, and can be provided all kinds of information if only he or she is authenticated normally by the authentication management unit 16 in the service providing system, or a public authentication system 60.

An exemplary web browser screen provided by the online medical information management method is shown in FIG. 16, illustrating an example from the web browser screen activated when a nurse selects a menu for management of a nurse's screen, which will be briefly referred to a nurse's web screen, after the nurse has normally logged in and connected to the service providing system 10. As shown in FIG. 16, the nurse's web screen is mainly divided into 5 blocks: user information display block 24, My menu block 220, main menu block 230, patient selection block 240, and patient information input/output block 250.

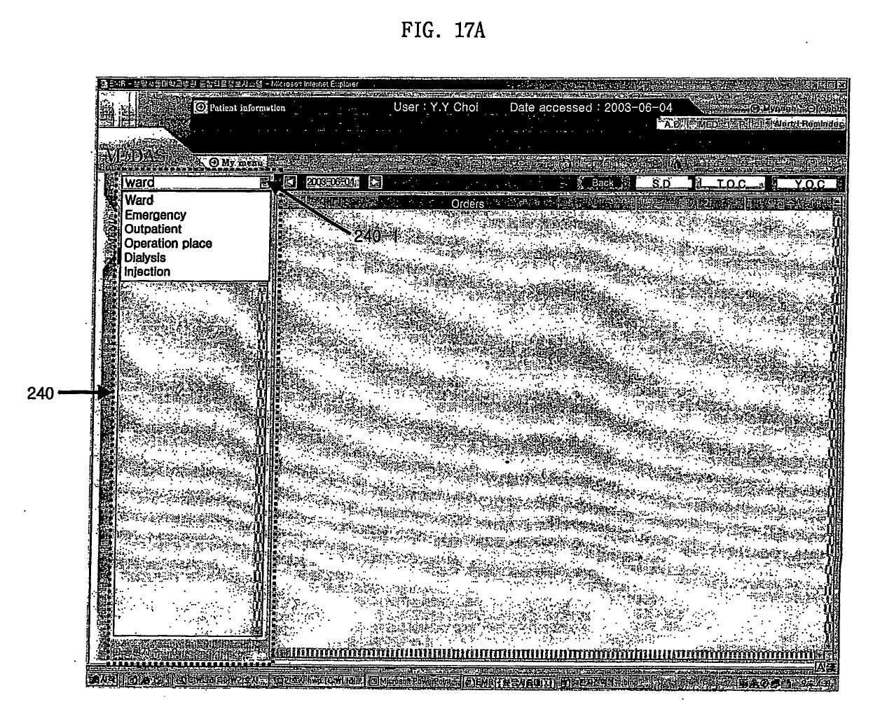

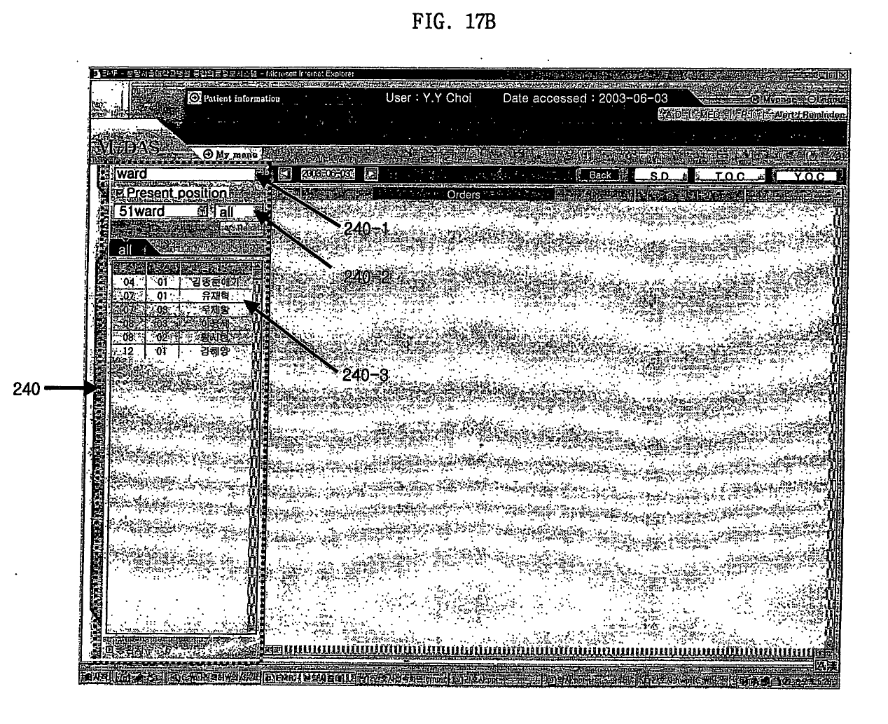

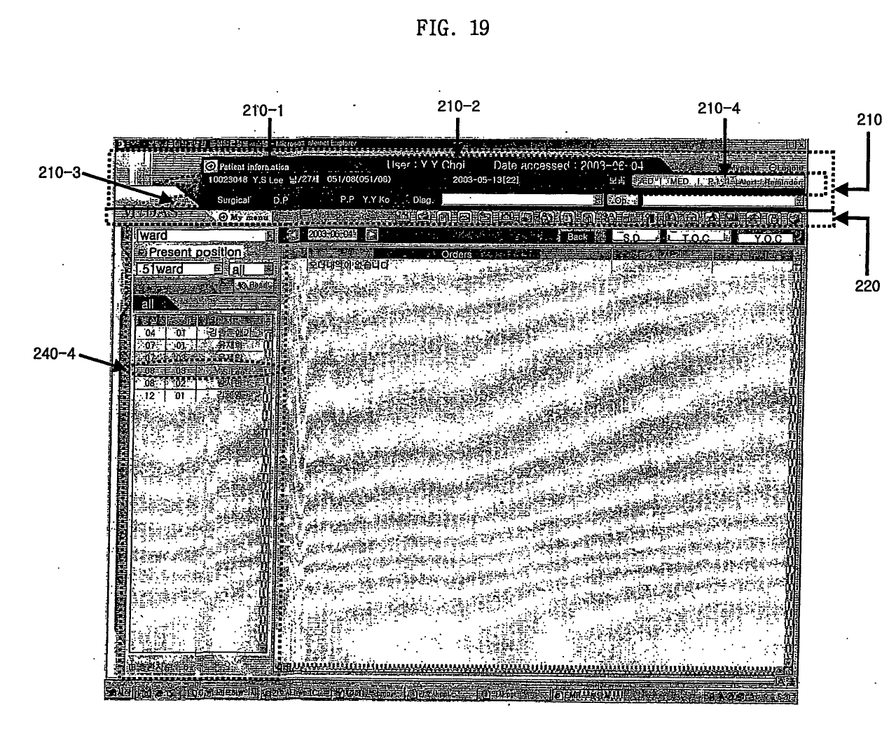

First, the user information display block 24 displays the information on a nurse (user) who has logged in. Also, when the nurse has logged in selects a patient, whose information he or she wants to view or enter, the block displays basic information, including patient name, patient number in hospital, department concerned, designated physician, primary care physician, and so on. In addition, the user information display block 24 displays pertinent items selected from diagnosis name, Operation, attending doctor, medication and the like. Here, the information output from the above-described block is the information stored in the patient information management unit 13. In FIG. 19, more details for this will be described. Additionally, the method of selecting a patient will be described in FIGS. 17A and 17B.

Next, My menu block 220 indicates an icon set by each user (nurse). Among many menu items in the main menu block 230, each nurse can set icons about menu items which are usually used by him or her. In other words, in the ‘My menu’ block 220, each nurse can select and set menu items he or she wants from the main menu block 230. The menu items, which consist of the ‘My menu’ block, are equipped in the main menu block 230, or as shown in the drawing, are able to be composed of by a menu button, “My menu” in the ‘My menu’ block. In addition, icons, which are displayed on the ‘My menu’ block 220, may have already been set, because basically, the menu items indicated by the icons are usually used.

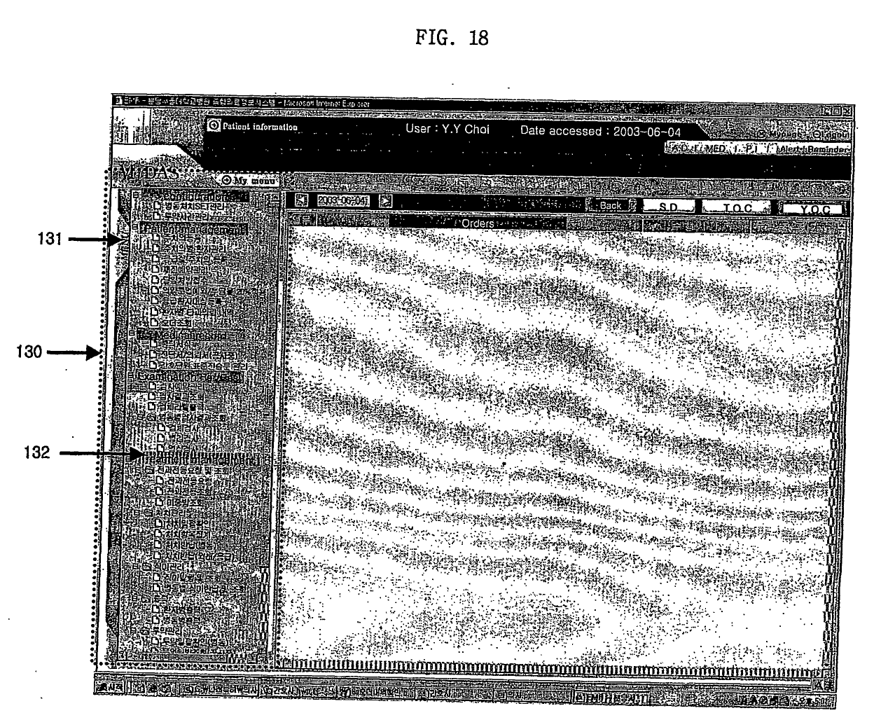

The main menu block 230 shows all menu items a nurse is able to use, which will be described in more detail with reference to FIG. 18.

The patient selection block 240 is a block for a nurse to select a patient, whose information he or she wants to search. The patients' information is stored in the patient information management unit 13. The details will be described in FIG. 17A and FIG. 17B.

The patient information input/output block 250 is a block for a nurse to enter or view all kinds of necessary information when he or she takes care of a patient.

FIG. 16 shows a step that a patient has not been selected yet, and a window is activated to check orders basically.

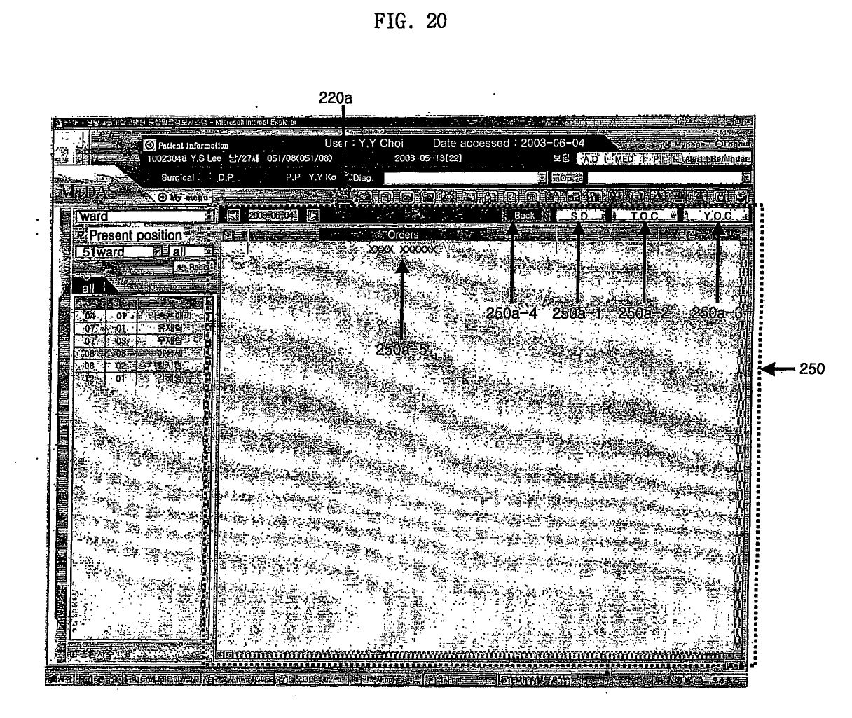

Meanwhile, as described above, the information input by a nurse through the patient information input/output block 250 is stored in the patient information management unit 13 of the service providing system 10. When a nurse clicks on a menu in the ‘My menu’ block 220 or the main menu block of the nurse's web screen in order to ask for pertinent information, in the above-described controller 12 the information is retrieved and displayed on the above-described nurse's web screen. A variety of embodiment examples of the patient information input/output block 250 will be described in FIGS. 20 through 24.

FIGS. 17A and 17B are exemplary ‘Patient Selection’ block activated from the web browser screen provided by the online medical information management method according to the present invention;

When a nurse logs in and a nurse's web screen is activated, the nurse can select the patient whose information he or she wants among patients of whom he or she takes care through the patient selection block 240.

As shown in FIG. 17A, when the nurse clicks on a button for selecting the first patient 240-1, menu items such as ward, emergency, outpatient, operation place, dialysis, injection are activated. If the nurse takes charge of a ward, he or she selects the ward menu. Likely, if the nurse works at an emergency room, he or she selects the emergency menu, and if the nurse works at an operation room, he or she selects the operation place menu.

When a nurse selects the ward menu as shown in FIG. 17A, a button for selecting the second patient 240-2 is indicated as shown in FIG. 17B. And then when the button is clicked, each ward in the hospital is indicated. Here, when the nurse selects the ward of which he or she takes charge, the patients' list 240-3 of the pertinent ward is output as shown in FIG. 17B. The nurse selects the patient whose information he or she wants in the patients' list 240-3.

Meanwhile, the button for selecting the second patient 240-2 can be output in each different type according to the button for selecting the first patient 240-1. For example, when a user selects the operation place menu, the menu where the user can select an operation room can be indicated. That is, the type of the button for selecting the second patient 240-2 can be indicated in different types respectively according to the menu items selected by the button for selecting the first patient 240-1.

However, even though a user is a nurse, he or she is not allowed to view, correct or input the information on all the patients. Accordingly, in case of a patient who needs to be taken special care of, the nurses who can view the patient information are defined as charge nurses of the pertinent ward or room. In most cases, all nurses is allowed to view the information on each patient, but the competence to correct or input the information on patients can be given only to charge nurses.

Meanwhile, in case of a new patient who visits a hospital provided the service according to the present invention and wants to be examined, the basic information on the patient is input through the administrative staff terminal 50 at a reception area in the hospital, and then the information is input in the patient information management unit 13. Then, the nurse is able to view the information. In other words, the initial information on a patient who visits the hospital for the first time is input through an administrative staff terminal 50, which is used by hospital personnel in the reception area. And then it is stored in the service providing system 10. Thereafter, every physician or nurse can view the information on the patient.

FIG. 18 illustrates an exemplary main menu block activated from the web browser screen provided by the online medical information management method according to the present invention.

Among the web screens for a nurse as shown in FIG. 16, the main menu block 230 is activated.

Here, when a nurse clicks on a menu button 231 of the main menu block 230, the menu selection window 232, which is shaped in a tree type, is activated. In the menu selection window 232 all the menu items to be used in the web screens for a nurse are composed in a tree type.

For example, the icon of the ‘My menu’ block 220 can be set according to each user through the environment setting menu in the menu selection window 232. The menu items such as medication time management, register for primary care physician, and order reference are also indicated in the shape of a tree type in the menu selection window 232.

FIG. 19 illustrates an exemplary user information display block displayed when a patient is selected from the web browser screen provided by the online medical information management method according to the present invention.

The screen shown in FIG. 17B includes the user information display block 24 when a nurse selects a patient whose information he or she wants to check.

For example, when a nurse selects ‘Lee Yong-Se’ at the patient name list 240-4 in the patients' list menu 240-3 of the patient selection block 240, the information on the patient is displayed on the user information display block 24 of web screens for a nurse.

Here, as shown in FIG. 16, in the user information display block 24 the information 24-2 including the name of the logging-in nurse and the logging-in date is output, and also the information 24-1 about the selected patient is output with the information 24-3 about the department concerned, an designated physician, and a primary care physician.

As shown, in the user information display block 24 the menu block 24-4 has been output. In the menu block 24-4, it is possible to input or view more detail information on the patient or the examining physicians additionally.

FIG. 19 shows submenu items of the menu block 24-4, including Attending doctor, Medication, Patient Information, Alert and Reminder.

First, a nurse can check the pertinent physician from the attending doctor menu in case another physician except for a primary care physician is assigned for the patient.

Next, in the medication menu a nurse can check the information on the medication order for the patient.

In the patient information menu, a nurse can find more detail information on the patient than the patient information 24-1 displayed on the user information display block 24.

Lastly, the alert menu and the reminder menu allow the nurse to check important matters in examining the patient. In the alert menu if the patient has allergy, the nurse can check it, and also if the patient has side effect on a certain medicine, he or she can input message about it. If the patient is pregnant, he or she can check it in the alert menu. In other words, the alert menu enables a nurse himself or herself to input or view the characteristic information which has taken place in examining the patient. In addition, while the patient is being nursed the matters to be checked at least once by a nurse are input in the reminder menu. That is, the alert menu and the reminder menu enable the nurse himself or herself to input necessary information while the patient is being examined. The input information is stored in the patient information management unit 13, and then it can be displayed in a pop-up window when the above-described menu items are selected.

In the menu items such as attending doctor, medication, patient information screen references or input screens can also be displayed on pop-windows when a pertinent menu item is selected. Here, a nurse himself or herself can input and register information in the patient information management unit 13, or can check the information stored in the patient information management unit 13 by other terminals 20, 40, and 50.

Besides, the user information display block 24 displays diagnosis and operation executed on the patient.

Meanwhile, as described above, when a patent is selected, the patient information is displayed on the user information display block 24. Each menu of the ‘My menu’ block 220 is activated to be used.

After selecting a patient, a nurse can input or view the patient information through all kinds of menu for patient management of the ‘My menu’ block 220 or the main menu block 230.

As described above, the icons of the ‘My menu’ block 220 may be set so as not to be correctable. Otherwise, the icons may be set to be added or deleted by a nurse who uses the same.

20 shortcut icons are shown in the drawing, including order execution, nursing notes, clinical observation, serious case nursing note, nursing activity execution, initial nursing information, post discharge nursing plan, pre-operation nursing status checklist, nursing note and nursing activity query, patient position check, medication issuance, diet issue and review, examination result review, and discharge process. Now, referring to FIGS. 20 through 24, among the above-described shortcut icons, the icons which are quite often used by nurses will be described. The patient information input/output block 250 to be activated by the icons can be activated by the menu items of the main menu block 230 as well as by the above-described icons.

When a nurse selects the icon of order execution 220a in the ‘My menu’ block 220, order 250a-5 is output in the patient information input/output block 250 as shown in FIG. 20.

The order 250a-5 input by the patient's primary care physician through a terminal for physicians 20 has been stored in the patient information management unit 13 of the service providing system.

Meanwhile, in the patient information input/output block 250 output by the icon of order execution not only the order 250a-5 but also items such as execution time and medicine reception time are indicated. And also a button for checking service 250a-1, which is used to check the order, a button for checking the next day's order 250a-2, and a button for checking the previous day's order 250a-3 are indicated. A button for returning screen 250a-4, which is used to return the original screen after checking the orders through the above-described buttons, is also indicated.

In order words, by checking orders as described above, a nurse can perform the order for the patient directed by the physician.

FIG. 20 illustrates an exemplary screen displayed when a shortcut icon for activating order execution is selected from a ‘My menu’ block displayed on the web browser screen provided by the online medical information management method according to the present invention.

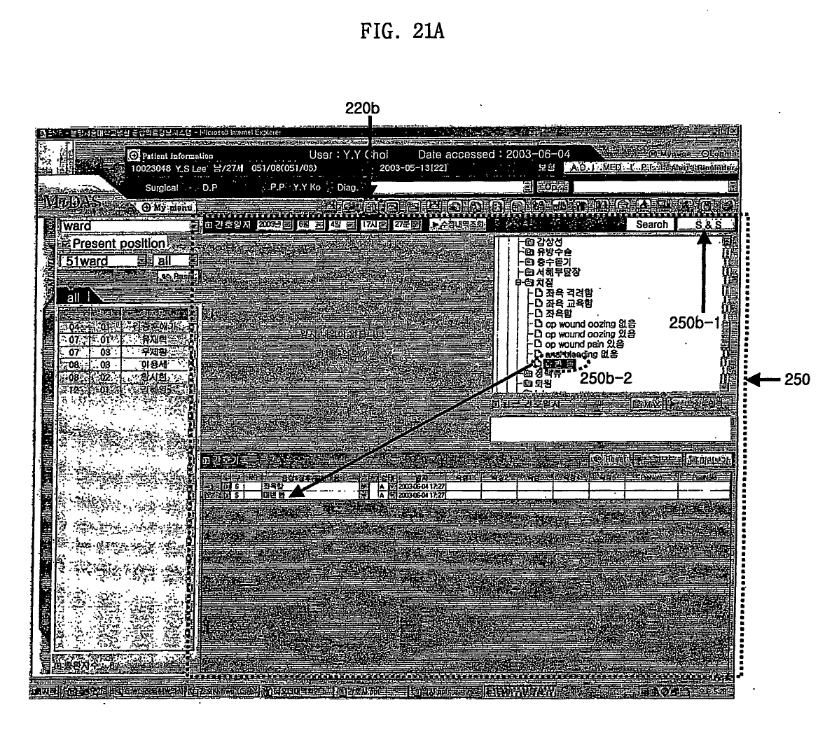

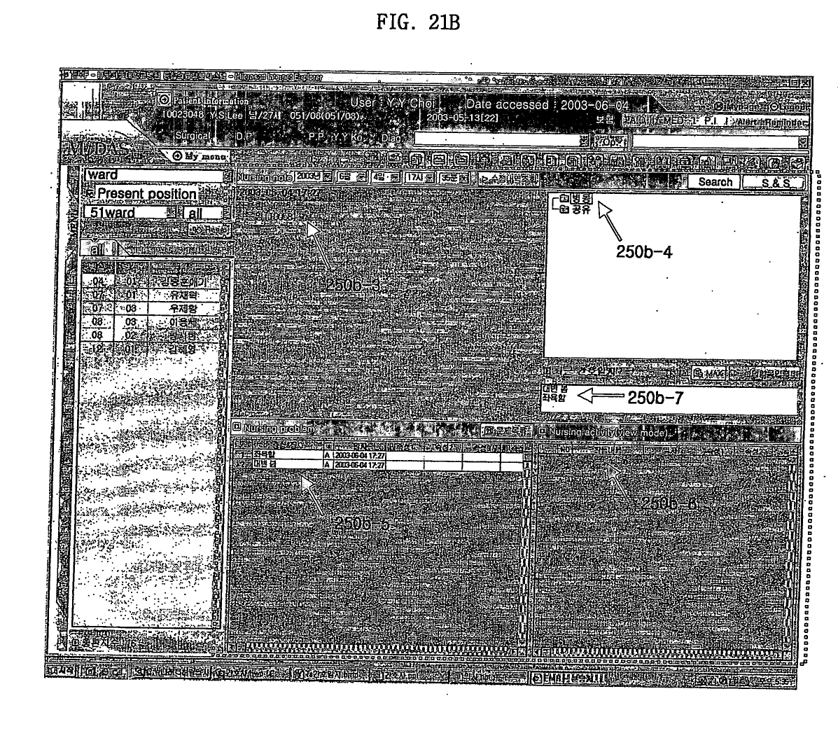

FIGS. 21A and 21B illustrate exemplary screens displayed when a shortcut icon for activating nursing notes is selected from the ‘My menu’ block displayed on the web browser screen provided by the online medical information management method according to the present invention.

When a nurse selects the icon of nursing notes 220b in the ‘My menu’ block 220, as shown in FIG. 21A, in the patient information input/output block 250 there is output an input window, where a nurse can input contents to take place according to dates while he or she is nursing the patient. When the nurse selects and clicks on a pertinent content (e.g., faces) 250b-2, the content of the selected item is displayed on the menu item of nursing notes.

As shown in FIG. 21B, the input window is divided into two: ward and sharing folder 254b-4. Necessary submenu items according to each ward and submenu items to be used in the whole hospital can be arranged. For example, in the input window shown in FIG. 21A, the list is indicated when the ward to which the patient belongs is selected in ward folder.

When a nurse clicks on a shortcut button 250b-1 after checking the contents input by the above-described method in the nursing notes, the input contents are stored in the patient information management unit 13, and output in the nursing note display column 250b-3, as shown in FIG. 21B.

Furthermore, if the input contents are related to nursing, they can be displayed in a special window 250b-5, and if the contents are related to nursing activity, they can also be displayed on another special window 250b-6. Besides, a window 250b-7 to check nursing notes input lately can be indicated.

By inputting or outputting the contents in nursing notes, a nurse can check the patient's status according to dates.

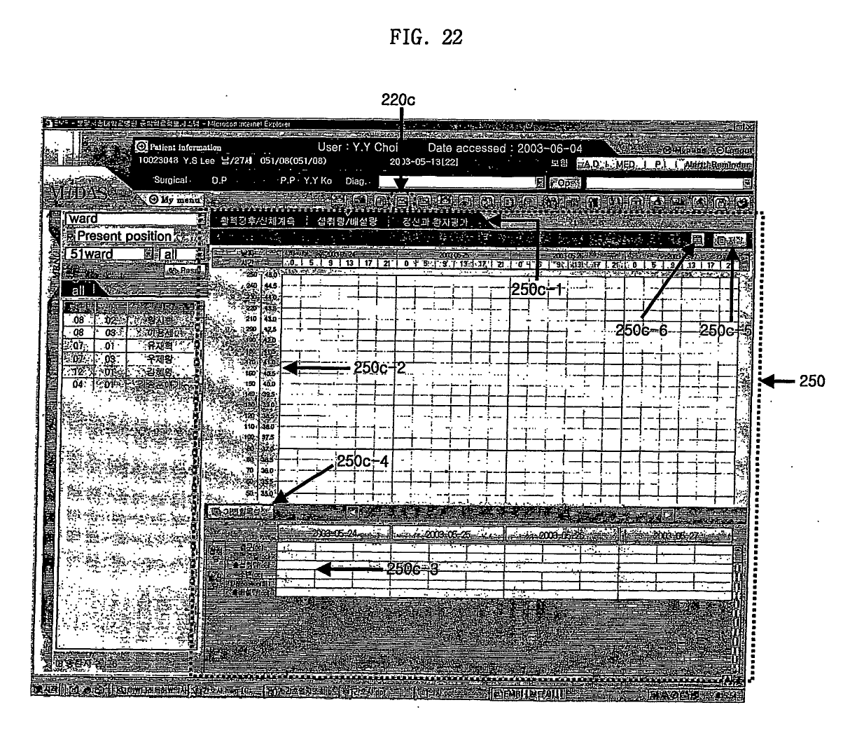

FIG. 22 illustrates an exemplary screen displayed when a shortcut icon for activating clinical observation is selected from the ‘My menu’ block displayed on the web browser screen provided by the online medical information management method according to the present invention.

When the shortcut icon of clinical observation 220c is selected from the ‘My menu’ block 220, as shown in FIG. 22, in the patient information input/output block 250 an input/output window to input and check the patient's clinical status according to dates and time is output. Through the input/output window it is possible for a nurse to enter and check all kinds of clinical status information for the patient. Here, clinical information is said to be information such as body weight, temperature, urine, and intake for the patient.

Meanwhile, the input/output window of the patient information input/output block 250 is composed of a chart display column 250c-2 and a number input column 250c-3. When a nurse enters pertinent contents through the number input column 250c-3 and presses a shortcut button 250c-5, the input contents are stored in the patient information management unit 13 and are output through the number input column 250c-3. If the input content is information that can be displayed through the chart display column 250c-2, the input content is output in the form of a chart through the chart display column 250c-2.

In addition, when a nurse wants to add a new item to the number input column 250c-3, the nurse can select a variable item setting button 250c-4 to enter the new item. Here, the input content is added to the number input column 250c-3 to then be displayed.

Also, ifs where the number input column 250c-3 is intended to be magnified due to an increase in the number of items, or the chart display column 250c-2 is not needed, a nurse can click a chart concealing button 250c-6. As a result, in the patient information input/output block 250 only the inputting section is shown without any chart.

As shown, patient's clinical information is classified as a menu 250c-1 including activity symptoms/body measure, intake/excretion and psychiatric findings, thereby inputting various types of information separately for each patient.

FIG. 22 shows that the items displayed when intake/excretion menu item is selected are shown in the number input column 250c-3 of the patient information input/output block 250.

In other words, through inputting and outputting the contents related with the clinical observation, a nurse can grasp the patient's status more exactly by checking all kinds of the patient's clinical information according to dates and time.

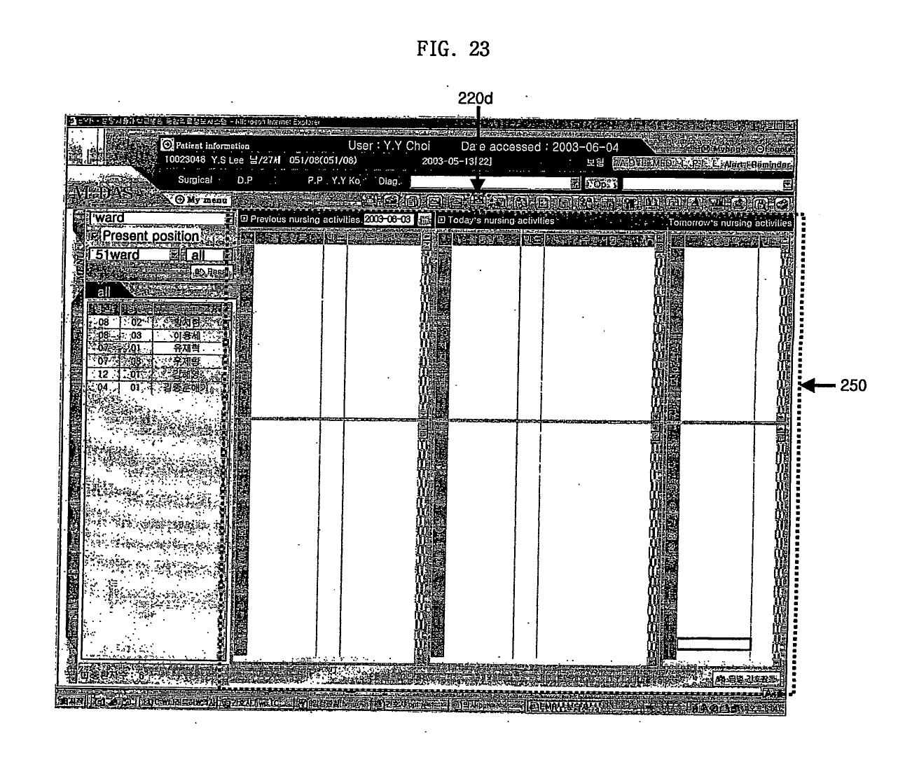

FIG. 23 illustrates an exemplary screen displayed when a shortcut icon for activating nursing activity execution is selected from the ‘My menu’ block displayed on the web browser screen provided by the online medical information management method according to the present invention.

If the icon 220d for activating nursing activity is selected from the ‘My menu’ block 220, as shown in FIG. 23, all kinds of activities to be performed by a nurse are checked in an order of dates, as displayed on the patient information input/output block 250.

Here, the activity items can be directly input by the nurse or by orders from the physician. The nurse checks the nursing activities performed while performing nursing activity. Through the progress, the nurse can check the contents which are possible to be omitted by mistakes while he or she is taking care of the patient.

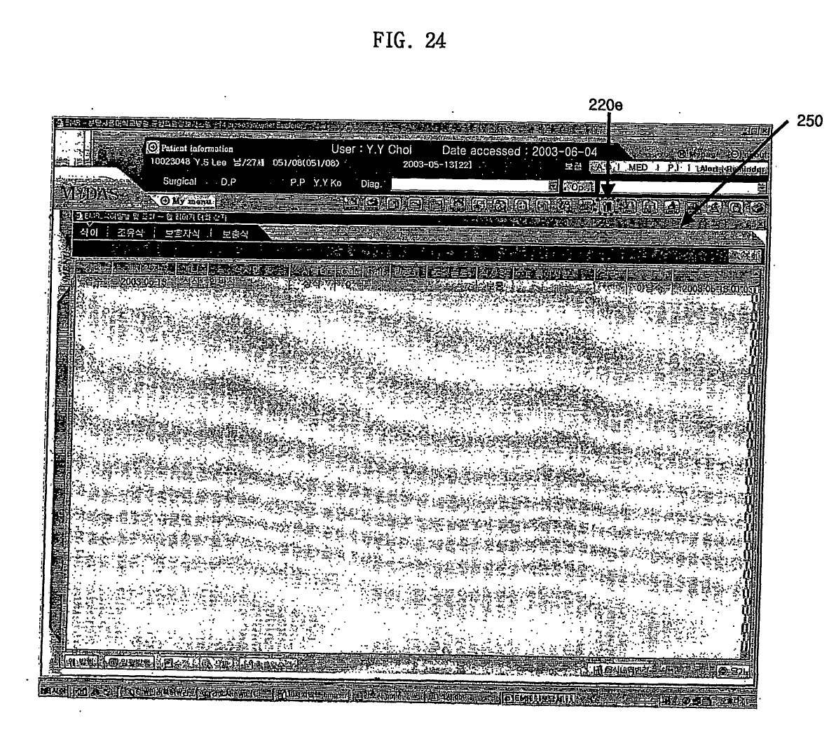

FIG. 24 illustrates an exemplary screen displayed when a shortcut icon for activating diet issue and review is selected from the ‘My menu’ block displayed on the web browser screen provided by the online medical information management method according to the present invention.

When the nurse selects the shortcut icon for activating diet issue and reference 220e in the ‘My menu’ block 220, a kind of diet to be issued to the patient is output in the patient information input/output block 250 as shown in FIG. 24. Here, in the diet to be issued to the patient, not only the information on the diet of the patient but also the information on the family diet and supplementary diet can be output.

In addition, the information on the diet for each patient can be input by a physician or by a nurse through the nurse terminal 30. Otherwise, the dietary information can be input by a nutritionist through the laboratory staff terminal 40 or the administrative staff terminal 50. The input information as described above has been input in the patient information management unit 13 and then is output through the patient information input/output block 250.

In order to nurse the patient without any failure, the nurse checks the diet information in the process of dispensing food, and then checks if an appropriate diet is assigned to each patient.

Other than the above-described menu items of the ‘My menu’ block 220, there are various kinds of menu items, which are necessary for nursing patients. The nurse can select a pertinent menu and view the contents. In addition, if necessary, he or she can input a new content in order to take an active measure as the patient's status changes.

In other words, by using the method of managing medical information online management for nurses according to the present invention, nurses can store the nursing information on patients in the patient information management unit 13 through network as soon as they have nursed patients, and can view it whenever they want to.

In addition, nurses can transmit all kinds of order necessary to nurse patients to physicians, laboratory staff, or general staff through network, and they can search the information on all kinds of patients input by physicians, clinical laboratory staff or general staff whenever they want to.

A method for providing medical information, which is executed in a clinical laboratory staff terminal 40, i.e., an online medical information management method, which is executed when clinical laboratory staff members have normally logged in to a service providing system 10 via the clinical laboratory staff terminal 40, will now be described more fully with reference to FIGS. 25A through 25E, 26A through 26D, 27A through 27D, and 28A and 28B.

In the online medical information management method for clinical laboratory staff, which will be described below, it is the clinical laboratory staff that checks whether there is a request for examination and enters information on test results. However, not only the clinical laboratory staff but also physicians or nurses are able to view the test results and enter data based on interpretation of the test results. In other words, according to the online medical information management method, the test results may be implemented via a physician terminal 20 or a nurse terminal 30 as well as the clinical laboratory staff terminal 40. Therefore, the online medical information management method may allow a physician or a nurse to enter or view the various test results by using the physician terminal 20 or the nurse terminal 30. From now on, the term “clinical laboratory staff member” used throughout the specification is intended to encompass meanings of a person who is authorized to use the online medical information management method, for example, clinical laboratory staff, a physician, or a nurse. However, if necessary, a clinical laboratory staff member, a physician, and a nurse shall be independently used to mean what they are originally called, instead of being collectively referred to as clinical laboratory staff.

Meanwhile, examinations, to which the online medical information management method according to the present invention is applied, may be largely categorized into four types according to tasks performed, i.e., a function tests, rehabilitation, a health examination for medical checkup, and a radiotherapy. The function tests include various function tests assigned to various clinical departments, such as electrocardiography, electromyography, and electroencephalography. The rehabilitation medical examination includes examinations for physical therapy and occupational therapy. The health examination includes various medical checkup examinations for health promotion. The radiotherapy examination includes various examinations for radiotherapy. Accordingly, several embodiments of the online medical information management method for each of the four categories will now be described with reference to the drawings.

FIGS. 25A through 25E illustrate various examples of web browser screens for function tests provided by the online medical information management method according to an embodiment of the present invention. More specifically, FIGS. 25A through 25E illustrate various exemplary web browser screens that allow a clinical laboratory staff to enter or view results of various tests.

FIG. 25A illustrates an initial screen for providing a variety of medical information when a clinical laboratory staff accesses and logs on to the service providing system 10 via his/her own terminal and selects a health examination.

As described above, the clinical laboratory staff can access the service providing system 10 via a web browser of his/her own terminal and can be provided a variety of medical information from the service providing system 10 once he/she is successfully authenticated by the authentication management block 16 in the service providing system 10 or by the public authentication system 60.

FIG. 25A illustrates an example of a web browser screen (hereinafter, referred to as a clinical laboratory web browser screen activated when the clinical laboratory staff logs on to the service providing system 10 and selects a ‘management screen for clinical laboratory staffs’ menu and then a ‘function test’ menu. Referring to FIG. 25A, the clinical laboratory web browser screen is divided into a user information display block 310a, a main menu block 330a, and a patient information input/output block 350a.

The user information display block 310a displays information of the clinical laboratory staff member who is currently logged on to the service providing system 10. If the clinical laboratory staff member selects a patient, the user information display block 310a displays basic information on the patient, such as the name of the patient, a registration number of the patient in a hospital, clinical departments in the hospital that the patient have visited, designated physician, and attending doctor of the patient. The user information display block 310a may also display information necessary for searching for the patient's medical history, such as diagnoses given to the patient, examinations that the patient has been subjected, and treatment history. In addition, when there are various laboratories, the user information display block 310 may also display a health examination laboratory menu for allowing the clinical laboratory staff member to select each of the various laboratories. The above-described basic information on the patient has been input to the service providing system 10 by the administrative staff through an administrative staff terminal 50. The clinical laboratory staff member may select the patient from a “patient selection” window, which is output when he/she selects a “patient number” menu on the clinical laboratory web browser screen.

The main menu block 330a displays a list of menu items available to the clinical laboratory staff. Some of the menu items of the main menu block 330a that are of importance will be described in greater detail with reference to FIGS. 25B through 25E.

The patient information input/output block 350a allows the clinical laboratory staff to enter or view a variety of information on the patient, which will be described in greater detail with reference to FIGS. 25B through 25E as well.

As described above, information on the patient input by the clinical laboratory staff via the patient information input/output block 350a is stored in a patient information management block 13 of the service providing system 10. When the clinical laboratory staff issues a request for the information on the patient stored in the patient information management block 13 of the service providing system 10 by selecting one of the menu items provided by the main menu block 330a on the clinical laboratory web browser screen, a controller 12 withdraws the requested information on the patient from the patient information management block 13 and outputs the withdrawn information on the clinical laboratory web browser screen. If the information on the patient input by the clinical laboratory staff is image data, it can be stored and managed in an image data management block 14 separately from other types of information on the patient.

FIG. 25B illustrates a clinical laboratory web browser screen when a clinical laboratory staff member selects an order view menu 330a-1 in the main menu block 330a. Referring to FIG. 25B, when the clinical laboratory staff selects a patient and then the order view menu 330a-1 on the clinical laboratory web browser screen, a list of orders given to the patient by a physician or a nurse is displayed in a patient information input/output block 350a-i for order view. In other words, a list of examination items requested by the physician or the nurse during examining the patient is displayed at the patient information input/output block 350a-1. The orders given to the patient by the physician or the nurse have been entered by the physician or the nurse through the physician terminal 20 or the nurse terminal 30 and are stored in the patient information management block 13. The clinical laboratory staff, particularly, a clinical laboratory staff member who actually performs the examination, checks the orders given to the patient by the physician or the nurse and performs examinations requested.

FIG. 25C illustrates a clinical laboratory web browser screen when a clinical laboratory staff member selects a registration menu 330a-3 in the main menu block 330a. Referring to FIG. 25C, when the clinical laboratory staff selects the registration menu 330a-3, a patient information input/output block 350a-3 for registration, with which the clinical laboratory staff can register a list of examinations for a patient and a list of the times when the patient are planned to take the examinations, is displayed. Then, the clinical laboratory staff member completes examination registration for the patient by inputting, to the patient information input/output block 350a-3, the list of examinations for a patient and the list of the times when the patient are planned to undergo the examinations. In other words, the clinical laboratory staff member can perform examinations requested by referring to orders given to the patient by a physician or a nurse and can register or check examinations scheduled for the patient.

FIG. 25D illustrates a clinical laboratory web browser screen when a clinical laboratory staff member selects an execution menu 330a-4 in the main menu block 330a. Referring to FIG. 25D, when the clinical laboratory staff member selects the execution menu 330a-4, a patient information input/output block 350a-4 for checking a list of examinations to be performed on a patient and then checking whether each of the examinations to be performed on the patient has been executed is displayed. Then, the clinical laboratory staff member completes an inspection of the patient by inputting, to the patient input/output block 28a-4, information on whether each of the examinations to be performed on the patient has already been executed.

In other words, the clinical laboratory web browser screen of FIG. 25D is used when performing registered ones among all examinations assigned to a predetermined clinical laboratory. An upper left portion of the patient information input/output block 350a-4 indicates a list of patients registered with the predetermined clinical laboratory using the patient registration method described above with reference to FIG. 25C, and a lower left portion of the patient information input/output block 350a-4 indicates a lists of patients corresponding to orders of a given day, the orders registered through reception areas of the hospital, not with the clinical laboratory. If the clinical laboratory staff member selects one patient from the list of patients registered with the predetermined clinical lab, a list of orders given to the selected patient are displayed on the right hand of the patient information input/output block 350a-4. Then, the clinical laboratory staff member checks the list of orders displayed, performs corresponding examinations, putting a predetermined mark on an execution check block for each of the corresponding examinations, and presses a ‘store’ button such that each of the corresponding examinations has already been executed can be stored in the patient information management block 13. The clinical laboratory staff member may further enter particular suggestions or matters to be attended to in the patient information input/output block 28a-4.

In short, the clinical laboratory staff member can check the orders given to the patient, can perform the corresponding examinations on the patient, and can register and check examinations scheduled for the patient.

The main menu block 330 may further include various menu items for systematically managing clinical laboratories and patients who visit each of the clinical laboratories, such as a reservation check menu, an examination reservation menu, a statistics menu, an examination code management menu, a clinical laboratory reservation menu, a clinical laboratory information registration menu, and a clinical laboratory registration menu. In other words, such various menu items enable the clinical laboratory staff member to enter or view information on patients who are yet to undergo examinations or information (examination or image data) on patients who have already undergone examinations or to register information required by each clinical laboratory.

When the information on the patients who have already undergone examinations is image data, such as X-ray images, computed tomograms (CTs), or ultrasonic images, the image data is converted into computer-searchable image data, and then the computer-searchable image data is stored in the image data management block 14 by using an image data input menu. When a photographing apparatus is able to directly output computer-searchable images, the clinical laboratory staff terminal 40 directly reads the computer-searchable images from the photographing apparatus and enters the computer-searchable images to the image data management block 14 using an image registration menu provided on the clinical laboratory web browser screen. If the photographing apparatus is unable to output computer-searchable images, images output from the photographing apparatus are converted into computer-searchable images, and then the computer-searchable images are input to. Therefore, if a physician, a nurse, or a clinical laboratory staff member issues a request for the images stored in the image management block, the requested images are transmitted and output to the physician terminal 20, the nurse terminal 30, or the clinical laboratory staff terminal 40.

FIG. 25E illustrates a clinical laboratory web browser screen when a clinical laboratory staff member selects an interpretation menu 330a-5 from the menu items of the main menu block 330a. Referring to FIG. 25E, if the clinical laboratory staff member selects the interpretation menu 330a-5, a patient information input/output block 350a-5 for checking results of tests performed on a patient is displayed. Then, a physician interprets the test results provided by the patient information input/output block 350a-5.

More specifically, various numerical values or other types of data as to the test results are displayed on the right hand of the patient information input/output block 350-5. Then, the physician puts a predetermined mark in each check block with reference to the numerical values or other types of data displayed.

In short, the clinical laboratory staff member can perform an examination on the patient by referring to orders given to the patient through the patient information input/output block 350a-5. In addition, the physician can diagnose a case of the patient by interpreting a result of the examination using the patient information input/output block 350a-5 and can provide appropriate treatments to the patient.

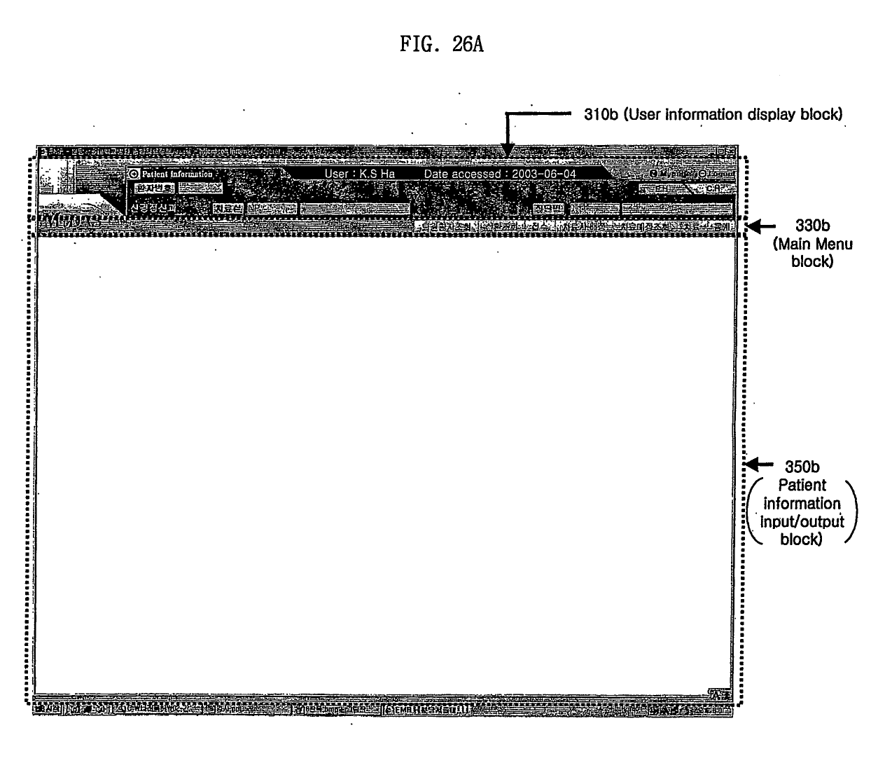

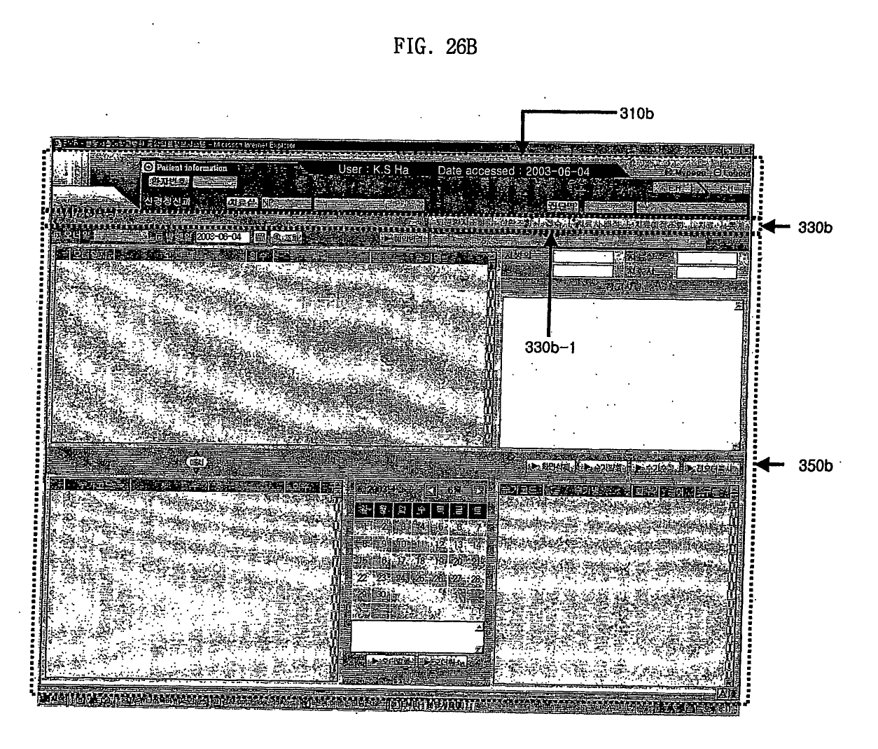

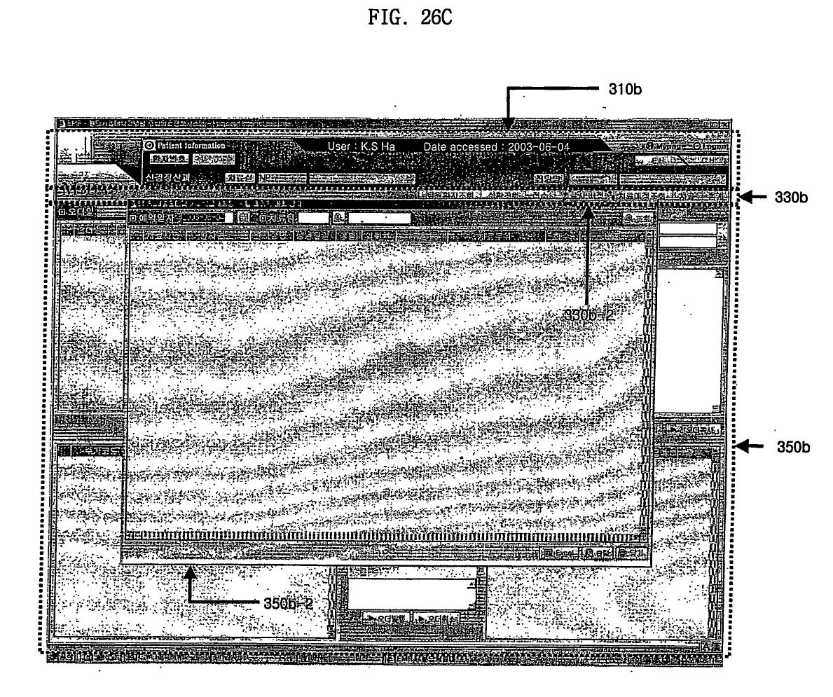

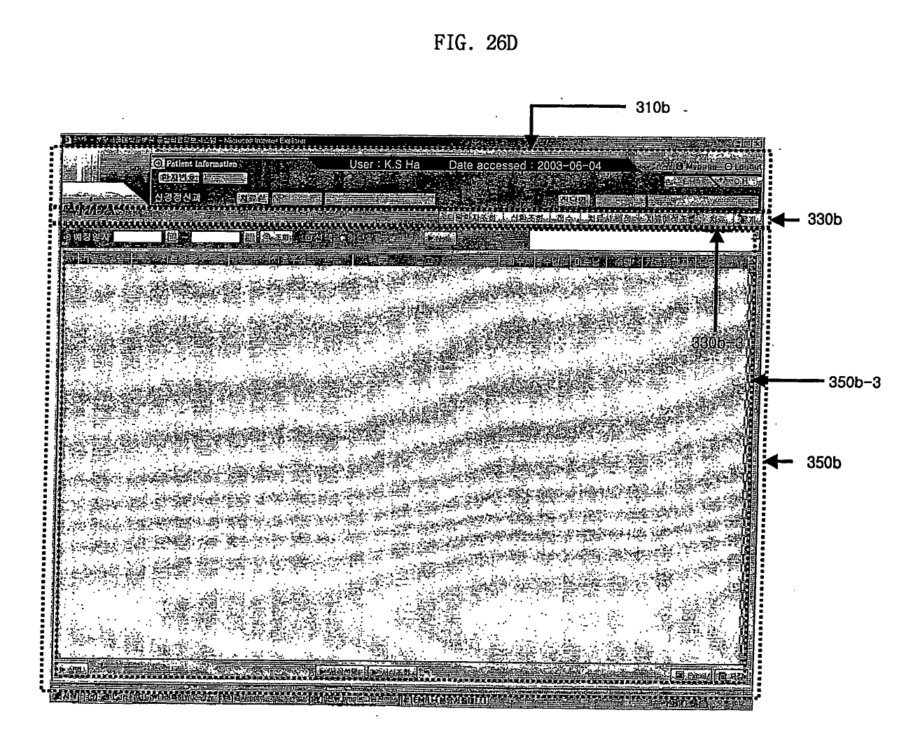

FIGS. 26A through 26D illustrate various examples of web browser screens for rehabilitation service provided by the online medical information management method according to an embodiment of the present invention.

More specifically, FIGS. 26A through 26D illustrate various exemplary web browser screens that allow a clinical laboratory staff member to enter or view various data regarding rehabilitation-related examinations. Unlike the online medical information management method for health examinations, which requires allowing a physician to interpret test results, the online medical information management method for rehabilitation may not necessarily involve allowing a clinical laboratory staff member to interpret results of various rehabilitation medical examinations because it is rather treatment-oriented focusing on, for example, physical therapy or occupational therapy.

FIG. 26A illustrates an example of an initial screen for providing a variety of medical information when a clinical laboratory staff member accesses and successfully logs on to the service providing system 10 via his/her own terminal, normally, and then selects a rehabilitation medical examination.

As described above, the clinical laboratory staff member can access the service providing system 10 via a web browser of his/her own terminal and can be provided a variety of medical information from the service providing system 10 once he/she is successfully authenticated by an authentication management block 16 in the service providing system 10 or by the public authentication system 60.

FIG. 26A illustrates an example of a clinical laboratory web browser screen activated when the clinical laboratory staff member logs on to the service providing system 10 and selects the ‘management screen for clinical laboratory staffs’ menu and then a rehabilitation menu.

Referring to FIG. 26A, the clinical laboratory web browser screen includes a user information display block 310a, a main menu block 330b, and a patient information input/output block 350b.

The user information display block 310b is the same as the user information display block 310b described above with reference to FIG. 25A, and thus its description will not, or briefly, be given.

The main menu block 330b displays a list of menu items available to the clinical laboratory staff member.

The patient information input/output block 350b allows the clinical laboratory staff member to enter or view a variety of information on a patient.

As shown in FIG. 26A, main menu items for rehabilitation provided by the online medical information management method for rehabilitation are outgoing patient query menu, a patient identification query menu, a registration menu, a therapist allocation menu, a treatment schedule query menu, and a statistics menu.

The outgoing patient query menu is used for checking whether there are patients who are about to be discharged from a hospital among those registered with a rehabilitation department of the hospital, and the patient identification query menu is used for searching for patients who are newly registered with the rehabilitation department.

FIG. 26B illustrates a web browser screen for allowing a clinical laboratory staff member to register patients with the rehabilitation department. Referring to FIG. 26B, the clinical laboratory staff member registers patients with the rehabilitation department on the web browser screen by selecting a registration menu 330b-1. In addition, the clinical laboratory staff member may calculate and check medical service charges for rehabilitation services that each of the patients is about to receive on the web browser screen. Moreover, patient information and medical service charge information registered on the web browser screen are stored in the patient information management block 13 or a hospital administration management block 16.

FIG. 26C illustrates a web browser screen for allocating a therapist to each patient who needs to receive a rehabilitation treatment. Referring to FIG. 26C, a person who is in charge of the rehabilitation department selects a therapist allocation menu 330b-2 on the web browser screen such that a therapist allocation window 350b-2 pops up on the web browser screen. Then, the person in charge of the rehabilitation department allocates a therapist to each patient by referring to information on each patient and the type of a treatment that each patient needs to receive. Information on therapist allocated to each patient is stored in the patient information management block 13 together with the information on each patient.

FIG. 26D illustrates a web browser screen for checking a list of patients who need to receive rehabilitation services and then checking whether the patients have received rehabilitation services that they needed. Referring to FIG. 26D, each therapist selects a treatment menu 330b-3, checks a list of patients allocated to him/her, provides an appropriate treatment to each of the patients, and enters a treatment result for each of the patients to the patient information input/output block 350b-3.

The treatment schedule menu allows the clinical laboratory staff member to check information on patients who are scheduled to receive a treatment, and the statistics menu allows the clinical laboratory staff member to statistically process a variety of information obtained from treatments performed on each patient.

In short, the clinical laboratory staff member can perform a treatment on each patient according to a treatment order given to each patient by using the above-described menu items, can record a result of the treatment. Accordingly, a physician or a nurse can check later whether each patient has been appropriately treated.

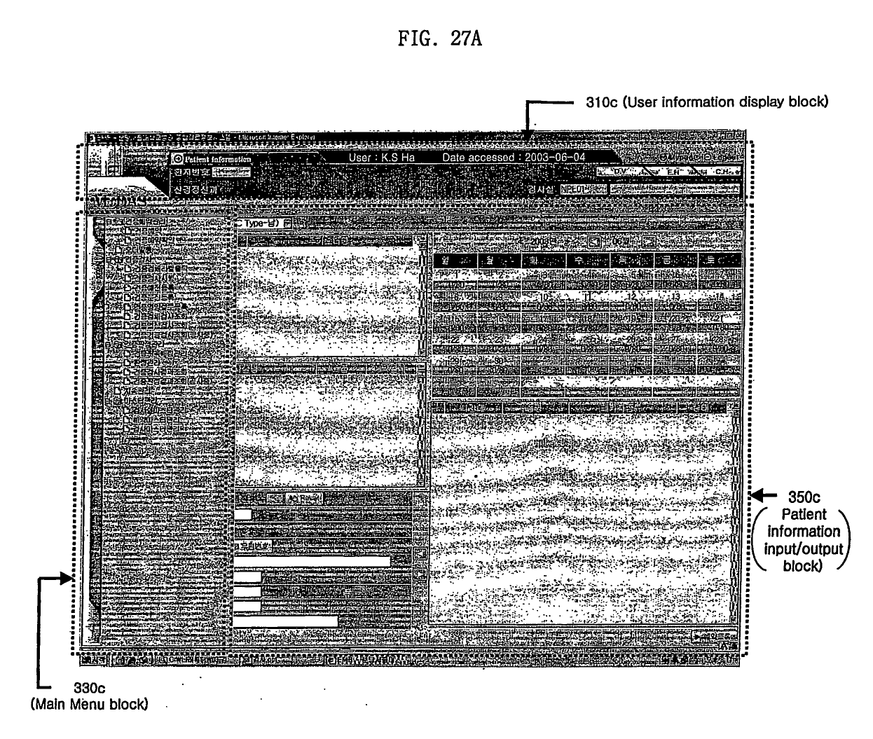

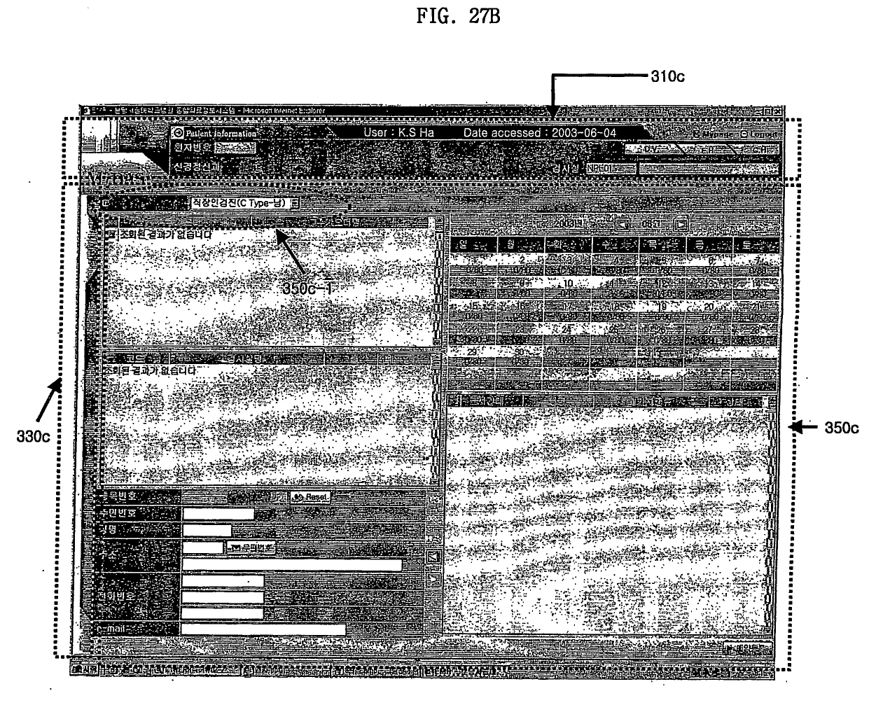

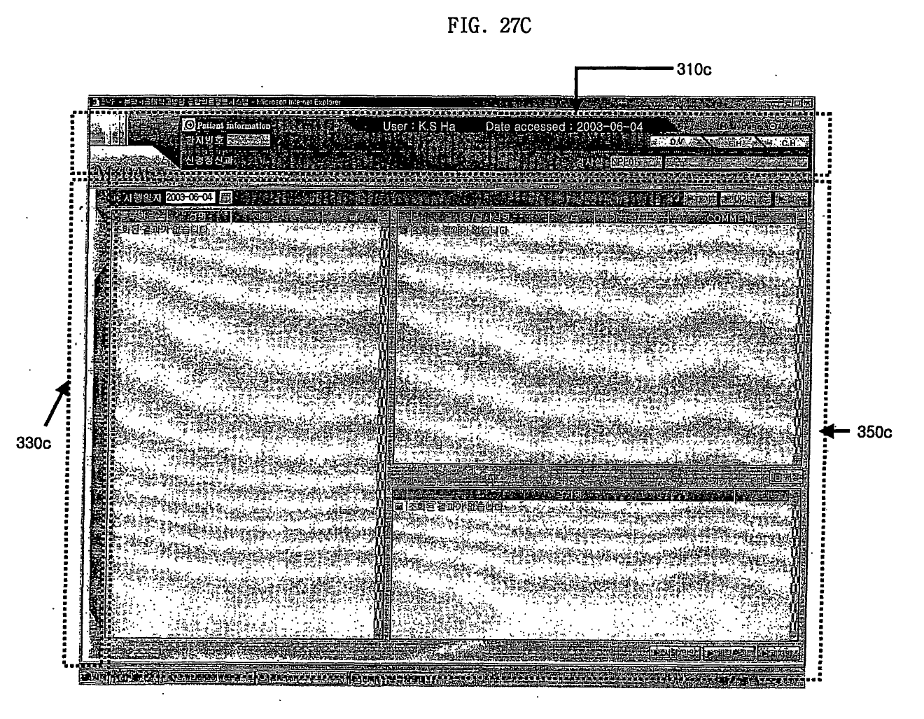

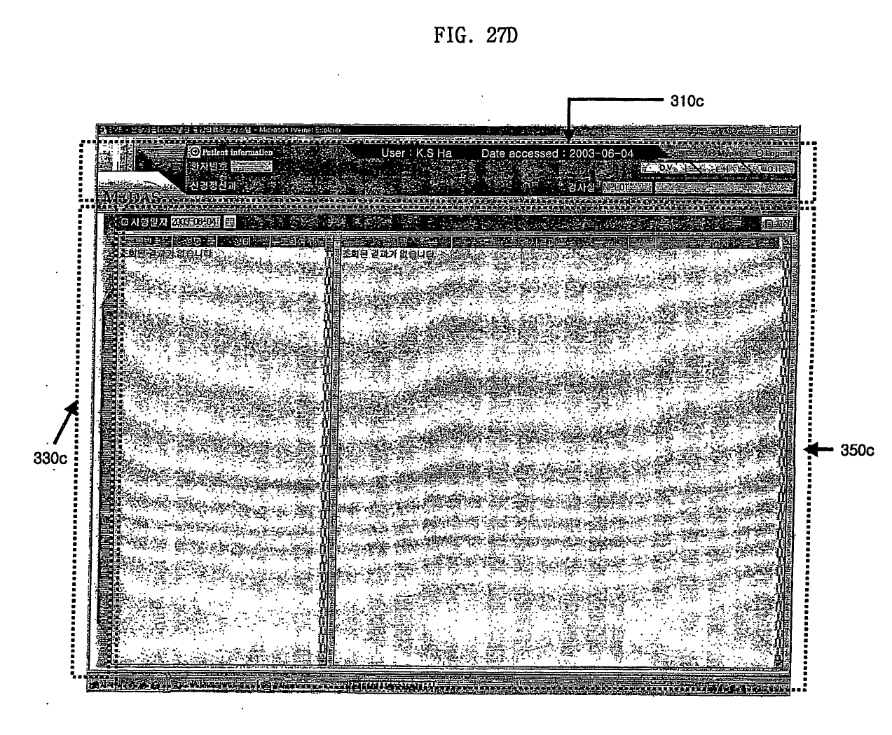

FIGS. 27A through 27D illustrate various examples of web browser screens for health examinations provided by the online medical information management method according to an embodiment of the present invention. More specifically, FIGS. 27A through 27D illustrate various exemplary web browser screens that allow a clinical laboratory staff member to enter or view various data during a health examination. The online medical information management method for health examinations is different from the online medical information management method described above with reference to FIGS. 25A through 25E and 26A through 26D in that a physician receives applications for health examination from patients and enters health examination results regardless of treatment of diseases of the patients. However, it can also be said that the online medical information management method for health examinations is similar to the online medical information management methods described above with reference to FIGS. 25A through 25E and 26A through 26D in terms of performing various examinations on patients and recording results of the various examinations.

FIG. 27A illustrates an example of an initial screen for providing a variety of medical information when a clinical laboratory staff member accesses and logs on to the service providing system 10 via his/her own terminal and selects a health examination category.

As described above, the clinical laboratory staff member can access the service providing system 10 via a web browser of his/her own terminal and can be provided a variety of medical information from the service providing system 10 once he/she is successfully authenticated by an authentication management block 16 in the service providing system 10 or by the public authentication system 60.

FIG. 27A illustrates an example of a clinical laboratory web browser screen activated when the clinical laboratory staff member logs on to the service providing system 10 and selects the ‘management screen for clinical laboratory staff’ menu and then a health examination menu. Referring to FIG. 27A, the clinical laboratory web browser screen includes a user information display block 310c, a main menu block 330c, and a patient information input/output block 350c.

The user information display block 310c is the same as the user information display block 310a of FIG. 25A, and thus its description will be skipped.

The main menu block 330c displays a list of menu items available to the clinical laboratory staff member. The clinical laboratory web browser screen, unlike the clinical laboratory web browser screen of FIG. 25A or 26A, provides a main menu button. Therefore, if the clinical laboratory staff member presses the main menu button on the clinical laboratory web browser screen, the list of menu items available to the clinical laboratory staff member is displayed in a tree format.

The patient information input/output block 350c allows the clinical laboratory staff member to enter or view a variety of information on each patient.

Main menu items used in the online medical information management method for health examinations are a health examination reservation management menu, a health examination menu, a health examination judgment management menu, and a master management menu. Each of the main menu items may have sub menu items.

The health examination reservation management menu will now be described in greater detail.

If the clinical laboratory staff member selects the health examination reservation menu in the main menu block 330c, a health examination reservation screen of FIG. 27B is displayed. The health examination reservation screen allows the clinical laboratory staff member to register health examination reservations. The clinical laboratory staff member can register a patient and then select and store a package of examinations for a health examination that the registered patient wants on the health examination reservation screen. If the registered patient wants to undergo additional examinations for the health examination, the clinical laboratory staff member can select the additional medical examinations on the health examination reservation screen.

As shown in FIG. 27B, a package selection block 350c-1 is provided at an upper left portion of the patient information input/output block 350c. The clinical laboratory staff member can select a package of examinations for a health examination that each patient wants. Here, a plurality of examinations for a health examination can be customized into packages for people of different ages, different sexes, and different health conditions. Therefore, a patient can conveniently select one of the packages of examinations for a health examination that he/she needs.

If the clinical laboratory staff member selects a package of examinations for a health examination using the package selection block 350c-1, additional orders and a list of clinical labs corresponding to the selected package of examinations are displayed at a lower left portion of the patient information input/output block 350c. In other words, a list of additional examinations in association with the selected batch of examinations may be displayed. The clinical laboratory staff member may give additional examination orders by referring to the selected batch of examinations. In addition, the clinical laboratory staff member may select or designate a clinical laboratory to execute the additional examination orders.

The clinical laboratory staff member selects the date of a health examination scheduled and completes the registration of a reservation for the health examination. Thereafter, the selected batch of examinations and user information are stored in the patient information management block 13.

If the clinical laboratory staff member selects an order issuance menu (not shown) in the main menu block 330c, he/she can give orders for examinations other than those for a health examination. In other words, if patients who have applied for health examinations want additional examinations, the clinical laboratory staff member can give orders for the additional examinations.

FIG. 27C illustrates a web browser screen for performing examinations for a health examination. Referring to FIG. 27C, information on a patient who has applied for a health examination is displayed on the left hand of the patient information input/output block 350c, and a list of examinations for a health examination that the patient is about to undergo is displayed on the right hand of the patient information input/output block 350c. A clinical laboratory staff member can perform examinations on the patient by referring to the list of examinations for a health examination displayed on the patient information input/output block 350c and can input comments on each of the examinations and results of the examinations. The input comments and test results are stored in the patient information management block 13.

FIG. 27D illustrates a web browser screen for checking various test results after performing a health examination on a patient. Referring to FIG. 27D, information on a patient who has undergone a health examination is displayed on the left hand of the patient information input/output block 350c, and results of examinations for the health examination are displayed on the right hand of the patient information input/output block 350c. The test results displayed on the right hand of the patient information input/output block 350c used to be stored in the patient information management block 13.

As described above, the clinical laboratory staff member can receive reservations for a health examination from patients, can perform corresponding examinations on each of the patients, and can input and check the test results.

In addition, the clinical laboratory staff member can perform various examinations for a health examination on each of the patients and can input and check the test results by using various menu items provided by the main menu block 330c.

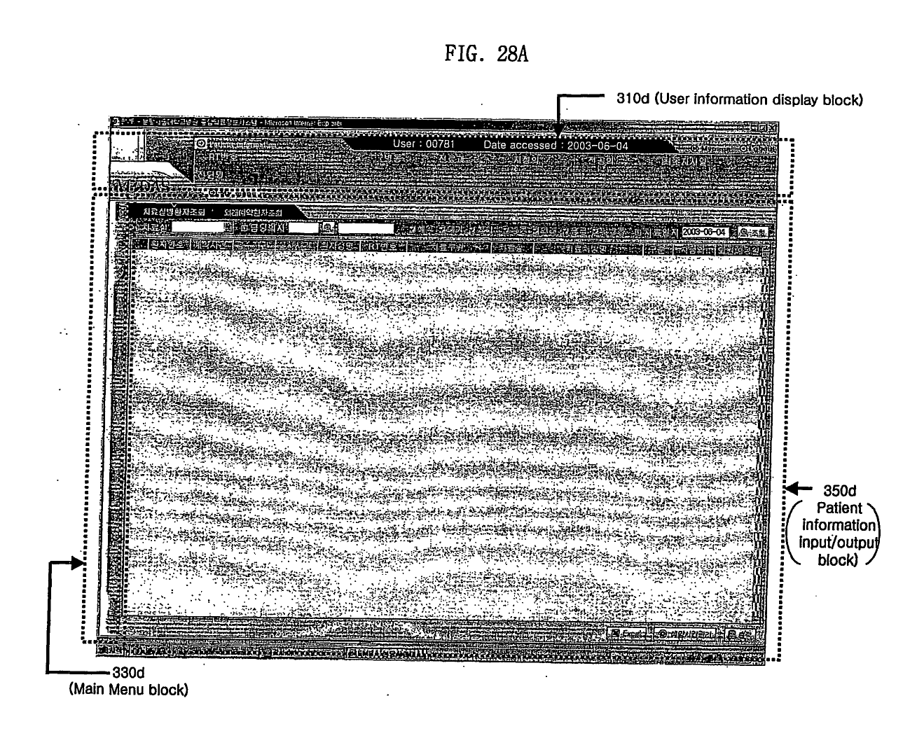

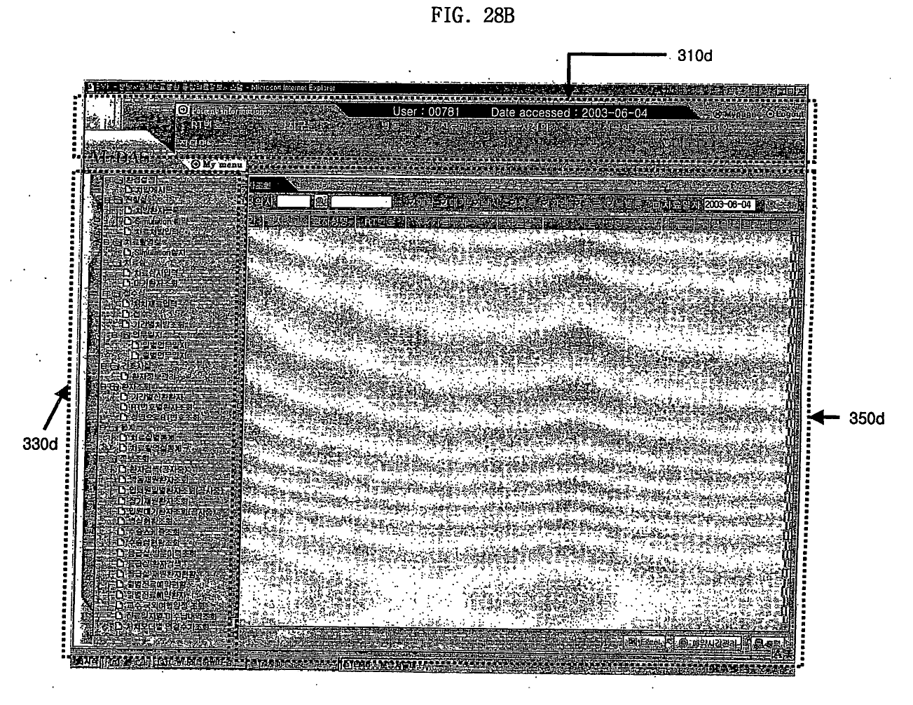

FIGS. 28A and 28B illustrate examples of web browser screens for radiotherapy provided by an online medical information management method to according to the present invention. More specifically, FIGS. 28A and 28B illustrate exemplary web browser screens for inputting or checking a variety of information during performing examinations for radiotherapy.

The online medical information management method for radiotherapy may be operated in almost the same manner that the online medical information management method for health examinations or rehabilitation is operated. However, it is still necessary to differentiate the online medical information management method for radiotherapy from the online medical information management method for health examinations or rehabilitation because radiotherapy deals with completely different types of examinations or treatments from health examinations or rehabilitation.

Although the online medical information management method for radiotherapy may have a different menu system and a different display style from the online medical information management method for function tests or rehabilitation, the online medical information management method for radiotherapy can be realized using the online medical information management method for function test or rehabilitation.

FIG. 28A illustrates an example of an initial screen for providing various medical information when a clinical laboratory staff member accesses and logs on to the service providing system 10 via his/her own terminal and selects a radiotherapy category.

As described above, the clinical laboratory staff member can access the service providing system 10 via a web browser of his/her own terminal. Once the clinical laboratory staff member is successfully authenticated by the authentication management block 16 in the service providing system 10 or by the public authentication system 60, he/she can be provided a variety of information from the service providing system 10.

FIG. 28A illustrates an example of a clinical laboratory web browser screen activated when the clinical laboratory staff member accesses and logs on to the service providing system 10 and selects the ‘management screen for clinical laboratory staff members’ menu and then a radiotherapy menu. Referring to FIG. 28A, the clinical laboratory web browser screen includes a user information display block 310d, a main menu block 330d and a patient information input/output block 350d.

The user information display block 310d is the same as the user information display block 310a of FIG. 25A. However, the user information display block 310d may output different data from the user information display block 310a.

The main menu block 330d displays a list of menu items available to the clinical laboratory staff member. The clinical laboratory web browser screen, unlike the clinical laboratory web browser screen of FIG. 25A or 26A, provides a main menu button. Therefore, if the clinical laboratory staff member presses the main menu button on the clinical laboratory web browser screen, the list of menu items available to the clinical laboratory staff member is displayed in a tree format.

The patient information input/output block 350c allows the clinical laboratory staff member to enter or view a variety of information on each patient.

Main menu items used in the online medical information management method for radiotherapy are illustrated in FIG. 28B. The online medical information management method for radiotherapy, like the online medical information management for health examinations or rehabilitation, may include a patient registration and reservation menu, a registration confirmation menu, a radiotherapy execution and result input menu and a radiotherapy result interpretation and checking menu.

Referring to FIG. 28B, the clinical laboratory staff member can enter or view a variety of information on radiotherapy by using the patient information input/output block 28d, which pops up when the clinical laboratory staff member selects any desired menu item from the main menu block 330d.

As described above, the clinical laboratory staff member can perform an examination on each patient and can check a test result by using the above-described online medical information management methods. In addition, the clinical laboratory staff member can store information on the examination that each patient has undergone and the test result in the patient information management block 13 via a network immediately after finishing the examination or a treatment for each patient. Moreover, a clinical laboratory staff member, a physician, or a nurse can check patient information at any time.

Furthermore, a clinical laboratory staff member can transmit various orders for examinations or treatments to be performed on each patient to a physician, a nurse, or an administrative staff member via a network or can check patient information input by the physician, nurse, or administrative staff member via the network.

The above-described online medical information management methods, which can be realized in terminals for physicians, nurses, or clinical laboratory staff members, enable physicians, nurses, and clinical laboratory staff members to share a variety of information on diagnoses, nursing, examinations, and treatment results via a network. Accordingly, it is possible to such caregivers to more quickly provide better medical services to patients.

FIGS. 29A through 29C illustrate various examples of web screens to which the method for providing medical information according to the present invention is applied. In detail, FIG. 29A illustrates an exemplary initial physician's web screen appearing after a physician has connected to the service providing system 10 via the physician terminal 20 and normally logged in to the same system 10. FIG. 29B illustrates an exemplary initial nurse's web screen that can be seen after a nurse has connected to the service providing system 10 via the nurse terminal 30 and normally logged in to the same system 10. FIG. 29C illustrates an exemplary initial clinical laboratory staff's web screen appearing when a clinical laboratory staff member has connected to the service providing system 10 via the clinical laboratory staff terminal 40 and normally logged in to the same system 10.

That is, the web screen allows a physician, a nurse, or clinical laboratory staff member to enter or view various types of information on his/her patient and to share the information among them if needed.

The medical information providing method that will be described below is intended to provide a wide variety of decision support information that is to be referred to or learned in entering various types of information on patient and issuing an order through the physician's, nurse's or clinical laboratory staffs web screen (hereinafter briefly called “User's web screen”). More specifically, the physician, nurse, or clinical laboratory staff member can be provided with the wide variety of decision support information through a web screen activated upon selection of the appropriate decision support menu that is made available through the main menu block 130, 230, or 330a or a separate select button and enter the appropriate information or issue an order according to the decision support information.

That is, the medical information providing method that follows is aimed at providing various references for diagnoses and treatments or performing various alert functions through the user's web screen.

Among various examples of medical information providing methods, methods for providing anticancer agent information, antibiotic information, information on blood transfusion medications, and medication information, respectively, will now be described. Hereinafter, web screens that can provide the same information are collectively called a “Decision support web screen” that is activated by selecting a pertinent menu on the user's web screen.

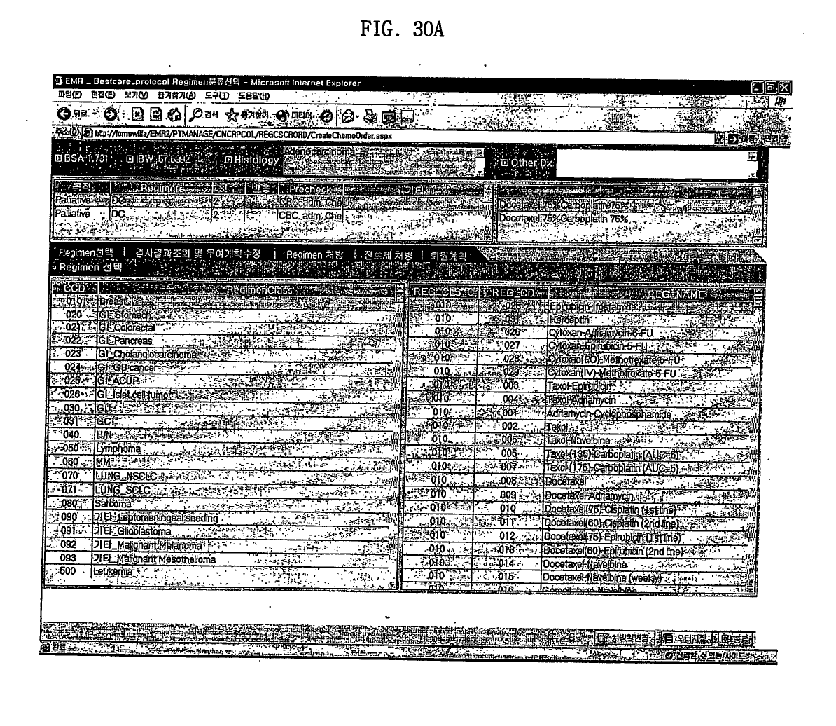

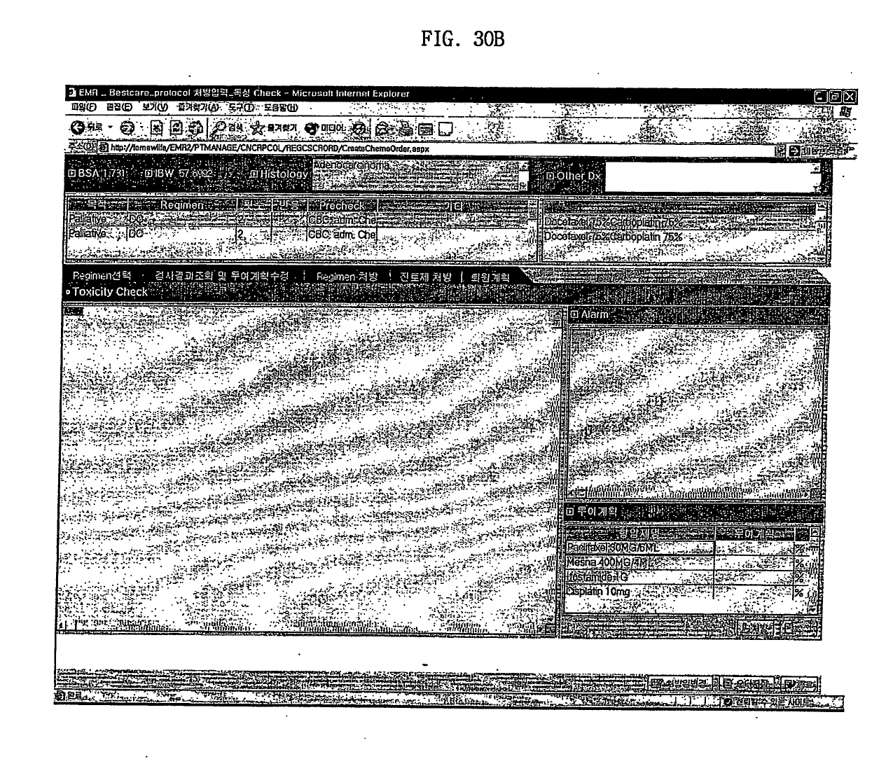

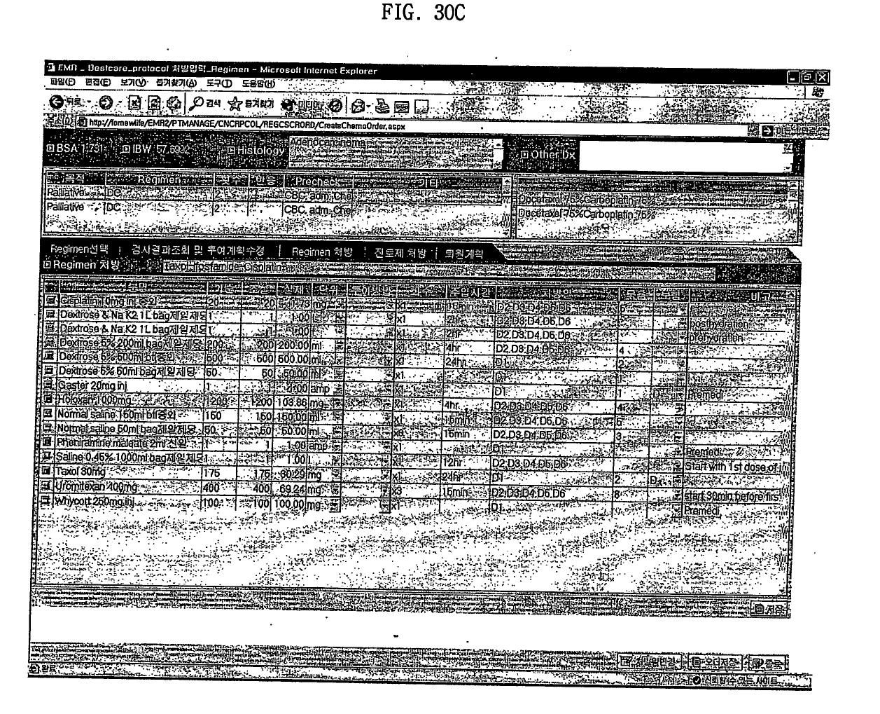

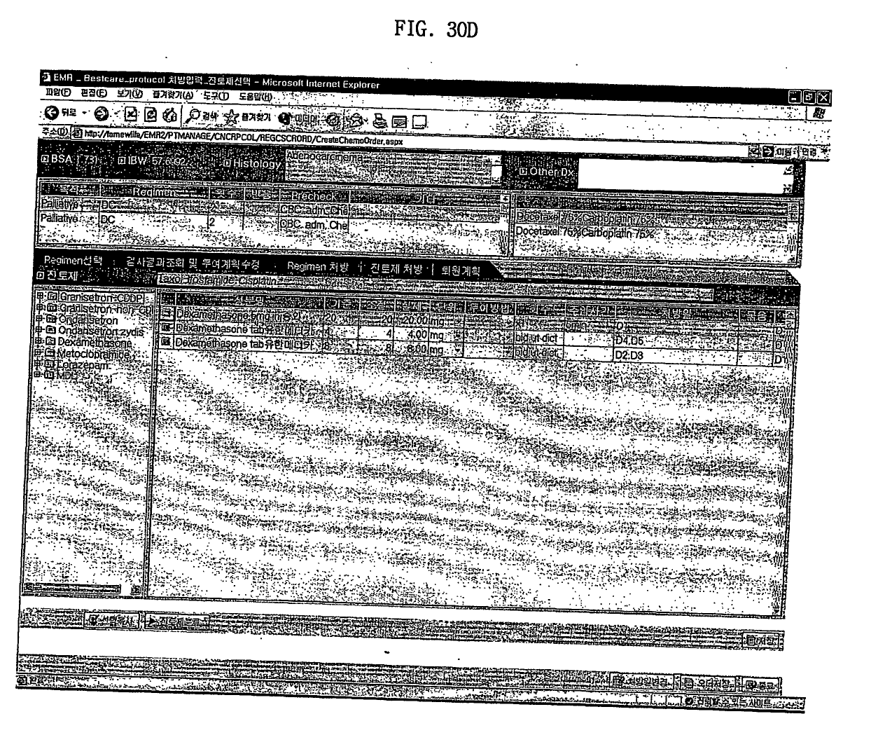

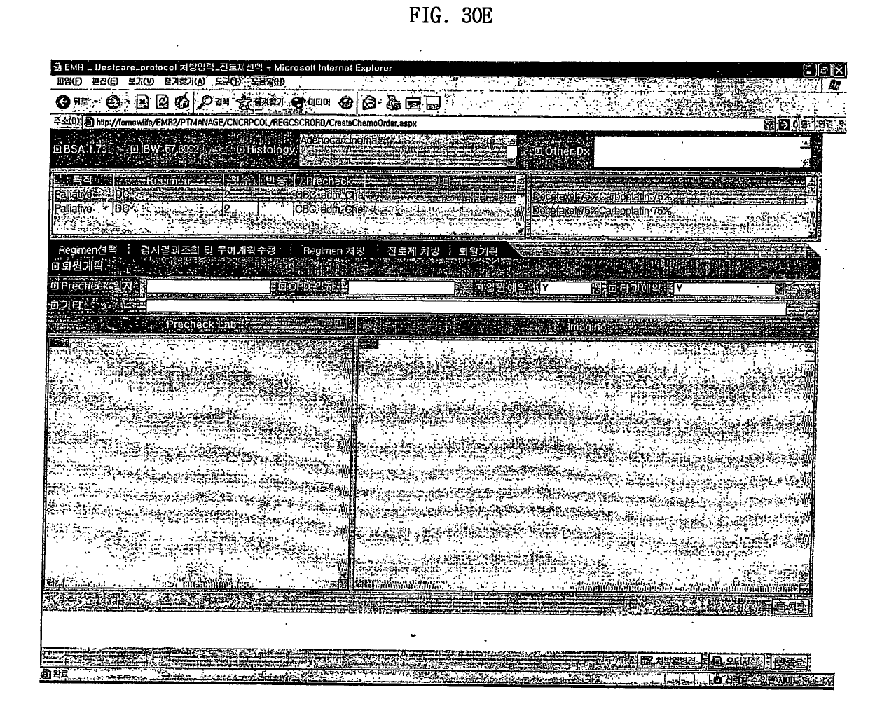

FIGS. 30A through 30E illustrate various examples of decision support web screens on which an anticancer agent information providing method is implemented in the online medical information management method according to the present invention.

As shown in FIGS. 30A through 30E, a decision support web screen for displaying various types of information on anticancer agent (hereinafter briefly called “anticancer agent web screens”) contains submenu items: Select Regimen, View clinical laboratory test results and modify Regimen, Prescribe Regimen, Prescribe antiemetics, and Discharge plan. The anticancer agent web screen allows the user to manage an anticancer agent protocol, issue a prescription for anticancer agent, view information on related medications, and access to a patient's blue sheet.

More specifically, FIG. 30A shows an example of an anticancer agent web screen displaying information on various anticancer agents categorized into lists of regimen classes so that the user can view the lists and select the desired regimen. FIG. 30B shows another example of the anticancer agent web screen displayed to manage toxicity of the anticancer agents in the regimen selected by the user and other Alarm information. That is, the screen shown in FIG. 30B presents information that allows a physician to check toxicity or properties of each anticancer agent and thus select the most suitable anticancer agents for his/her patient.

FIG. 30C shows still another example of the anticancer agent web screen that displays a prescription for selected anticancer agents issued. An appropriate dose of each anticancer agent is automatically calculated based on information such as patient's weight and body surface area. That is, once the user has selected a patient for treatment on the web screens shown in FIGS. 29A through 29C, the user information display blocks 10, 24, and 310a display basic information on the selected patient and are ready to provide detailed information on the patient. Meanwhile, once the user has selected a patient to be treated and then the anticancer agent web screen described above through the main menu blocks 130, 230, and 330a, the controller 12 automatically calculates a dose of an anticancer agent by referring to information on the selected patent's weight and body surface area that is stored in the patient information management unit 13. Alternatively, when a physician directly searches for detailed information on the patient and enters the same, a dose of an anticancer agent may be automatically calculated using the input patient information.

FIG. 30D shows yet another example of the anticancer agent web screen displaying a prescription for antiemetics that can be administered concurrently with anticancer agents. This screen allows the physician and others to view a list of antiemetics that can be administered simultaneously with the anticancer agents selected through FIGS. 30A through 30C while issuing a prescription for the selected antiemetics. FIG. 30E shows another example of the anticancer agent web screen that allows the user to enter and review treatment plans when patient needs to undergo anticancer treatment after discharge.

That is, the physician, the nurse, or the clinical laboratory staff member can be provided with information on anticancer agent that is the most suitable to the selected patient. Since they are able to take actions based on the information, it is possible to make the optimal decision based on the precise data instead of personal opinion. The anticancer agent information is stored on the decision support information management unit 18 while the information entered by the user through the anticancer agent web screens is stored on the patient information management unit 13 along with other patient information for further viewing.

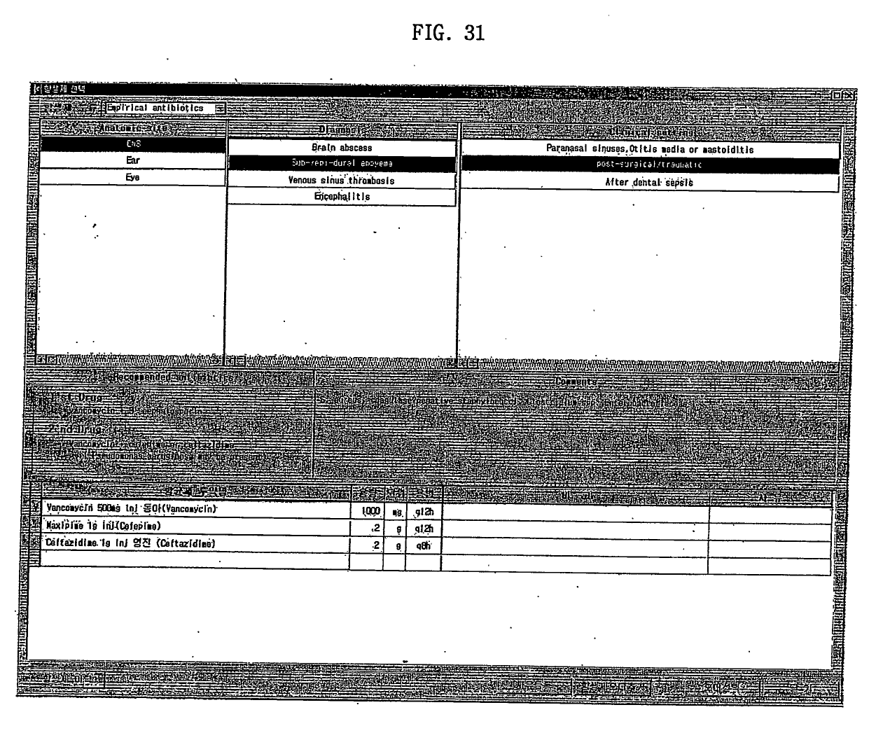

FIG. 31 shows an exemplary decision support web screen on which an antibiotic information providing method is implemented in the online medical information management method according to the present invention.

That is, a decision support web screen for displaying various types of information on antibiotics as shown in FIG. 31 (hereinafter briefly called an “antibiotic web screen”) allows a physician, a nurse or a clinical laboratory staff member to check clinical laboratory test results and information related to antibiotics to be prescribed in order to ensure that they prescribe the antibiotics most suitable for a patient's status. While the antibiotic information is stored on the decision support information management unit 18, the information entered by the user through the antibiotic web screen is stored on the patient information management unit 13 along with other patient information for further viewing. The antibiotic information providing method is intended to manage antibiotic-related information such as type and dose of antibiotics used for specific illnesses or indications in a database and control/manage actual prescriptions issued.

The antibiotic web screen displays functions such as calculation of a dose of antibiotics needed for a patient with renal failure, selection of prescriptions for medication to be administered to a pregnant woman or a child/adult.

When issuing a prescription for antibiotics, the physician checks various types of information on antibiotics on the antibiotic web screen to make sure he/she prescribe antibiotics suitable for a patient. Here, for specific antibiotics, their expiration dates are preset so that they may be checked through an Alert or Reminder menu in the user information display block 10 on the physician's web screen of FIG. 29A.

Furthermore, information on antibiotics prescribed through the antibiotic web screen may be viewed on a general order screen selected through a menu in the main menu block 130. Thus, it is possible to consider information on the previously prescribed antibiotics together when issuing a prescription for medication other than antibiotics. That is, the antibiotic web screen is intended for providing detailed information on antibiotics, and the information on antibiotics prescribed through the antibiotic web screen can be freely viewed on the general order screen as well.

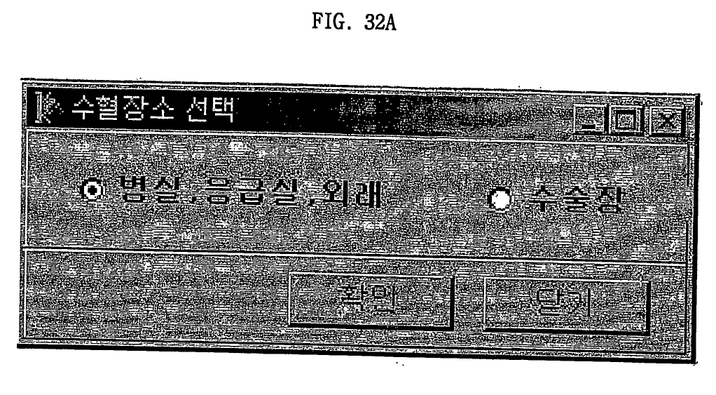

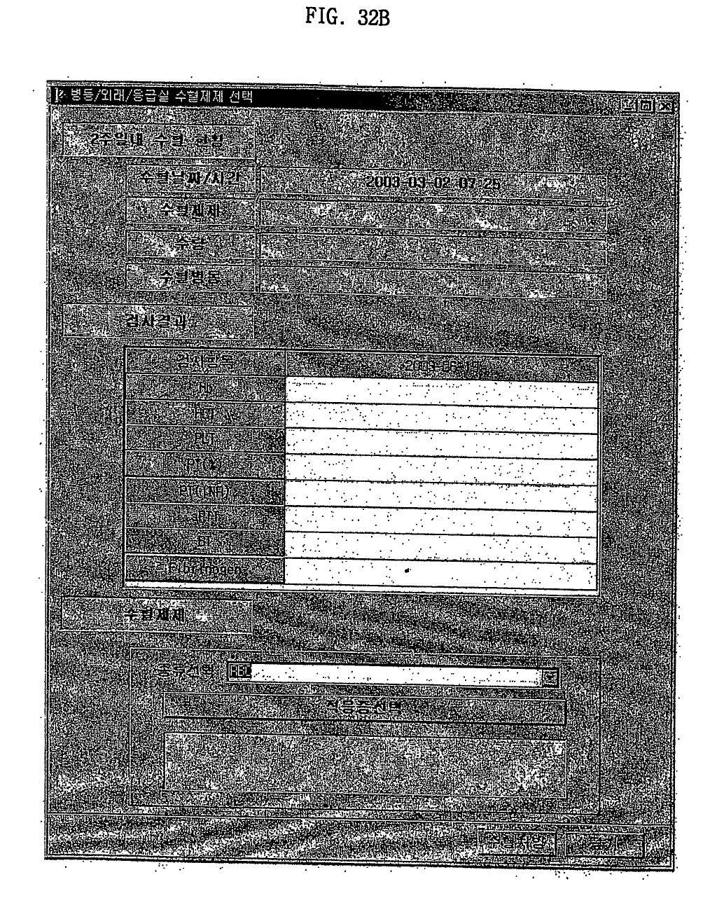

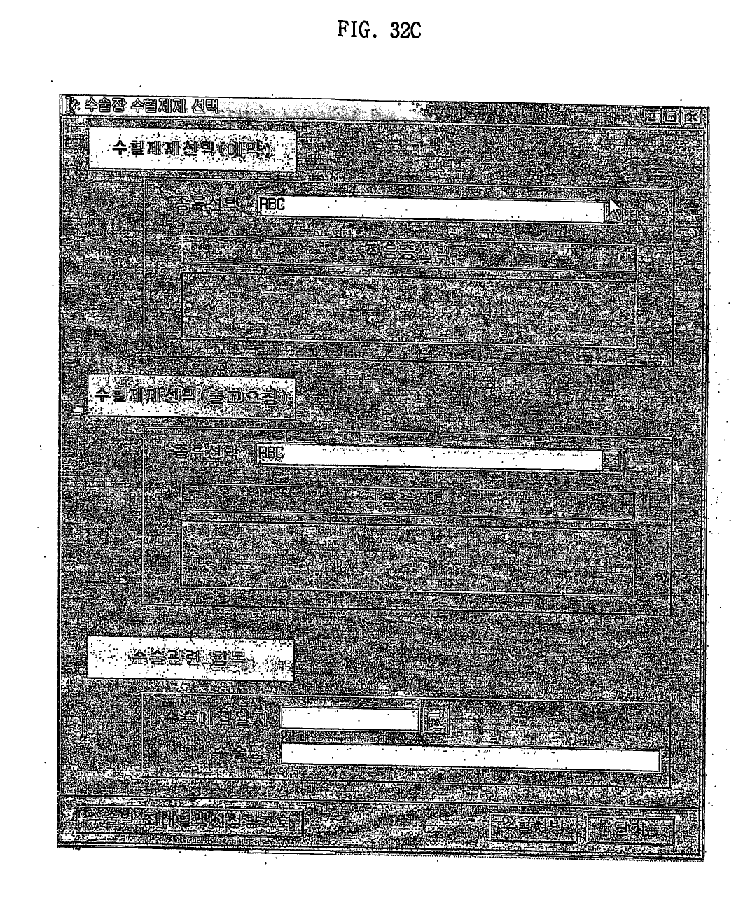

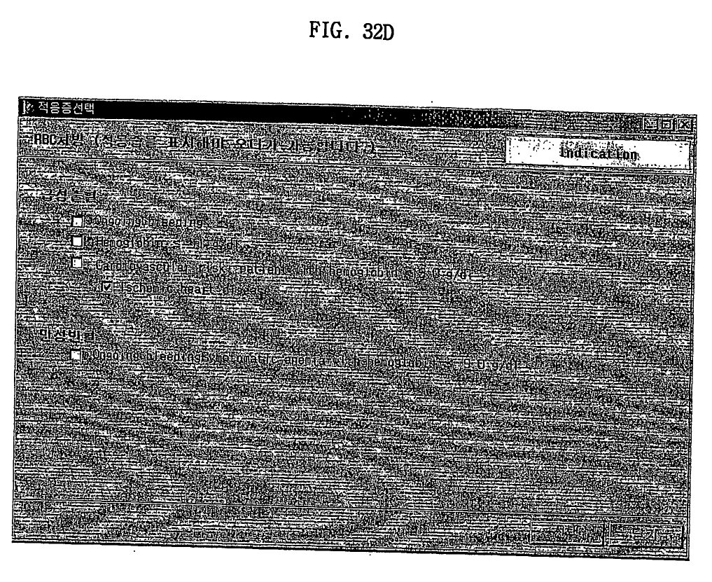

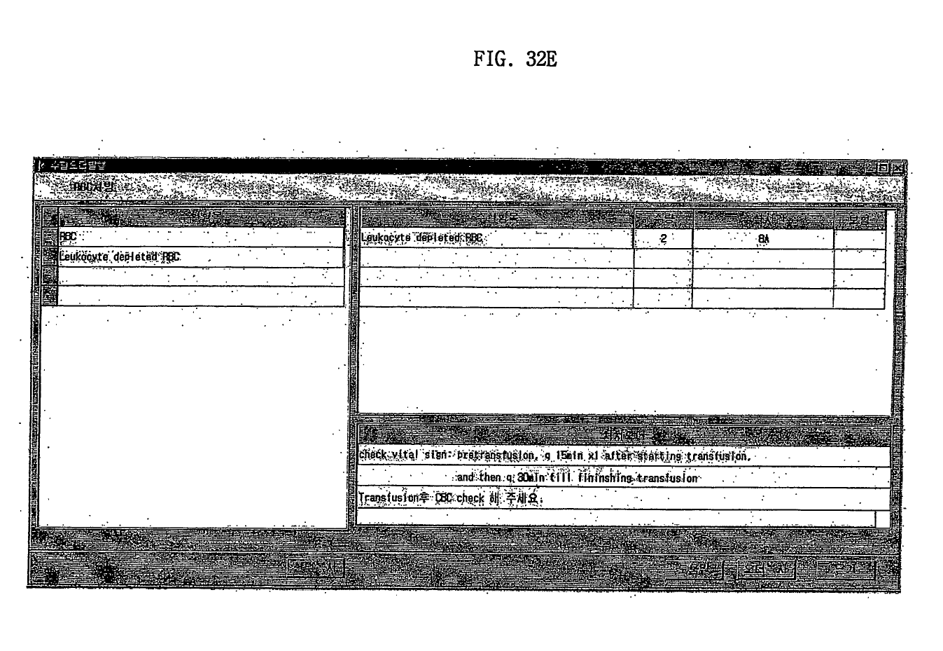

FIGS. 32A through 32E illustrate various examples of decision support web screens on which a blood transfusion prescription information providing method is implemented to assist a user in making a decision about his/her care and treatment by providing various types of information on medications.

That is, decision support web screens for displaying various types of information on prescriptions for blood transfusion as shown in FIGS. 32A through 32E (hereinafter briefly called “blood transfusion prescription web screens”) allow a physician, a nurse or a clinical laboratory staff member to not only view detailed information on transfusing blood components but also issue an order related to quantity of transfusing blood components suitable for a patient's status and other transfusion-related orders.

That is, the blood transfusion prescription web screen enables the physician, nurse, or clinical laboratory staff member to be presented with detailed information on blood resources currently being managed by a hospital and to issue an order specifying an adequate quantity of blood based on the information. Thus, it is possible to decrease the volume of blood returned or discarded, thereby enabling efficient use of blood resources. Furthermore, the web screen allows the user to check test information on blood samples in advance of transfusion, thereby preventing transfusion errors or side effects.

FIG. 32A shows an example of a blood transfusion prescription web screen that allows the user to select a place for blood transfusion, that is, whether to use the blood in a patient room, an emergency room, or an operating room, or on an outpatient basis.

FIG. 32B shows another example of the blood transfusion prescription web screen that allows the user to select transfusing blood components and view details of transfusion of the blood components within the last 2 weeks and test results in order to ensure that they are suitable for transfusion.

FIG. 32C shows another example of the blood transfusion prescription web screen that allows the user to select transfusing blood components, that is, type, delivery and quantity of blood components, according to the date and type of surgery.

FIG. 32D shows another example of the blood transfusion prescription information screen that allows the user to view various types of information on the selected transfusing blood components in order to ensure that the blood components is suitable for use.

Lastly, FIG. 32E shows another example of the blood transfusion prescription web screen that enables the user to issue orders specifying the type and quantity of blood components to be actually transfused and other orders related to use of the blood components.

That is, the blood transfusion prescription web screens of FIGS. 32A through 32E can be activated upon selecting a menu from the user's web screens shown in FIGS. 29A through 29C, which allows the physician, nurse, or clinical laboratory staff member to not only view various types of information on prescriptions for blood transfusion but also order the type and quantity of blood components.

As described with reference to FIG. 31, it is also possible to view information on the orders entered through the blood transfusion prescription web screens on the general order screen or other separate screens.

Furthermore, as described with references to FIGS. 30A through 30E, the information on prescriptions for blood transfusion is stored on the decision support information management unit 18 while the information entered by the user through the blood transfusion prescription web screens is stored on the patient information management unit 13 along with other patient information for further viewing.

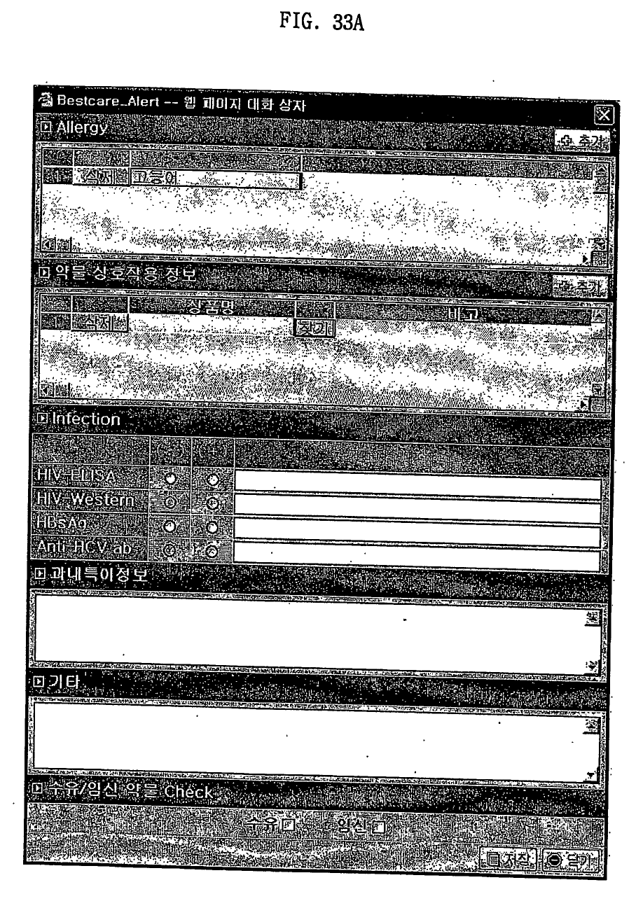

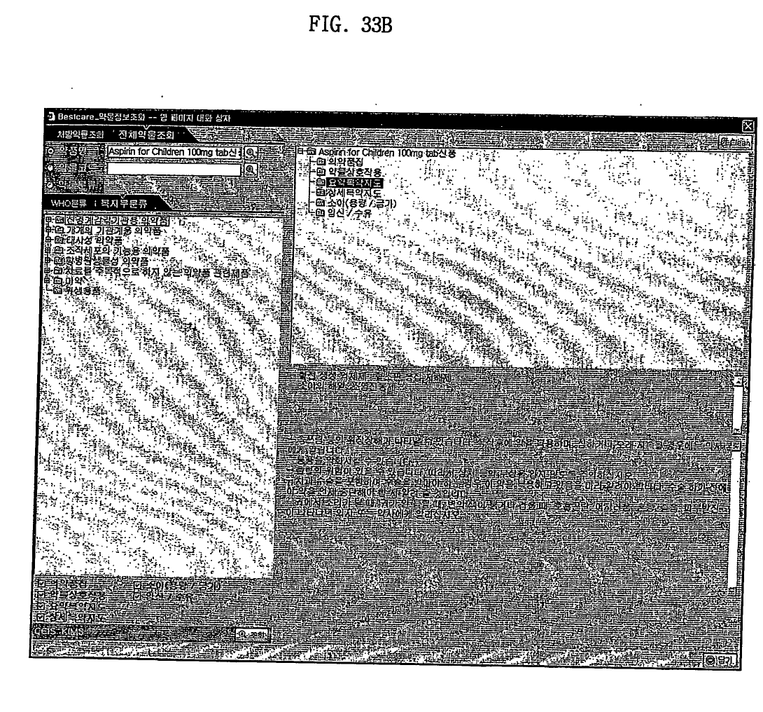

FIGS. 33A and 33B illustrate examples of decision support web screens on which a medication information providing method is implemented by the online medical information management method according to the present invention.

That is, decision support web screens for entering and viewing various types of information on medications shown in FIGS. 33A and 33B (hereinafter briefly called “medication information web screens”) allow a physician, a nurse or a clinical laboratory staff member to not only view detailed information on medications to be prescribed but also issue an order specifying the type of medications suitable for a patient's status and an appropriate quantity thereof.

FIG. 33A shows an example of a medication information web screen for inputting common medication information and idiosyncratic information, which can be accessed by a user authorized to manage the medication information web screen. That is, the medication information web screen shown in FIG. 33A allows the manager to enter detailed information on each medication administered in hospital together with idiosyncratic information on the same medication. The entered information is stored in the decision support information management unit 18 and viewed on the appropriate web screen when requested by a physician, a nurse or a clinical laboratory staff member through a menu in the web screens of FIGS. 29A through 29C.

The information entered through the screen shown in FIG. 33A can be viewed through a screen shown in FIG. 33B.

Although not shown in the drawings, it is possible to implement a medication information web screen designed to provide a medication prescription order issued to a patient while checking the related medication information entered by the user. Alternatively, the user may make an order while directly checking the medication information on the general order screen.

The anticancer agent information and the antibiotic information described with references to FIGS. 30A through 30E and FIG. 31, respectively, may be entered through a separate manager's screen and stored on the decision support information management unit 18 or entered together with other medication information through the screen shown in FIG. 33A. In other words, the medication information displayed on the screens of FIGS. 33A and 33B may contain the anticancer agent information and the antibiotic information. Since special caution must be exercised in prescribing anticancer agents and antibiotics, the present invention provides a separate web screen for displaying the relevant information. Furthermore, the present invention also provides a separate management screen for entering the information on prescriptions for blood transfusion.

Meanwhile, the information entered through the medication information web screen of FIG. 33A may include the efficacy of a particular medication, affected organs, association between generic-name and brand-name medications, interaction between medications, a medication allergy and a side effect caused by a medication, and dose of medication prescribed. Here, the various types of information may be mainly categorized into information on prescription for medication, information on medication warning, information on insurance stipulations, and information on medication classification.

More specifically, the information on prescription for medication may contain brand name, generic name, dose, dosage, instructions for use, unit, pharmaceutical company, dosage form, insurance price and code, and information on dose limitations. The information on medication warning may contain medication code, medication interaction code, interacting medication code, medication contraindication code, contraindicating item code, allergy code and allergen code. The information on insurance stipulations may contain period of medication prescription, information on dosage, information on names of medication and diagnosed illness, and information on order of medication use.

The entered medication information can be stored on the decision support information management unit 18 as described above and viewed by selecting a menu in a physician's, a nurse's, or clinical laboratory staff's web screen. The example of viewing screen is shown in FIG. 33B.

It is possible for a physician to use the medication information through a general order screen while making orders on a physician's web screen. That is, after treatment of a patient, the physician can issue orders together with prescriptions for medications. The controller 12 refers to various medication information stored on the decision support information management unit 18 and issues a message indicating whether the medications prescribed by the physician are suitable for use. For example, for a mix of two medications prescribed, the controller 12 determines whether the two medications can be used together, and if not, issues a warning message indicating that the physician cannot use the medications to the physician's web screen.

That is, the medication information web screens shown in FIGS. 33A and 33B allows the user to comprehensively control information on all medications used in a hospital, thereby preventing medication side effects and misuse/abuse.

The method for providing medical information according to the present invention provides a physician, a nurse, or a clinical laboratory staff member with objective information that can be referenced, thereby assisting him/her in making the right decisions about treatment of a patient, which are not biased toward a personal subjective view.

The decision support information is objectively obtained from various tests, experiments and treatment results. The present invention also allows each manager to directly enter newly acquired information through the decision support web screen.

The method for providing medical information using the decision support information enables the users to manage and view various types of information needed in providing patient care in a hospital, thereby assisting them in making decisions about treatment and diagnosis.

As described above, in the medical information management method implemented by the physician's, nurses' and clinical laboratory staff member terminals according to the present invention, the physician, nurses and clinical laboratory staff can share information of results of medical care, nursing, examination and treatment of the patient through the network, thereby giving care services to the patient rapidly and accurately.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

### INDUSTRIAL APPLICABILITY

In order to solve inconveniences experienced by physicians, nurses or clinical laboratory staff members in hospitals due to a necessity of writing down information on treatment and care of patients on paper-based charts, a variety of information input through user terminals connected to the service providing system according to the present invention via a network can be stored and presented upon request from the user terminals, thereby enabling the physician, nurses, clinical laboratory staff members to accurately and conveniently perform care services on the patient.

Also, according to the present invention, since the patient information is stored in the service providing system, any physician, nurse or a clinical laboratory staff member who is authenticated to having a right to view the information can view the patient information, thereby providing for rapid acquisition of patient information.

Further, since the physician, nurse, clinical laboratory staff member or administrative staff members can share the patient information, they can acquire rapidly and accurately a variety of information necessary for patient care.

In addition, unlike in the prior in which a variety of patient information created during patient care are recorded in paper-based charts or memos to then be input again using a computer, according to the present invention, nurses can directly input the patient information to a notebook-type computer on the spot or can view patient information supplied through web screens, allowing the nurse to afford a much time in nursing, thereby ultimately leading to a more effective nursing service for the patient.

Also, in order to solve inconveniences experienced by physicians, nurses or clinical laboratory staff members in hospitals due to a necessity of writing down information on treatment and care of patients on paper-based charts, a variety of information input through user terminals connected to the service providing system according to the present invention via a network can be stored and presented through the user terminals, upon request, thereby enabling the physician, nurses, clinical laboratory staff members to accurately and conveniently perform examination, interpretation and care services on the patient.

In addition, according to the present invention, the physician, nurse or clinical laboratory staff member can manage or view a wide variety of decision support information that is required for the physician, nurse or clinical laboratory staff member to make a decision concerning the diagnosis or opinion for the patient through the physician's, nurse's or clinical laboratory staffs web screen, enabling the user to easily acquire pertinent information, thereby making a prompt, accurate decision.

Further, the method according to the present invention allows the user to directly enter a prescription and to view a variety of information using the decision support information, thereby facilitating medical care for the patient.

1. An online medical information management method applied to a medical information providing system, comprising the acts of:
(1) when a physician terminal connected to the medical information providing system requests a medical information management service for a physician from a network, a controller performing an authentication procedure for the request;
(2) when it is determined by the authentication procedure that the request has been made by an authenticated user, the controller transmitting a physician's web screen to the physician terminal, the physician's web screen comprising at least one block selected from the group consisting of a user information display block, a My menu block, a main menu block, a patient information view block, and a patient information input block;
(3) when a patient to be cared for is selected, the controller displaying information in the user information display block, the information including at least one information item selected from the group consisting of patient identification, department concerned, primary care physician, diagnosis, and operation;
(4) when at least one information item selected from the group consisting of new outpatient, outpatient progress, new inpatient, admission progress, ask for referral, operation record, discharge record, medical certificate/request, form, and psychiatric findings is input through the patient information input block, the controller storing the input information together with the patient information displayed in the user information display block; and
(5) when a request to view at least one information item selected from the group consisting of new outpatient, outpatient progress, examination query, ask for referral, form, new inpatient, admission progress, operation record, and discharge record is input through the patient information view block, the controller retrieving pertinent information among the information items stored in act (4) and outputting the retrieved information through the patient information view block.

2. The method of claim 1, wherein the user information display block displays at least one selected from the group consisting of an attending doctor menu item for identifying and registering a physician other than a primary care physician, if any, a Medication menu item for check information on medicines prescribed for the patient, a patient information menu item for checking detailed identification information for the patient, an alert menu item for inputting or viewing special status information on the patient, and a reminder menu item for inputting or viewing matters to be attended in caring the patient.

3. The method of claim 1, further comprising the acts of:
(6) when the physician' web screen is output and simultaneously an order input menu item is selected, the controller displaying an order input window for inputting an order for the patient on the physician terminal and storing the order input through the order input window; and
(7) when there is a request to view the order input through the patient information view block, the controller transmitting the stored order to the physician terminal to be displayed.

4. The method of claim 1, further comprising the act of:
(8) when there is a request for view nursing notes input through the patient information view block, the controller displaying-in the patient information view block the nursing notes input and stored through a nurse terminal.

5. The method of claim 1, wherein the information items input through the patient information input block, including new outpatient, outpatient progress, new inpatient, admission progress, ask for referral, operation record, discharge record, medical certificate/request, form, and psychiatric findings, are configured to allow the physician to selectively check or to directly input the same.

6. The method of claim 1, wherein the patient information displayed on the patient information view block is configured to output pertinent content in an in chronological order.

7. The method of claim 1, wherein the patient information input block for inputting the information on new outpatient and new inpatient information displays at least one menu item selected from the group consisting of chief complaint (CC), present illness (PI), past history1 (PHx1), past history2 (PHx2), review of systems (ROS), physical examination (PE) and treatment plan (A/P).

8. The method of claim 1, wherein when the information input through the physician's web screen is stored and there is a request for the stored information from at least one terminal selected from the physician terminal, the nurse terminal, the clinical laboratory staff terminal, and the administrative staff terminal, make a request for the stored information when the request has been made by a the user authenticated to have a viewing right.

9. An online medical information management method applied to a medical information providing system, comprising the acts of:
(1) when a nurse terminal connected to the medical information providing system requests a medical information management service for a nurse through a network a controller performing an authentication procedure for the request;
(2) when it is determined by the authentication procedure that the request has been made by an authenticated user, the controller transmitting a nurse's web screen to the nurse terminal, the nurse's web screen comprising at least one block selected from the group consisting of a user information display block, a My menu block, a main menu block, a patient selection block, and a patient information input/output block;
(3) when a patient to be cared for is selected, the controller displaying information in the user information display block, the information including at least one information item selected from the group consisting of patient identification, department concerned, primary care physician, diagnosis, and operation; and
(4) when there is a request for activating at least one menu item of the ‘My menu’ block selected from the consisting of order execution, nursing notes, clinical observation, serious case nursing note, nursing activity execution, initial nursing information, post discharge nursing plan, pre-operation nursing status checklist, nursing note and nursing activity query, patient position check, medication issuance, diet issue and review, examination result review, and discharge process, the controller outputting the pertinent content to the patient information input/output block, storing the information input through the patient information input/output block therein, and outputting the requested information through the patient information input/output block when there is a request for outputting the menu items,
the patient selection block displaying a first patient selection button for activating patient selection, a second patient selection button displayed in different types according to the menu item selected by the first patient selection button, and a patient list for displaying a list of patients according to the menu item selected by the second patient selection button.

10. The method of claim 9, wherein the user information display block displays at least one selected from the group consisting of an attending doctor menu item for identifying and registering a physician other than a primary care physician, when a physician is designated, a medication menu item for check information on medicines prescribed for the patient, a patient information menu item for checking detailed identification information for the patient, an alert menu item for inputting or viewing special status information on the patient, and a reminder menu item for inputting or viewing reminders to care for the patient.

11. The method of claim 9, further comprising the act of: (5) when an order execution menu item is selected from the ‘My menu’ block, the controller displaying the order input and stored by the physician on the patient information input/output block.

12. The method of claim 9, further comprising the act of: (6) when a nursing note menu item is selected from the ‘My menu’ block, the controller displaying items to be input to the nursing note, and when there is a request for storing the selected item among the items, displaying the selected item and outputting the same through the patient information input/output block.

13. The method of claim 9, further comprising the act of: (7) when a clinical observation menu item is selected from the ‘My menu’ block, the controller displaying the pertinent screen on the patient information input/output block, storing the clinical observation information input through the input/output block and outputting the same through the patient information input/output block.

14. The method of claim 9, wherein when the information input through the nurse's web screen is stored and there is a request for the stored information from at least one selected from the physician terminal, the nurse terminal, the clinical laboratory staff terminal, and the administrative staff terminal 50, the information is transmitted for viewing when the request has been made from the user authenticated to have a viewing right.

15. An online medical information management method applied to a medical information providing system, comprising the acts of:
(1) when there is a request for a medical information management service for clinical laboratory staff from at least one selected from the physician terminal, the nurse terminal, and the clinical laboratory staff terminal connected to the medical information providing system through a network, a controller performing an authentication procedure for the request;
(2) when it is determined by the authentication procedure that the request has been made by an authenticated user, the controller transmitting a clinical laboratory staff's web screen to the requesting terminal, the clinical laboratory staff's screen including at least one block selected from the group consisting of a user information display block, a main menu block, and a patient information input/output block;
(3) when a patient to be reviewed is selected, the controller displaying information on the user information display block, the information including at least one information item selected from the group consisting of patient identification, department concerned, primary care physician, diagnosis, operation, examination history, consultation history, treatment history, treatment room and examining room; and
(4) the controller outputting pertinent information according to the content of the menu item selected from the main menu block to the patient information input/output block and storing the examination or treatment related information input through the patient information input/output block, and outputting the examination or treatment related information when there is a request for reviewing the information,
wherein the clinical laboratory staff's web screen in act (2) is at least one selected from a web screen for information on function tests assigned to the respective departments concerned, a web screen for a rehabilitation service for physical therapy and occupational therapy, and a web screen for radiotherapy.

16. The method of claim 15, wherein when the clinical laboratory staff's web screen is a web screen for displaying information on function tests assigned to the respective departments concerned, the main menu block comprises menu items selected from the group consisting of order view, reservation query, reservation, registration, execution, interpretation and statistics related to examination, examination code management, reservation and registration of laboratory standard information, and a clinical laboratory registration menu, the method further comprises the act of (5) the controller outputting the information corresponding to the selected menu item to the patient information input/output block and storing the input information input through the patient information input/output block.

17. The method of claim 15, wherein when the clinical laboratory staff's web screen is a web screen for displaying information on rehabilitation, the method further comprises the act of (6) the main menu block including at least one menu item selected from the group consisting of an outgoing patient query menu, a patient identification query menu, a registration menu, a therapist allocation menu, a treatment schedule query menu, and a statistics menu, and the controller outputs the information corresponding to the selected menu item to the patient information input/output block and stores the input information input through the patient information input/output block.

18. The method of claim 15, wherein when the clinical laboratory staff's web screen is a web screen for displaying information on health examination for medical checkup for health promotion, the method further comprises the act of (7) the controller outputting a plurality of health examination menu forms in a standard type of package, receiving and storing reservation registrations and outputting contents corresponding to the registrations, and receiving and storing data resulting after checking whether the health examination has been executed.

19. The method of claim 15, wherein when the clinical laboratory staff's web screen is a web screen for displaying information on the treatment result by radiotherapy, the method further comprises the act of (8) the controller outputting information on a patient to be subjected to radiotherapy, and receiving and storing data resulting after checking whether the radiotherapy has been executed.

20. The method of claim 15, wherein information displayed when the menu items are selected is information input through at least one terminal selected from the physician terminal, the nurse terminal, the clinical laboratory staff terminal, and the administrative staff terminal.

21. An online medical information management method applied to a medical information providing system, comprising the acts of:
(1) managing medical information necessary for patient care by a controller transmitting a physician's web screen, a nurse's web screen, and a clinical laboratory staff's web screen for medical information management to each of a physician terminal, a nurse terminal, and a clinical laboratory staff terminal, which are connected to the service providing system through a network, and storing the medical information to allow the user to share the information input through the respective terminals through the web screens;
(2) when there is a request for viewing decision support information through a menu item supplied from the at least one of the physician's web screen, the nurse's web screen, and the clinical laboratory staff's web screen, the controller supplying pertinent decision support information retrieved from the decision support information stored in a decision support management unit 18 to the requesting user through the corresponding decision support web screen;
(3) the controller storing information input by at least one user selected from a physician, a nurse or a clinical laboratory staff member through the physician's decision support web screen and, when it is necessary to convert the input information based on prestored patient information, performing a pertinent calculation and supplying the calculation result through the decision support web screen; and
(4) the controller allowing the information input through the decision support web screen to be viewed through the user's web screen and issuing an alert message to the user's web screen when the information input through the user's web screen is inappropriate information with respect to the decision support information stored in the decision support management unit, the decision support information including at least one information item selected from the group consisting of anticancer agent information, antibiotics information, blood transfusion prescription information, and medicine information.

22. The method of claim 21, wherein the decision support web screen for displaying various types of information on am anticancer agent contains at least one submenu item selected from the group consisting of Select Regimen, View clinical laboratory test results and Modify Regimen, Prescribe Regimen, Prescribe antiemetics, and Discharge plan, the anticancer agent web screen performing at least one function selected from the group consisting of management of an anticancer agent protocol, issuance of a prescription for the anticancer agent, query of information on related medications, and access to a patient's blue sheet.

23. The method of claim 21, wherein the antibiotics web screen of the decision support web screen for providing a variety of information related to antibiotics allows antibiotic-related information including type and dose of antibiotics used for specific illnesses or indications to be managed in a database and performs functions of controlling/managing actual prescriptions issued.

24. The method of claim 21, wherein the blood transfusion prescription information screen supplies the user with various types of information including detailed information on blood components to be transfused to the patient on a quantity of blood components suitable for the patient's status, receives and stores transfusion-related orders, and supplies the user with order contents through the user's web screen when there is a request for the orders.

25. The method of claim 21, wherein the medication information web screen of the decision support web screen, for inputting and viewing a variety of medication information, displays at least one information item selected from the group consisting of brand name, generic name, dose, dosage, instructions for use, unit, pharmaceutical company, dosage form, insurance price and code, and information on dose limitations, medication code, medication interaction code, interacting medication code, medication contraindication code, contraindicating item code, allergy code, allergen code, insurance stipulations that may contain period of medication prescription, information on dosage, information on names of medication and diagnosed illness, and information on order of medication use, each of the information items being categorized into information on prescription for medication, information on medication warning, information on insurance stipulations, and information on medication classification.

26. The method of claim 21, wherein when a user authorized for management requests through the user's web screen at least one function selected from the group consisting of correcting, deleting and editing of the decision support information and registration of new decision support information, the method further comprising the step act of (5) displaying the function on the decision support web screen for a manager.
